(19) United States
(12) Patent Application Publication
(10) Pub. No.: US 2025/0283193 A1
(43) Pub. Date: Sep. 11, 2025

(54) SYNTHETIC LITHIUM SOLUTIONS WITH CONTROLLED IMPURITY PROFILES

(71) Applicant: Lilac Solutions, Inc., Oakland, CA (US)

(72) Inventors: David Henry SNYDACKER, San Francisco, CA (US); Sophia Patricia MOCK, Berkeley, CA (US); Christopher John KOMLOS, San Francisco, CA (US); Nicolás Andrés GROSSO GIORDANO, Oakland, CA (US); Amos INDRANADA, Oakland, CA (US)

(21) Appl. No.: 18/857,041

(22) PCT Filed: Apr. 17, 2023
(86) PCT No.: PCT/US2023/018806

§ 371 Date: Oct. 15, 2024

Related U.S. Application Data
(60) Provisional application No. 63/332,194, filed on Apr. 18, 2022.

(51) Int. Cl. C22B 26/12; C22B 3/06; C22B 3/16; C22B 3/42

(52) U.S. Cl. CPC C22B 26/12; C22B 3/06; C22B 3/16; C22B 3/42

(57) ABSTRACT

The present disclosure relates to the extraction of lithium from liquid resources such as natural and synthetic brines, leachate solutions from clays and minerals, and recycled products.

### CROSS-REFERENCE

This application claims the benefit of U.S. Provisional Application Ser. No. 63/332,194 filed Apr. 18, 2022, which is hereby incorporated by reference in its entirety.

### BACKGROUND OF THE INVENTION

Lithium is an essential element for high-energy rechargeable batteries and other technologies. Lithium can be found in a variety of liquid solutions, including natural and synthetic brines and leachate solutions from minerals and recycled products.

### SUMMARY OF THE INVENTION

In one aspect, disclosed herein is a lithium ion exchange eluate solution comprising: a. water; b. lithium, wherein the concentration of lithium is greater than about 100 milligrams per liter and less than about 25,000 milligrams per liter; c. sodium, wherein the concentration of sodium is greater than about 10 milligrams per liter and less than about 25,000 milligrams per liter; d. calcium, wherein the concentration of calcium is greater than about 1 milligram per liter and less than about 10,000 milligrams per liter; e. magnesium, wherein the concentration of magnesium is greater than about 10 milligrams per liter and less than about 10,000 milligrams per liter; f. potassium, wherein the concentration of potassium is greater than about 10 milligrams per liter and less than about 10,000 milligrams per liter. In another aspect, disclosed herein is a process for generating the lithium ion exchange eluate solution disclosed herein, the process comprising: contacting an acidic solution with an ion exchange material to provide the lithium ion exchange eluate solution. In some embodiments, the process further comprises: contacting the ion exchange material with a liquid resource prior to contacting said ion exchange material with an acidic solution.

In another aspect, disclosed herein is a lithium ion exchange eluate solution comprising: a. water; b. lithium, wherein the concentration of lithium is greater than about 100 milligrams per liter and less than about 25,000 milligrams per liter; c. sodium, wherein the concentration of sodium is greater than about 10 milligrams per liter and less than about 25,000 milligrams per liter; d. one or more cationic metals, wherein the concentration of the one or more cationic metals is greater than about 1 milligram per liter and less than about 10,000 milligrams per liter. In some embodiments, the one or more cationic metals comprises: a. calcium, wherein the concentration of calcium is greater than about 10 milligrams per liter and less than about 10,000 milligrams per liter; and b. one or more transition metals, wherein the concentration of said one or more transition metals is greater than 0.01 milligrams per liter and less than about 1000 milligrams per liter. In some embodiments, the one or more cationic metals comprises: a. magnesium, wherein the concentration of magnesium is greater than about 1 milligram per liter and less than about 10,000 milligrams per liter; and b. one or more transition metals, wherein the concentration of said one or more transition metals is greater than 0.01 milligrams per liter and less than about 1000 milligrams per liter. In some embodiments, the one or more metal comprises: a. calcium, wherein the concentration of calcium is greater than about 10 milligrams per liter and less than about 10,000 milligrams per liter; b. magnesium, wherein the concentration of magnesium is greater than about 10 milligrams per liter and less than about 10,000 milligrams per liter; and c. potassium, wherein the concentration of potassium is greater than about 10 milligrams per liter and less than about 10,000 milligrams per liter. In another aspect, disclosed herein is a process for generating the lithium ion exchange eluate solution disclosed herein, the process comprising: contacting an acidic solution with an ion exchange material to provide the lithium ion exchange eluate solution. In some embodiments, the process further comprises: contacting the ion exchange material with a liquid resource prior to contacting said ion exchange material with an acidic solution.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a synthetic lithium solution (e.g., lithium ion exchange eluate solution) produced by extracting lithium from a liquid resource through an ion exchange process comprising a network of vessels with beds of ion exchange beads.

FIG. 2 illustrates a synthetic lithium solution (e.g., lithium ion exchange eluate solution) produced by extracting lithium from a liquid resource through an ion exchange process comprising a vessel containing ion exchange beads.

FIG. 3 illustrates a synthetic lithium solution (e.g., lithium ion exchange eluate solution) produced by extracting lithium from a liquid resource through an ion exchange process comprising an agitated vessel containing ion exchange beads.

FIG. 4 illustrates a synthetic lithium solution (e.g., lithium ion exchange eluate solution) produced by extracting lithium from a liquid resource through an ion exchange process comprising an agitated vessel containing ion exchange beads.

### DETAILED DESCRIPTION OF THE INVENTION

Unless defined otherwise, all terms of art, notations, and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range of formats. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including combinations thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative, or quantitative and qualitative determinations. Assessing can be relative or absolute.

The term “about” or “approximately” as used herein when referring to a measurable value such as an amount or concentration and the like, is meant to encompass variations of 20%, 10%, 5%, 1%, 0.5%, or even 0.1% of the specified amount. For example, “about” can mean plus or minus 10%, per the practice in the art. Alternatively, “about” can mean a range of plus or minus 20%, plus or minus 10%, plus or minus 5%, or plus or minus 1% of a given value. Alternatively, particularly with respect to biological systems or processes, the term can mean within an order of magnitude, up to 5-fold, or up to 2-fold, of a value. Where particular values can be described in the application and claims, unless otherwise stated the term “about” may be assumed to encompass the acceptable error range for the particular value. Also, where ranges, subranges, or both, of values, can be provided, the ranges or subranges can include the endpoints of the ranges or subranges.

Where values are described as ranges, it may be understood that such disclosure includes the disclosure of all possible sub-ranges within such ranges, as well as specific numerical values that fall within such ranges irrespective of whether a specific numerical value or specific sub-range is expressly stated.

The terms “comprise,” “have,” and “include” are open-ended linking verbs. Any forms or tenses of one or more of these verbs, such as “comprises,” “comprising,” “has,” “having,” “includes,” and “including,” are also open-ended. For example, any method that “comprises,” “has,” or “includes” one or more steps is not limited to possessing only those one or more steps and also covers other unlisted steps.

The terms “lithium”, “lithium ion”, and “Li⁺” are used interchangeably in the present specification and these terms are synonymous unless specifically noted to the contrary. The terms “hydrogen”, “hydrogen ion”, “proton”, and “H⁺” are used interchangeably in the present specification and these terms are synonymous unless specifically noted to the contrary.

As used herein, the words “column” and “vessel” are used interchangeably. In some embodiments described herein referring to a “vessel”, the vessel is a column. In some embodiments described herein referring to a “column”, the column is a vessel.

The term “the pH of the system” or “the pH of” a component of a system, for example one or more tanks, vessels, columns, pH modulating setups, or pipes used to establish fluid communication between one or more tanks, vessels, columns, or pH modulating setups, refers to the pH of the liquid medium contained or present in the system, or contained or present in one or more components thereof. In some embodiments, the liquid medium contained in the system, or one or more components thereof, is a liquid resource. In some embodiments, the liquid medium contained in the system, or one or more components thereof, is a brine. In some embodiments, the liquid medium contained in the system, or one or more components thereof, is an acid solution, an aqueous solution, a wash solution, a salt solution, a salt solution comprising lithium ions, or a lithium-enriched solution.

The term “concentration”, as used herein, refers to the amount of a chemical species within a given amount of liquid. In some embodiments, said concentration can be specified as the mass of a species dissolved in an amount of liquid (e.g. mg/L), or the number of moles of a species dissolved in an amount of liquid (e.g. mol/L). In some embodiments, concentration can be specified by the ratio of moles or mass of the species of interest to one or more other species dissolved in the same liquid. In some embodiments, only the mass concentration of an ionic species is stated; for example, a concentration of sodium (Na) is stated to be 100 milligrams per liter (mg/L). In such cases, the stated concentration refers to the mass concentration of the ion in solution, and does not include the mass of the anion; in the example stated above, such an ion may comprise chloride (Cl⁻), nitrate (NO₃⁻), or sulfate (SO₄²⁻).

All values of “oxidation-reduction potential” and/or “oxidation reduction potential” detailed herein shall be understood to be relative to standard hydrogen electrode (SHE) unless specified otherwise.

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium in acid while absorbing hydrogen. This ion exchange process is optionally repeated to extract lithium from a liquid resource and yield a concentrated lithium solution. The concentrated lithium solution is optionally further processed into chemicals for the battery industry or other industries.

In some embodiments of the systems and methods and processes disclosed herein, an ion exchange material is contacted with a liquid resource comprising lithium. The lithium in the liquid resource is absorbed by the ion exchange material to yield an enriched ion exchange material. In some embodiments, the enriched ion exchange material contains a higher lithium content then the ion exchange material. In some embodiments, the ion exchange material is a protonated ion exchange material. In some embodiments, the protonated ion exchange material is contacted with a liquid resource comprising lithium. The lithium in the liquid resource is absorbed via an ion exchange process to yield a lithiated ion exchange material. In some cases, the terms “enriched ion exchange material” and “lithiated ion exchange material” are used interchangeably.

In some embodiments, the chemical formula of the ion exchange material may vary throughout the ion exchange systems and processes described herein in terms of hydrogen and lithium stoichiometries, as the ion exchange materials readily exchange lithium and hydrogen depending on the aqueous solutions and gases that the ion exchange material is exposed to. In addition, fully lithiated or fully protonated ion exchange materials may not be the most stable form of the material, and is therefore commercially sold as another form. For example, many commercially available ion exchange materials benefit from an activation step or an initial treatment in which the material is wetted and activated with an acid wash to produce an ion exchange material that is in an ideal state for lithium absorption (termed pre-activated ion exchange materials herein). In some embodiments, the term “protonated ion exchange material” refers to material that has been activated and is capable of absorbing lithium. In some embodiments, the protonated ion exchange material is at least partially protonated. In some embodiments, the protonated ion exchange material is fully protonated. Following exposure to a liquid resource comprising lithium, the protonated ion exchange material absorbs lithium and releases hydrogen to form the lithiated ion exchange material. The stoichiometries of the ion exchange material and the lithiated ion exchange material may vary with both the lithium concentration of the liquid resource and the pH of the acidic solution. Therefore, in some embodiments, the material is in part best described by the solution or alternate phase the material has been exposed to most recently. As such, the term “ion exchange material” is meant to include the various states that the material may exist as throughout the ion exchange and preparatory process. In some embodiments, an ion exchange material comprises a protonated ion exchange material, a lithiated ion exchange material, and a pre-activated ion exchange material.

In some embodiments, the ion exchange material may benefit from an activation process. An ion exchange material that benefits from an activation process is termed “pre-activated ion exchange material.” In some embodiments, the pre-activated ion exchange material is selected from an oxide, a phosphate, an oxyfluoride, a fluorophosphate, and combinations thereof. In some embodiments, the pre-activated ion exchange material is selected Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof. In some embodiments, the pre-activated ion exchange material is selected from the following list: Li₄Mn₅O₁₂, Li₄Ti₅O₁₂, Li_{1.6}Mn_{1.6}O₄, Li₂MO₃ (M=Ti, Mn, Sn), LiFePO₄, solid solutions thereof, or combinations thereof.

In some embodiments, the processes described herein utilize ion exchange materials that are exposed to a liquid resource and an acidic solution over the course of two or more cycles. The ion exchange material may be protonated ion exchange material following exposure to an acidic solution and subsequently yield a lithiated ion exchange material following exposure to a liquid resource. Although the ion exchange materials described herein are expressed as compounds with discrete stoichiometries, it should be understood that variable amounts of lithium ions and hydrogen ions are envisioned in each ion exchange material during the cyclic ion exchange processes described herein. For example, the ion exchange material Li₄Ti₅O₁₂ may be Li₄Ti₅O₁₂, Li₃HTi₅O₁₂, Li₂H₂Ti₅O₁₂, LiH₃Ti₅O₁₂, or H₄Ti₅O₁₂. Combinations of such states are also envisioned, and may be expressed as averages, for example Li_{2.1}H_{1.9}Ti₅O₁₂, Li_{2.2}H_{1.8}Ti₅O₁₂, Li_{2.3}H_{1.7}Ti₅O₁₂, Li_{2.4}H_{1.6}Ti₅O₁₂, etc. Applicant envisions that the ion exchange materials listed below comprise the chemical entity listed, each compound that replaces one lithium ion for one hydrogen ion, and any combination of such states: Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, and Li₂CUP₂O₇.

In some embodiments, ion exchange material comprises a chemical compound capable of exchanging lithium and hydrogen ions. In some embodiments, ion exchange material comprises a chemical compound capable of ion exchange of lithium and hydrogen, wherein the ion exchange material will uptake lithium selectively as opposed to uptaking other metals or metal ions (e.g., sodium, potassium, magnesium, other metal ions present in liquid resources). In some embodiments, ion exchange material is in the form of ion exchange particles. In some embodiments, ion exchange material or ion exchange beads comprise a coating material. In some embodiments, ion exchange material or ion exchange beads do not comprise a coating material. In some embodiments, ion exchange material is in the form of ion exchange beads. In some embodiments, ion exchange beads are porous. Embodiments of the present disclosure directed to “ion exchange beads” shall be understood to also be directed to “ion exchange material” unless specified otherwise. Embodiments of the present disclosure that specify use of “ion exchange beads” may also operably use “ion exchange material” unless specified otherwise.

Ion exchange beads, including ion exchange particles, ion exchange material, ion exchange media, porous ion exchange beads, and/or coated ion exchange particles, are loaded into ion exchange vessels. Alternating flows of brine (e.g., a liquid resource), acid (e.g., acidic solution), and other solutions are optionally flowed through an ion exchange column or vessel to extract lithium from the brine and produce a lithium concentrate (e.g., lithium ion exchange eluate solution), which is eluted from the column or vessel using the acid. As brine flows through the ion exchange column or vessel, the ion exchange beads absorb lithium while releasing hydrogen, where both the lithium and hydrogen are cations. After the ion exchange beads have absorbed lithium, acid is used to elute the lithium from the ion exchange beads to produce an eluate or lithium-enriched solution.

In some embodiments, ion exchange material comprises a chemical compound capable of ion exchange of lithium and hydrogen. In some embodiments, ion exchange material comprises a chemical compound capable of ion exchange of lithium and hydrogen, wherein the ion exchange material will uptake lithium selectively as opposed to uptaking other metals or metal ions (e.g., sodium, potassium, magnesium, other metal ions present in liquid resources). In some embodiments, ion exchange material comprises a lithium selective ion exchange material. In some embodiments, ion exchange material is in the form of ion exchange particles. In some embodiments, ion exchange material is in the form of ion exchange beads. In some embodiments, ion exchange beads are porous. In some embodiments, ion exchange particles or ion exchange beads comprise a coating material. In some embodiments, ion exchange particles or ion exchange beads do not comprise a coating material.

Ion exchange beads may have small diameters less than about one millimeter causing a high pressure difference across a packed bed of the ion exchange beads during pumping of the liquid resource and other fluids through the bed. To minimize pressure across the packed bed and to minimize associated pumping energy, vessels with optimized geometries can be used to reduce the flow distance through the packed bed of ion exchange beads. These vessels may be networked with pH modulation units to achieve adequate control of the pH of the liquid resource.

In some embodiments a network of vessels loaded with ion exchange materials may comprise two vessels, three vessels, four vessels, five vessels, six vessels, seven vessels, eight vessels, nine vessels, 10 vessels, 11 vessels, 12 vessels, 13-14 vessels, 15-20 vessels, 20-30 vessels, 30-50 vessels, 50-70 vessels, 70-100 vessels, or more than 100 vessels.

The concentrated lithium solution is an aqueous solution comprising lithium and other dissolved ions. Said concentrated lithium solution is produced by treatment of an ion exchange material that has absorbed lithium with an acidic eluent (e.g., acidic solution) to produce an eluate (e.g., lithium ion exchange eluate solution). Said eluate is acidic and contains lithium in combination with other cations and anions that are present in the liquid resource from which lithium is extracted. Said eluent is contacted with ion exchange material in one or more of the aforementioned ion exchange vessels to produce an eluate. Said eluate is stored in one or more different vessels that are part of an ion exchange network.

The type and concentration of lithium and other ions in solution vary depending on the liquid resource from which lithium is extracted. The pH of the eluate can be adjusted following elution by treatment with other acidic or basic substances. The eluate can be further treated and subjected to other separation processes to result in a changed relative concentration of lithium and other ions. The eluate can further be diluted or concentrated to result in varying concentrations of lithium and other ions.

The performance of the ion exchange process and associated ion exchange material can be measured by the durability, service life, cycle life, or combinations thereof of the ion exchange material used for lithium extraction by ion exchange. This durability, service life, or cycle life is quantified by the total service time, total amount of lithium carbonate equivalents produced per amount of ion exchange material over said service life, total number of lithium absorption-desorption ion exchange cycles that the ion exchange material can undergo before replacements, or combinations thereof. The performance of the ion exchange process and associated ion exchange material can also be measured by the cation purity of the synthetic lithium eluate (e.g., lithium ion exchange eluate solution) produced by the ion exchange material. The performance of the ion exchange process and associated ion exchange material can also be measured by amount of lithium that is absorbed by the ion exchange material in each cycle. The performance of the ion exchange process and associated ion exchange material can also be measured by quantity of ion exchange material dissolved in the synthetic lithium eluate (e.g., lithium ion exchange eluate solution). The performance of the ion exchange process and associated ion exchange material can also be measured by quantity of ion exchange material present in the solid phase that is most active phase. In the embodiments of the disclosure provided herein, one or more of these metrics are used to assess the performance of the ion exchange system and associated process.

Ion exchange beads, including ion exchange particles, ion exchange material, ion exchange media, porous ion exchange beads, and/or coated ion exchange particles, are loaded into ion exchange vessels. Alternating flows of brine, acid, and other solutions are optionally flowed through an ion exchange column or vessel to extract lithium from the brine and produce a lithium concentrate, which is eluted from the column or vessel using the acid. As brine flows through the ion exchange column or vessel, the ion exchange beads absorb lithium while releasing hydrogen, where both the lithium and hydrogen are cations. After the ion exchange beads have absorbed lithium, acid is used to elute the lithium from the ion exchange beads to produce an eluate, or synthetic lithium-enriched solution.

Ion exchange beads may have small diameters less than about one millimeter causing a high pressure difference across a packed bed of the ion exchange beads during pumping of the liquid resource and other fluids through the bed. To minimize pressure across the packed bed and to minimize associated pumping energy, vessels with optimized geometries can be used to reduce the flow distance through the packed bed of ion exchange beads. These vessels may be networked with pH modulation units to achieve adequate control of the pH of the liquid resource.

In some embodiments a network of vessels loaded with ion exchange materials may comprise two vessels, three vessels, four vessels, five vessels, six vessels, seven vessels, eight vessels, nine vessels, 10 vessels, 11 vessels, 12 vessels, 13-14 vessels, 15-20 vessels, 20-30 vessels, 30-50 vessels, 50-70 vessels, 70-100 vessels, or more than 100 vessels.

The synthetic concentrated lithium solution is an aqueous solution comprising lithium and other dissolved ions. Said synthetic lithium solution is produced by treatment of an ion exchange material that has absorbed lithium with an acidic eluent to produce an eluate. Said eluate is acidic and contains lithium in combination with other cations and anions that are present in the liquid resource from which lithium is extracted. The eluent is contacted with ion exchange material in one or more of the aforementioned ion exchange vessels to produce an eluate. Said eluate is stored in one or more different vessels that are part of an ion exchange network.

The type and concentration of lithium and other ions in the synesthetic lithium solution vary depending on the liquid resource from which lithium is extracted. The pH of the eluate can be adjusted following elution by treatment with other acidic or basic substances. The eluate can be further treated and subjected to other separation processes to result in a changed relative concentration of lithium and other ions. The eluate can further be diluted or concentrated to result in varying concentrations of lithium and other ions.

Exemplary embodiments of the present disclosure include compositions of the concentrated lithium eluate produced by lithium extraction from a liquid resource using ion exchange.

### The Liquid Resource

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from sediments, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, organic molecules, iron, certain metals, or other chemical or ionic species. In some embodiments, the liquid resource is optionally fed into the ion exchange reactor without any pre-treatment following from its source. In some embodiments, the liquid resource is injected into a reservoir, salt lake, salt flat, basin, or other geologic deposit after lithium has been removed from the liquid resource. In some embodiments, other species are recovered from the liquid resource before or after lithium recovery. In some embodiments, the pH of the liquid resource is adjusted before, during, or after lithium recovery.

In one embodiment, the liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. Accordingly, embodiments of the present disclosure directed to “brine” are also operably directed to “liquid resource.”

In one embodiment, the brine is at a temperature of-20 to 20 degrees Celsius, 20 to 50 degrees Celsius, 50 to 100 degrees Celsius, 100 to 200 degrees Celsius, or 200 to 400 degrees Celsius. In one embodiment, the brine is heated or cooled to precipitate or dissolve species in the brine, or to facilitate removal of metals from the brine.

In one embodiment, the brine contains lithium at a concentration of less than 1 mg/L, 1 to 50 mg/L, 50 to 200 mg/L, 200 to 500 mg/L, 500 to 2,000 mg/L, 2,000 to 5,000 mg/L, 5,000 to 10,000 mg/L, 10,000 to 20,000 mg/L, 20,000 to 80,000 mg/L, or greater than 80,000 mg/L.

In one embodiment, the brine contains magnesium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains calcium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains strontium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains barium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the brine contains multivalent cations at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains multivalent ions at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains non-lithium impurities at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains transition metals (e.g., one or more transition metals) at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains iron at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains manganese at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the brine is treated to produce a feed brine which has certain metals removed. In one embodiment, the feed brine contains iron at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains manganese at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains lead at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains zinc at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains lithium at a concentration of 1 to 50 mg/L, 50 to 200 mg/L, 200 to 500 mg/L, 500 to 2,000 mg/L, or greater than 2,000 mg/L.

In one embodiment, the feed brine is processed to recover metals such as lithium and yield a spent brine or raffinate. In one embodiment, the raffinate contains residual quantities of the recovered metals at a concentration of less than 0.01, 0.01 to 0.1 mg/L, mg/L, 0.1 to 1.0 mg/L, 1.0 to 10 mg/L, 10 to 100 mg/L, 100 to 1,000 mg/L, or 1,000 to 10,000 mg/L.

In one embodiment, the pH of the brine is corrected to less than 0, 0 to 1, 1 to 2, 2 to 4, 4 to 6, 6 to 8, 4 to 8, 8 to 9, 9 to 10, 9 to 11, or 10 to 12. In one embodiment, the pH of the brine is corrected to 2 to 4, 4 to 6, 6 to 8, 4 to 8, 8 to 9, 9 to 10, 9 to 11, or 10 to 12. In one embodiment, the pH of the brine is corrected to precipitate or dissolve metals.

In one embodiment, metals are precipitated from the brine to form precipitates. In one embodiment, precipitates include transition metal hydroxides, oxy-hydroxides, sulfide, flocculants, aggregate, agglomerates, or combinations thereof. In one embodiment, the precipitates include Li, Na, K, Rb, Cs, Fr, Be, Mg, Ca, Sr, Ba, Ra, Sc, Y, Ti, Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, other metals, or a combination thereof. In one embodiment, the precipitates may be concentrated into a slurry, a filter cake, a wet filter cake, a dry filter cake, a dense slurry, or a dilute slurry.

In one embodiment, the precipitates contain iron at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain manganese at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain lead at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain arsenic at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain magnesium at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain Li, Na, K, Rb, Cs, Fr, Be, Mg, Ca, Sr, Ba, Ra, Sc, Y, Ti, Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, or other metals at a concentration of less than 0.01 mg/kg, 0.01 to 1 mg/kg, 1 to 100 mg/kg, 100 to 10,000 mg/kg, or 10,000 to 800,000 mg/kg In one embodiment, the precipitates are toxic and/or radioactive.

In one embodiment, precipitates are redissolved by combining the precipitates with acid. In one embodiment, precipitates are redissolved by combining the precipitates with acid in a mixing apparatus. In one embodiment, precipitates are redissolved by combining the precipitates with acid using a high-shear mixer.

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium into an acidic solution while absorbing hydrogen. This ion exchange process is optionally repeated to extract lithium from a liquid resource and yield a concentrated lithium solution. The concentrated lithium solution is optionally further processed into chemicals for the battery industry or other industries.

Ion exchange materials are optionally formed into beads and the ion exchange beads are optionally loaded into ion exchange columns, stirred tank reactors, other reactors, or other systems for lithium extraction. Alternating flows or aliquots of brine, acidic solution, and optionally other solutions are flowed through or flowed into an ion exchange column, reactors, or reactor system to extract lithium from the brine and produce a lithium concentrate, which is eluted from the column using the acidic solution. As brine flows through the ion exchange column, reactors, or reactor system, the ion exchange material absorbs lithium while releasing hydrogen, where both the lithium and hydrogen are cations. The release of hydrogen during lithium uptake will acidify the brine and limit lithium uptake unless the pH of the brine is optionally maintained in a suitable range to facilitate thermodynamically favorable lithium uptake and concomitant hydrogen release. In one embodiment, pH of the liquid resource is maintained near a set-point through addition of base to neutralized protons released from the ion exchange material into the liquid resource.

### Treatment of the Liquid Resource

In some embodiments, the pH of the liquid resource is adjusted before, during and/or after contact with the lithium-selective ion exchange material to maintain the pH in range that is suitable for lithium uptake.

To control the pH of the brine and maintain the pH in a range that is suitable for lithium uptake in an ion exchange column (e.g., vessel, tank, compartment, filter bank), bases such as NaOH, Ca(OH)₂, CaO, KOH, or NH₃ are optionally added to the brine as solids, aqueous solutions, or in other forms. For brines that contain divalent ions such as Mg, Ca, Sr, or Ba, addition of base to the brine can cause precipitation of solids, such as Mg(OH)₂ or Ca(OH)₂, which can cause problems for the ion exchange reaction. These precipitates cause problems in at least three ways. First, precipitation can remove base from solution, leaving less base available in solution to neutralize protons and maintain pH in a suitable range for lithium uptake in the ion exchange column. Second, precipitates that form due to base addition can clog the ion exchange column, including clogging the surfaces and pores of ion exchange beads and the voids between ion exchange beads. This clogging can prevent lithium from entering the ion exchange beads and being absorbed by the ion exchange material. The clogging can also cause large pressure heads in the column. Third, precipitates in the column dissolve during acid elution and thereby contaminate the lithium concentrate produced by the ion exchange system. For ion exchange beads to absorb lithium from brine, an ideal pH range for the brine is optionally 5 to 7, a preferred pH range is optionally 4 to 8, and an acceptable pH range is optionally 1 to 9. In one embodiment, an pH range for the brine is optionally about 1 to about 14, about 2 to about 13, about 3 to about 12, about 4 to about 12, about 4.5 to about 11, about 5 to about 10, about 5 to about 9, about 2 to about 5, about 2 to about 4, about 2 to about 3, about 3 to about 8, about 3 to about 7, about 3 to about 6, about 3 to about 5, about 3 to about 4, about 4 to about 10, about 4 to about 9, about 4 to about 8, about 4 to about 7, about 4 to about 6, about 4 to about 5, about 5 to about 6, about 5 to about 7, about 5 to about 8, about 6 to about 7, about 6 to about 8, or about 7 to about 8.

In one embodiment, the liquid resource is subjected to treatment prior to ion exchange. In some embodiments, said treatment comprises filtration, gravity sedimentation, centrifugal sedimentation, magnetic fields, other methods of solid-liquid separation, or combinations thereof. In some embodiments, precipitated metals are removed from the brine using a filter. In some embodiments, the filter is a belt filter, plate-and-frame filter press, pressure vessel containing filter elements, rotary drum filter, rotary disc filter, cartridge filter, a centrifugal filter with a fixed or moving bed, a metal screen, a perforate basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon.

In some embodiments, a filter cake is prevented, limited, or removed by using gravity, centrifugal force, an electric field, vibration, brushes, liquid jets, scrapers, intermittent reverse flow, vibration, crow-flow filtration, or pumping suspensions across the surface of the filter. In some embodiments, the precipitated metals and a liquid is moved tangentially to the filter to limit cake growth. In some embodiments, gravitational, magnetic, centrifugal sedimentation, or other means of solid-liquid separation are used before, during, or after filtering to prevent cake formation.

In some embodiments, a filter comprises a screen, a metal screen, a sieve, a sieve bend, a bent sieve, a high frequency electromagnetic screen, a resonance screen, or combinations thereof. In some embodiments, one or more particle traps are a solid-liquid separation apparatus.

In some embodiments, one or more solid-liquid separation apparatuses may be used in series or parallel. In some embodiments, a dilute slurry is removed from the tank, transferred to an external solid-liquid separation apparatus, and separated into a concentrated slurry and a solution with low or no suspended solids. In some embodiments, the concentrated slurry is returned to the tank or transferred to a different tank. In some embodiments, precipitate metals are transferred from a brine tank to another brine tank, from an acid tank to another acid tank, from a washing tank to another washing tank, from a brine tank to a washing tank, from a washing tank to an acid tank, from an acid tank to a washing tank, or from an acid tank to a brine tank.

In some embodiments, solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the ion exchange particles into a zone where the particles can leave through the bottom of the thickener.

In some embodiments, solid-liquid separation apparatuses include a deep cone, a deep cone tank, a deep cone compression tank, or a tank wherein the slurry is compacted by weight. In some embodiments, solid-liquid separation apparatuses include a tray thickener with a series of thickeners oriented vertically with a center axle and raking components. In some embodiments, solid-liquid separation apparatuses include a lamella type thickener with inclined plates or tubes that may be smooth, flat, rough, or corrugated. In some embodiments, solid-liquid separation apparatuses include a gravity clarifier that may be a rectangular basin with feed at one end and overflow at the opposite end optionally with paddles and/or a chain mechanism to move particles. In some embodiments, the solid-liquid separation apparatuses may be a particle trap.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may have multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated metals entering near the middle of the apparatus, and precipitated metals get trapped at the bottom and center of the apparatus due to a “teacup effect”.

### Ion Exchange Material

An aspect of the disclosure described herein is a system wherein the ion exchange material comprises a plurality of ion exchange particles. In an embodiment, the plurality of ion exchange particles in the ion exchange material is selected from uncoated ion exchange particles, coated ion exchange particles and combinations thereof. In an embodiment, the ion exchange material is a porous ion exchange material. In an embodiment, the porousion exchange material comprises a network of pores that allows liquids to move quickly from the surface of the porous ion exchange material to the plurality of ion exchange particles. In an embodiment, the ion exchange material is in the form of porous ion exchange beads. Accordingly, embodiments of the disclosure detailed herein that are directed to “ion exchange beads” are also operably directed to “ion exchange material.” In an embodiment, the liquid resource is a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

Ion exchange materials are typically small particles, which together constitute a fine powder. In some embodiments small particle size minimizes the diffusion distance that lithium must travel into the core of the ion exchange particles. In some cases, these particles are optionally coated with protective surface coatings to minimize dissolution of the ion exchange materials while allowing efficient transfer of lithium and hydrogen to and from the particles.

In an embodiment, the coated ion exchange particles are comprised of an ion exchange material and a coating material wherein the ion exchange material comprises Li₄Mn₅O₁₂, Li_{1.6}Mn_{1.6}O₄, Li₂MO₃ (M=Ti, Mn, Sn), LiFePO₄, solid solutions thereof, or combinations thereof and the coating material comprises TiO₂, ZrO₂, MoO₂, Li₇TiO₃, Li₂ZrO₃, LiNbO₃, AlF₃, SiC, Si₃N₄, graphitic carbon, amorphous carbon, diamond-like carbon, or combinations thereof. The coated ion exchange particles have an average diameter less than about 100 nm, less than about 1,000 nm, or less than about 10,000 nm, and the coating thickness is less than about 1 nm, less than about 10 nm, or less than about 100 nm. The particles are created by first synthesizing the ion exchange material using a method such as hydrothermal, solid state, or microwave. The coating material is then deposited on the surface of the ion exchange material using a method such as chemical vapor deposition, hydrothermal, solvothermal, sol-gel, precipitation, or microwave. The coated ion exchange particles are treated with an acid solution prepared with hydrochloric acid, sulfuric acid, nitric acid, or combinations thereof wherein the concentration of the acid solution is greater than about 0.1 M, greater than about 1.0 M, greater than about 5 M, greater than about 10 M, or combinations thereof. During acid treatment, the particles absorb hydrogen while releasing lithium. The ion exchange material is converted to a hydrated state with a hydrogen-rich composition (e.g., a hydrogen-rich ion exchange material, a hydrated ion exchange material). The coating material allows diffusion of hydrogen and lithium respectively to and from the ion exchange material while providing a protective barrier that limits dissolution of the ion exchange material. After treatment in acid, the hydrated coated ion exchange particles are treated with a liquid resource wherein the liquid resource is a natural brine, a dissolved salt flat, a concentrated brine, a processed brine, a synthetic brine, liquid from an ion exchange process, liquid from a solvent extraction process, leachate from minerals, leachate from clays, leachate from recycled products, leachate from recycled materials, or combinations thereof. The coated ion exchange particles absorb lithium while releasing hydrogen. The lithium salt solution is then collected. The coated ion exchange particles are capable then perform the ion exchange reaction repeatedly over a number of cycles greater than about 10 cycles, greater than about 30 cycles, greater than about 100 cycles, or greater than about 300 cycles.

In some embodiments, a cycle comprises contacting an ion exchange material (e.g., a hydrogen-rich ion exchange material, a hydrated ion exchange material) with a liquid resource (e.g., brine) to provide a lithiated ion exchange material and contacting the lithiated ion exchange material with an acidic solution (e.g., acid) to provide a lithium eluate (e.g., lithium concentrate, synthetic lithium solution, synthetic lithium eluate, lithium ion exchange eluate solution). In some embodiments, the ion exchange material is used (e.g., a process for generating a lithium ion exchange eluate solution is conducted) for at least 10 cycles, at least 50 cycles, at least 100 cycles, at least 250 cycles, at least 500 cycles, at least 1000 cycles, at least 2000 cycles, at least 3000 cycles, at least 4000 cycles, at least 5000 cycles, at least 6000 cycles, at least 7000 cycles, at least 8000 cycles, at least 9000 cycles, or at least 10000 cycles.

One major challenge for lithium extraction using inorganic ion exchange particles is the loading of the particles into an ion exchange column in such a way that brine and acid are optionally pumped efficiently through the column with minimal clogging. The materials are optionally formed into beads, and the ion exchange beads are optionally loaded into the column. This bead loading creates void spaces between the ion exchange beads, and these void spaces facilitate pumping through the column. The ion exchange beads hold the ion exchange particles in place and prevent free movement of the particles throughout the column. When the materials are formed into beads, the penetration of brine and acid solutions into the ion exchange beads become slow and challenging. A slow rate of convection and diffusion of the acid and brine solutions into the ion exchange bead slows the kinetics of lithium absorption and release. Such slow kinetics can create problems for column operation. Slow kinetics can require slow pumping rates through the column. Slow kinetics can also lead to low lithium recovery from the brine and inefficient use of acid to elute the lithium.

In some embodiments, the ion exchange beads are porous ion exchange beads with networks of pores that facilitate the transport into the ion exchange beads of solutions that are pumped through an ion exchange column. Pore networks are optionally strategically controlled to provide fast and distributed access for the brine and acid solutions to penetrate into the ion exchange bead and deliver lithium and hydrogen to the ion exchange particles.

In some embodiments, the ion exchange beads are formed by mixing ion exchange particles, a matrix material, and a filler material. These components are mixed and formed into a bead. Then, the filler material is removed from the ion exchange bead to leave behind pores. The filler material is dispersed in the ion exchange bead in such a way to leave behind a pore structure that enables transport of lithium and hydrogen with fast kinetics. This method optionally involves multiple ion exchange materials, multiple polymer materials, and multiple filler materials.

Another major challenge for lithium extraction using inorganic ion exchange materials is dissolution and degradation of the ion exchange materials, especially during lithium elution in acid but also during lithium uptake in liquid resources. To yield a concentrated lithium solution (e.g., lithium eluate) from the ion exchange process (e.g., one or more cycles), it is desirable to use a concentrated acid solution to elute the lithium. However, concentrated acid solutions dissolve and degrade inorganic ion exchange materials, which decrease the performance and lifespan of the materials. Therefore, the porous ion exchange beads optionally contain coated ion exchange particles for lithium extraction that are comprised of an ion exchange material and a coating material protecting the particle surface. The coating protects the ion exchange material from dissolution and degradation during lithium elution in acid, during lithium uptake from a liquid resource, and during other aspects of an ion exchange process. This coated particle enables the use of concentrated acids in the ion exchange process to yield concentrated lithium solutions.

In this disclosure, the ion exchange material is selected for high lithium absorption capacity, high selectivity for lithium in a liquid resource relative to other ions such as sodium and magnesium, strong lithium uptake in liquid resources including those with low concentrations of lithium, facile elution of lithium with a small excess of acid, and fast ionic diffusion. A coating material is optionally selected to protect the particle from dissolution and chemical degradation during lithium recovery in acid and also during lithium uptake in various liquid resources. A coating material optionally is also selected to facilitate diffusion of lithium and hydrogen between the particles and the liquid resources, to enable adherence of the particles to a structural support, and to suppress structural and mechanical degradation of the particles.

When the porous ion exchange beads are used in an ion exchange column, the liquid resource containing lithium is pumped through the ion exchange column so that the ion exchange particles absorb lithium from the liquid resource while releasing hydrogen. After the ion exchange beads have absorbed lithium, an acid solution is pumped through the column so that the particles release lithium into the acid solution while absorbing hydrogen. The column is optionally operated in co-flow mode with the liquid resource and acid solution alternately flowing through the column in the same direction, or the column is optionally operated in counter-flow mode with a liquid resource and acid solution alternately flowing through the column in opposite directions. Between flows of the liquid resource and the acid solution, the column is optionally treated or washed with water or other solutions for purposes such as adjusting pH in the column or removing potential contaminants. The ion exchange beads optionally form a fixed or moving bed, and the moving bed optionally moves in counter-current to the brine and acid flows. The ion exchange beads are optionally moved between multiple columns with moving beds where different columns are used for brine, acid, water, or other flows. Before or after the liquid resource flows through the column, the pH of the liquid is optionally adjusted with NaOH or other chemicals to facilitate the ion exchange reaction as well as handling or disposal of the spent liquid resource. Before or after the liquid resource flows through the column, the liquid resource is optionally subjected to other processes including other ion exchange processes, solvent extraction, evaporation, chemical treatment, or precipitation to remove lithium, to remove other chemical species, or to otherwise treat the brine.

When the ion exchange particles are treated with acid, a lithium solution is produced. This lithium solution is optionally further processed to produce lithium chemicals. These lithium chemicals are optionally supplied for an industrial application. In some embodiments, an ion exchange material is selected from the following list: an oxide, a phosphate, an oxyfluoride, a fluorophosphate, or combinations thereof. In some embodiments, an ion exchange material (e.g., lithiated ion exchange material) is selected from the following list: LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In a further aspect, an ion exchange material comprises LiFePO₄, Li₂SnO₃, Li₂MnO₃, Li₂TiO₃, Li₄Ti₅O₁₂, Li₄Mn₅O₁₂, Li_{1.6}Mn_{1.6}O₄, solid solutions thereof, or combinations thereof.

In a further aspect described herein, the coating material allows diffusion to and from the ion exchange material. In particular, the coating material facilitates diffusion of lithium and hydrogen between the particles and the liquid resources, enables adherence of the particles to a structural support, and suppresses structural and mechanical degradation of the particles. In a further aspect described herein, the coating material comprises a carbide, a nitride, an oxide, a phosphate, a fluoride, a polymer, carbon, a carbonaceous material, or combinations thereof. In a further aspect, the coating material comprises polyvinylidene difluoride, polyvinyl chloride, a fluoro-polymer, a chloro-polymer, or a fluoro-chloro-polymer. In a further aspect, a coating material comprises Nb₂O₅, Ta₂O₅, MoO₂, TiO₂, ZrO₂, SnO₂, SiO₂, Li₂O, Li₂TiO₃, Li₂ZrO₃, Li₂MoO₃, LiNbO₃, LiTaO₃, Li₂SiO₃, Li₂Si₂O₅, Li₂MnO₃, ZrSiO₄, AlPO₄, LaPO₄, ZrP₂O₇, MoP₂O₇, MO₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In a further aspect, a coating material comprises TiO₂, ZrO₂, SiO₂, Li₂TiO₃, Li₂ZrO₃, Li₂MnO₃, ZrSiO₄, or LiNbO₃. In a further aspect, a coating material comprises a chloro-polymer, a fluoro-polymer, a chloro-fluoro-polymer, a hydrophilic polymer, a hydrophobic polymer, co-polymers thereof, mixtures thereof, or combinations thereof. In a further aspect, a coating material comprises a co-polymer, a block co-polymer, a linear polymer, a branched polymer, a cross-linked polymer, a heat-treated polymer, a solution processed polymer, co-polymers thereof, mixtures thereof, or combinations thereof. In a further aspect, a coating material comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly (4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In a further aspect, a coating material comprises polyvinylidene fluoride (PVDF), polyvinyl chloride (PVC), ethylene chlorotrifluoro ethylene (Halar), poly (4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In a further aspect, a coating is deposited onto an ion exchange particle by dry mixing, mixing in solvent, emulsion, extrusion, bubbling one solvent into another, casting, heating, evaporating, vacuum evaporation, spray drying, vapor deposition, chemical vapor deposition, microwaving, hydrothermal synthesis, polymerization, co-polymerization, cross-linking, irradiation, catalysis, foaming, other deposition methods, or combinations thereof. In a further aspect, a coating is deposited using a solvent comprising N-methyl-2-pyrrolidone, dimethyl sulfoxide, tetrahydrofuran, dimethylformamide, dimethylacetamide, methyl ethyl ketone, ethanol, acetone, other solvents, or combinations thereof. In a further aspect, a coating is deposited using a solvent comprising N-methyl-2-pyrrolidone, dimethyl sulfoxide, tetrahydrofuran, dimethylformamide, dimethylacetamide, methyl ethyl ketone, ethanol, acetone, or combinations thereof.

In a further aspect described herein, the coated ion exchange particles have an average diameter less than about 10 nm, less than about 100 nm, less than about 1,000 nm, less than about 10,000 nm, or less than about 100,000 nm. In a further aspect, the coated ion exchange particles have an average size less than about 100 nm, less than about 1,000 nm, or less than about 10,000 nm. In a further aspect, the coated ion exchange particles are optionally secondary particles comprised of smaller primary particles that have an average diameter less than about 10 nm, less than about 100 nm, less than about 1,000 nm, less than about 10,000 nm, or less than about 100,000 nm. In a further aspect, the coating optionally coats the primary ion exchange particles. In a further aspect, the coating optionally coats the secondary ion exchange particles. In a further aspect, the coating optionally coats the secondary ion exchange particles. In a further aspect, the coating optionally coats both the primary ion exchange particles and the secondary ion exchange particles. In a further aspect, the primary ion exchange particles optionally have a first coating and the secondary ion exchange particles optionally have a second coating that is optionally identical, similar, or different in composition to the first coating.

It is recognized that measurements of average particle diameter can vary according to the method of determination utilized. Determination of said average particle diameter according to one method to obtain one or more values shall be understood to inherently encompass all other values that may be obtained using other methods. The average particle diameter can be determined using sieve analysis. The average particle diameter can be determined using optical microscopy. The average particle diameter can be determined using electron microscopy. The average particle diameter can be determined using laser diffraction. In some embodiments, the average particle diameter is determined using laser diffraction, wherein a Bettersizer ST instrument is used. In some embodiments, the average particle diameter is determined using a Bettersizer ST instrument. In some embodiments, the average particle diameter is determined using laser diffraction, wherein an Anton-Parr particle size analyzer (PSA) instrument is used. In some embodiments, the average particle diameter is determined using an Anton-Parr PSA instrument. The average particle diameter can be determined using dynamic light scattering. The average particle diameter can be determined using static image analysis. The average particle diameter can be determined using dynamic image analysis.

In some embodiments described herein, the coating material has a thickness less than about 1 nm, less than about 10 nm, less than about 100 nm, less than about 1,000 nm, or less than about 10,000 nm. In further embodiments, the coating material has a thickness less than about 5 nm, less than about 50 nm, or less than about 500 nm. In some embodiments, the ion exchange particles have a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm. In certain embodiments, the coating material has a thickness between about 0.5 nm to about 1000 nm. In some embodiments, the coating material has a thickness between about 1 nm to about 100 nm.

In a further aspect described herein, the ion exchange material and the coating material form one or more concentration gradients where the chemical composition of the particle ranges between two or more compositions. In a further aspect, the chemical composition optionally varies between the ion exchange materials and the coating in a manner that is continuous, discontinuous, or continuous and discontinuous in different regions of the particle. In a further aspect, the ion exchange materials and the coating materials form a concentration gradient that extends over a thickness less than about 1 nm, less than about 10 nm, less than about 100 nm, less than about 1,000 nm, less than about 10,000 nm, or less than about 100,000 nm. In a further aspect, the ion exchange materials and the coating materials form a concentration gradient that extends over a thickness of about 1 nm to about 1,000 nm.

In some embodiments, coating thickness may be measured by any one or more of electron microscopy, optical microscopy, couloscopy, nanoindentation, atomic force microscopy, and X-ray fluorescence. In some embodiments, coating thickness may be inferred or extrapolated from data obtained according to an analytical method that indicates the bulk composition of the coated ion exchange particle, or the ion exchange material that further comprises the coating material. In some embodiments, coating thickness may be inferred by differential analysis of data obtained by analysis of ion exchange material that further comprises a coating material and data obtained by analysis ion exchange material that does not further comprise a coating material. In some embodiments, coating thickness may be inferred by differential analysis of data obtained by analysis of one or more coated ion exchange particles and data obtained by analysis of one or more uncoated ion exchange particles.

In a further aspect described herein, the ion exchange material is synthesized by a method such as hydrothermal, solvothermal, sol-gel, solid state, molten salt flux, ion exchange, microwave, ball milling, chemical precipitation, co-precipitation, vapor deposition, or combinations thereof. In a further aspect, the ion exchange material is synthesized by a method such as chemical precipitation, hydrothermal, solid state, or combinations thereof.

In a further aspect described herein, the coating material is deposited by a method such as chemical vapor deposition, atomic layer deposition, physical vapor deposition, hydrothermal, solvothermal, sol-gel, solid state, molten salt flux, ion exchange, microwave, chemical precipitation, co-precipitation, ball milling, pyrolysis, or combinations thereof. In a further aspect, the coating material is deposited by a method such as sol-gel, chemical precipitation, or combinations thereof. In a further aspect, the coating materials is deposited in a reactor that is optionally a batch tank reactor, a continuous tank reactor, a batch furnace, a continuous furnace, a tube furnace, a rotary tube furnace, or combinations thereof.

In some embodiments, a coating material is deposited with physical characteristics selected from the following list: crystalline, amorphous, full coverage, partial coverage, uniform, non-uniform, or combinations thereof.

In some embodiments, multiple coatings are optionally deposited on the ion exchange material in an arrangement selected from the following list: concentric, patchwork, or combinations thereof.

In some embodiments, the matrix material is selected from the following list: a polymer, an oxide, a phosphate, or combinations thereof. In some embodiments, a structural support (e.g., a structural support to which ion exchange material can be adhered, a support structure within which an ion exchange material can be embedded) is selected from the following list: polyvinyl fluoride, polyvinylidene fluoride, polyvinyl chloride, polyvinylidene chloride, polyethylene, polypropylene, polyphenylene sulfide, polytetrafluoroethylene, polytetrofluoroethylene, sulfonated polytetrofluoroethylene, polystyrene, polydivinylbenzene, polybutadiene, sulfonated polymer, carboxylated polymer, Nafion, copolymers thereof, and combinations thereof. In some embodiments, a structural support is selected from the following list: polyvinylidene difluoride, polyvinyl chloride, sulfonated polytetrofluoroethylene, polystyrene, polydivinylbenzene, copolymers thereof, or combinations thereof. In some embodiments, a structural support is selected from the following list: titanium dioxide, zirconium dioxide, silicon dioxide, solid solutions thereof, or combinations thereof. In some embodiments, the matrix material is selected for thermal resistance, acid resistance, and/or other chemical resistance.

In some embodiments, the porous ion exchange bead is formed by mixing the ion exchange particles, the matrix material, and the filler material together at once. In some embodiments, the porous ion exchange bead is formed by first mixing the ion exchange particles and the matrix material, and then mixing with the filler material. In some embodiments, the porous ion exchange bead is formed by first mixing the ion exchange particles and the filler material, and then mixing with the matrix material. In some embodiments, the porous ion exchange bead is formed by first mixing the matrix material and the filler material, and then mixing with the ion exchange particles.

In some embodiments, the porous ion exchange bead is formed by mixing the ion exchange particles, the matrix material, and/or the filler material with a solvent that dissolves once or more of the components. In some embodiments, the porous ion exchange bead is formed by mixing the ion exchange particles, the matrix material, and/or the filler material as dry powders in a mixer or ball mill. In some embodiments, the porous ion exchange bead is formed by mixing the ion exchange particles, the matrix material, and/or the filler material in a spray drier.

In some embodiments, the matrix material is a polymer that is dissolved and mixed with the ion exchange particles and/or filler material using a solvent from the following list: n-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved and mixed with the ion exchange particles and/or matrix material using a solvent from the following list: water, ethanol, iso-propyl alcohol, acetone, or combinations thereof.

In some embodiments, the filler material is a salt that is dissolved out of the ion exchange bead to form pores using a solution selected from the following list: water, ethanol, iso-propyl alcohol, a surfactant mixture, an acid a base, or combinations thereof. In some embodiments, the filler material is a material that thermally decomposes to form a gas at high temperature so that the gas can leave the ion exchange bead to form pores, where the gas is selected from the following list: water vapor, oxygen, nitrogen, chlorine, carbon dioxide, nitrogen oxides, organic vapors, or combinations thereof.

In some embodiments, the porous ion exchange bead is formed from dry powder using a mechanical press, a pellet press, a tablet press, a pill press, a rotary press, or combinations thereof. In some embodiments, the porous ion exchange bead is formed from a solvent slurry by dripping the slurry into a different liquid solution. The solvent slurry is optionally formed using a solvent of n-methyl-2-pyrrolidone, dimethyl sulfoxide, tetrahydrofuran, dimethylformamide, dimethylacetamide, methyl ethyl ketone, or combinations thereof. The different liquid solution is optionally formed using water, ethanol, iso-propyl alcohol, acetone, or combinations thereof.

In some embodiments, the porous ion exchange bead is approximately spherical with an average diameter selected from the following list: less than 10 μm, less than 100 μm, less than 1 mm, less than 1 cm, or less than 10 cm. In some embodiments, the porous ion exchange bead is approximately spherical with an average diameter selected from the following list: less than 200 μm, less than 2 mm, or less than 20 mm. In certain embodiments, the porous ion exchange bead is approximately spherical with an average diameter between 10 μm and 2 mm.

In some embodiments, the porous ion exchange bead is tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm. In certain embodiments, the porous ion exchange bead is tablet-shaped with a diameter between 500 μm and 10 mm.

In some embodiments, the porous ion exchange bead is embedded in a support structure, which is optionally a membrane, a spiral-wound membrane, a hollow fiber membrane, or a mesh. In some embodiments, the porous ion exchange bead is embedded on a support structure comprised of a polymer, a ceramic, or combinations thereof. In some embodiments, the porous ion exchange bead is loaded directly into an ion exchange column with no additional support structure.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, or organic molecules. In some embodiments, the liquid resource is optionally enter the ion exchange reactor without any pre-treatment following from its source.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

System for Extracting Lithium from a Liquid Resource

In one aspect described herein, is a system for lithium extraction from a liquid resource comprising one or more vessels independently configured to simultaneously accommodate porous ion exchange beads moving in one direction and alternately acid, brine, and optionally other solutions moving in the net opposite direction. This lithium extraction system produces an eluate which is concentrated in lithium and optionally contains other ions.

In one aspect described herein, there is a device for lithium extraction from a liquid resource comprising a stirred rank reactor, an ion exchange material, and a pH modulating setup for increasing the pH of the liquid resource in the stirred tank reactor.

In one aspect described herein, is a device for lithium extraction from a liquid resource comprising a stirred rank reactor, an ion exchange material, a pH modulating setup for increasing the pH of the liquid resource in the stirred tank reactor, and a compartment for containing the ion exchange material in the stirred tank reactor while allowing for removal of liquid resource, washing fluid, and acid solutions from the stirred tank reactor.

In one embodiment, at least one of the one or more vessels are fitted with a conveyer system suitably outfitted to move porous ion exchange beads upward and simultaneously allow a net flow of acid, brine, and optionally other solutions, downward. In one embodiment, the conveyor system comprises fins with holes. In one embodiment, wherein the fins slide upward over a sliding surface that is fixed in place. In one embodiment, the fins slide upward over a sliding surface that is fixed in place. In one embodiment, all of the one or more vessels are fitted with a conveyor system suitably outfitted to move porous ion exchange beads upward and simultaneously allow a net flow of acid, brine, and optionally other solutions, downward. In one embodiment, there are an even number of vessels. In one embodiment, there are an odd number of vessels. In one embodiment, the vessels are columns.

In some embodiments, structures with holes are used to move the ion exchange material through one or more vessels. In some embodiments, the holes in the structures may be less than 10 microns, less than 100 microns, less than 1,000 microns, or less than 10,000 microns. In some embodiments, the structures may be attached to a conveyer system. In some embodiments, the structures may comprise a porous compartment, porous partition, or other porous structure. In some embodiments, the structures may contain a bed of fixed or fluidized ion exchange material. In some embodiments, the structures may contain ion exchange material while allowing brine, aqueous solution, or acid solution to pass through the structures.

In one embodiment, the porous ion exchange beads comprise ion exchange particles that reversibly exchange lithium and hydrogen and a structural matrix material and having a pore network. In one embodiment, the liquid resource comprises a natural brine, a dissolve salt flat, a concentrated brine, a processed brine, a filtered brine, a liquid from an ion exchange process, a liquid from a solvent extraction process, a synthetic brine, leachate from ores, leachate from minerals, leachate from clays, leachate from recycled products, leachate from recycled materials, or combinations thereof.

### Recirculating Batch System

In an embodiment of the system, the ion exchange material is loaded in a column. In an embodiment of the system, the pH modulating setup is connected to the column loaded with the ion exchange material. In an embodiment of the system, the pH modulating setup comprises one or more tanks.

In some embodiments of the systems described herein, the ion exchange material is loaded in a vessel. In some embodiments, the pH modulating setup is in fluid communication with the vessel loaded with the ion exchange material. In some embodiments, the pH modulating setup is in fluid communication with the column loaded with the ion exchange material.

In one embodiment of the system, one or more ion exchange columns are loaded with a fixed or fluidized bed of ion exchange beads. In one embodiment of the system, the ion exchange column is a cylindrical construct with entry and exit ports. In a further embodiment, the ion exchange column is optionally a non-cylindrical construct with entry and exit ports. In a further embodiment, the ion exchange column optionally has entry and exit ports for brine pumping, and additional doors or hatches for loading and unloading ion exchange beads to and from the column. In a further embodiment, the ion exchange column is optionally equipped with one or more security devices to decrease the risk of theft of the ion exchange beads. In one embodiment, these beads contain ion exchange material that can reversibly absorb lithium from brine and release lithium in acid. In one embodiment, the ion exchange material is comprised of particles that are optionally protected with coating material such as SiO₂, ZrO₂, or TiO₂ to limit dissolution or degradation of the ion exchange material. In one embodiment, these beads contain a structural component such as an acid-resistant polymer that binds the ion exchange materials. In one embodiment, the ion exchange beads contain pores that facilitate penetration of brine, acid, aqueous, and other solutions into the ion exchange beads to deliver lithium and hydrogen to and from the ion exchange bead or to wash the ion exchange bead. In one embodiment, the ion exchange bead pores are structured to form a connected network of pores with a distribution of pore sizes and are structured by incorporating filler materials during bead formation and later removing that filler material in a liquid or gas.

In one embodiment of the system, the system is a recirculating batch system, which comprises an ion exchange column that is connected to one or more tanks for mixing base into the brine, settling out any precipitates following base addition, and storing the brine prior to reinjection into the ion exchange column or the other tanks. In one embodiment of the recirculating batch system, the brine is loaded into one or more tanks, pumped through the ion exchange column, pumped through a series of tanks, and then returned to the ion exchange column in a loop. In one embodiment, the brine optionally traverses this loop repeatedly. In one embodiment, the brine is recirculated through the ion exchange column to enable optimal lithium uptake by the ion exchange beads. In one embodiment, base is added to the brine in such a way that pH is maintained at an adequate level for lithium uptake and in such a way that the amount of base-related precipitates in the ion exchange column is minimized.

In one embodiment, as the brine is pumped through the recirculating batch system, the brine pH drops in the ion exchange column due to hydrogen release from the ion exchange beads during lithium uptake, and the brine pH is adjusted upward by the addition of base as a solid, aqueous solution, or other form. In one embodiment, the ion exchange system drives the ion exchange reaction to near completion, and the pH of the brine leaving the ion exchange column approaches the pH of the brine entering the ion exchange column. In one embodiment, the amount of base added is optionally controlled to neutralize the hydrogen released by the ion exchange beads in such a way that no basic precipitates form. In one embodiment, an excess of base or a transient excess of base is optionally added in such a way that basic precipitates form. In one embodiment, the basic precipitates form transiently and then are redissolved partially or fully by the hydrogen that is released from the ion exchange column. In one embodiment of the system, base is optionally added to the brine flow prior to the ion exchange column, after the ion exchange column, prior to one or more tanks, or after one or more tanks.

In one embodiment of the recirculating batch system, the tanks include a mixing tank where the base is mixed with the brine. In one embodiment, the tanks include a settling tank, where precipitates such as Mg(OH)₂ optionally settle to the bottom of the settling tank to avoid injection of the precipitates into the ion exchange column. In one embodiment, the tanks include a storage tank where the brine is stored prior to reinjection into the ion exchange column, mixing tank, settling tank, or other tanks. In one embodiment, the tanks include an acid recirculation tank. In one embodiment, some tanks in the recirculating batch reactor optionally serve a combination of purposes including base mixing tank, settling tank, acid recirculation tank, or storage tank. In any embodiment, a tank optionally does not fulfil two functions at the same time. For example, a tank is not a base mixing tank and a settling tank.

In one embodiment of the recirculating batch system, base is added to a mixing tank, which is optionally a continuous stirred tank system, a confluence of acidified brine flow and base flow followed by a static mixer, a confluence of acidified brine flow and base flow followed by a paddle mixer, a confluence of acidified brine flow and base flow followed by a turbine impeller mixer, or a continuous stirred tank system in the shape of a vertical column which is well mixed at the bottom and settled near the top. In one embodiment, the base is optionally added as a solid or as an aqueous solution. In one embodiment, the base is optionally added continuously at a constant or variable rate. In one embodiment, the base is optionally added discretely in constant or variable aliquots or batches. In one embodiment, the base is optionally added according to one or more pH meters, which optionally samples brine downstream of the ion exchange column or elsewhere in the recirculating batch system. In one embodiment, filters are optionally used to prevent precipitates from leaving the mixing tank. In one embodiment, the filters are optionally plastic mesh screens, small packed columns containing granular media such as sand, silica, or alumina, small packed columns containing porous media filter, or a membrane.

In one embodiment of the recirculating batch system, the settling tank is optionally a settling tank with influent at bottom and effluent at top or a settling tank with influent on one end and effluent on another end. In one embodiment, chambered weirs are used to fully settle precipitates before brine is recirculated into reactor. In one embodiment, solid base precipitates are collected at the bottom of the settling tank and recirculated into the mixer. In one embodiment, precipitates such as Mg(OH)₂ optionally settle near the bottom of the tank. In one embodiment, brine is removed from the top of the settling tank, where the amount of suspended precipitates is minimal. In one embodiment, the precipitates optionally settle under forces such as gravity, centrifugal action, or other forces. In one embodiment, filters are optionally used to prevent precipitates from leaving the settling tank. In one embodiment, the filters are optionally plastic mesh screens, small packed columns containing granular media such as sand, silica, or alumina, small packed columns containing porous media filter, or a membrane. In one embodiment, baffles are optionally used to ensure settling of the precipitate and to prevent the precipitate from exiting the settling tank and entering the column.

In one embodiment of the recirculating batch system, basic precipitates are optionally collected from the settling tank and reinjected into the brine in a mixing tank or elsewhere to adjust the pH of the brine.

In one embodiment of the recirculating batch system, one or more ion exchange columns are optionally connected to one or more tanks or set of tanks. In one embodiment of the recirculating batch system, there are optionally multiple ion exchange columns recirculating brine through a shared set of mixing, settling, and storage tanks. In one embodiment of the recirculating batch system, there is optionally one ion exchange column recirculating brine through multiple sets of mixing, settling, and storage tanks.

### Column Interchange System

An aspect of the disclosure described herein is a system wherein the ion exchange material is loaded in a plurality of columns. In an embodiment, the pH modulating setup comprises a plurality of tanks connected to the plurality of columns, wherein each of the plurality of tanks is immediately connected to one of the plurality of columns. In an embodiment, two or more of the plurality of tanks connected to the plurality of columns forms at least one circuit. In an embodiment, three or more of the plurality of tanks connected to the plurality of columns forms at least two circuits. In an embodiment, three or more of the plurality of tanks connected to the plurality of columns forms at least three circuits. In an embodiment, at least one circuit is a liquid resource circuit. In an embodiment, at least one circuit is a water washing circuit. In an embodiment, at least one circuit is an acid solution circuit. In an embodiment, at least two circuits are water washing circuits.

In one embodiment of the ion exchange system, the system is a column interchange system where a series of ion exchange columns are connected to form a brine circuit, an acid circuit, a water washing circuit, and optionally other circuits. In one embodiment of the brine circuit, brine flows through a first column in the brine circuit, then into a next column in the brine circuit, and so on, such that lithium is removed from the brine as the brine flows through one or more columns. In one embodiment of the brine circuit, base is added to the brine before or after each ion exchange column or certain ion exchange columns in the brine circuit to maintain the pH of the brine in a suitable range for lithium uptake by the ion exchange beads. In one embodiment of the acid circuit, acid flows through a first column in the acid circuit, then into the next column in the acid circuit, and so on, such that lithium is eluted from the columns with acid to produce a lithium concentrate. In one embodiment of the acid circuit, acid flows through a first column in the acid circuit, then optionally into a next column in the acid circuit, and so on, such that lithium is eluted from the columns with acid to produce a lithium concentrate. In one embodiment of the water washing circuit, water flows through a first column in the water washing circuit, then optionally into a next column in the water washing circuit, and so on, such that brine in the void space, pore space, or head space of the columns in the water washing circuit is washed out.

In one embodiment of the column interchange system, ion exchange columns are interchanged between the brine circuit, the water washing circuit, and the acid circuit. In one embodiment, the first column in the brine circuit is loaded with lithium and then interchanged into the water washing circuit to remove brine from the void space, pore space, or head space of the column. In one embodiment, the first column in the water washing circuit is washed to remove brine, and then interchanged to the acid circuit, where lithium is eluted with acid to form a lithium concentrate. In one embodiment, the first column in the acid circuit is eluted with acid and then interchanged into the brine circuit to absorb lithium from the brine. In one embodiment of the column interchange system, two water washing circuits are used to wash the columns after both the brine circuit and the acid circuit. In one embodiment of the column interchange system, only one water washing circuit is used to wash the columns after the brine circuit, whereas excess acid is neutralized with base or washed out of the columns in the brine circuit.

In one embodiment of the column interchange system, the first column in the brine circuit is interchanged to become the last column in the water washing circuit. In one embodiment of the column interchange system, the first column in the water washing circuit is interchanged to become the last column in the acid circuit. In one embodiment of the column interchange system, the first column in the acid circuit is interchanged to become the last column in the brine circuit.

In one embodiment of the column interchange system, each column in the brine circuit contains one or more tanks or junctions for mixing base into the brine and optionally settling any basic precipitates that form following base addition. In one embodiment of the column interchange system, each column in the brine circuit has associated one or more tanks or junctions for removing basic precipitates or other particles via settling or filtration. In one embodiment of the column interchange system, each column or various clusters of columns have associated one or more settling tanks or filters that remove particles including particles that detach from ion exchange beads.

In one embodiment of the column interchange system, the number of the columns in the brine circuit is optionally less than about 3, less than about 10, less than about 30, or less than about 100. In one embodiment of the column interchange system, the number of the columns in the acid circuit is optionally less than about 3, less than about 10, less than about 30, or less than about 100. In one embodiment of the column interchange system, the number of the columns in the water washing circuit is optionally less than about 3, less than about 10, less than about 30, or less than about 100. In certain embodiments, the number of columns in the brine circuit is 1 to 10. In some embodiments, the number of columns in the acid circuit is 1 to 10. In some embodiments, the number of columns in washing circuit is 1 to 10.

In one embodiment of the column interchange system, there is optionally one or more brine circuits, one or more acid circuits, and one or more water washing circuits. In one embodiment of the column interchange system, ion exchange columns are optionally supplied with fresh ion exchange beads without interruption to operating columns. In one embodiment of the column interchange system, ion exchange columns with beads that have been depleted in capacity is optionally replaced with ion exchange columns with fresh ion exchange beads without interruption to operating columns.

In one embodiment of the column interchange system, the columns contain fluidized beds of ion exchange material. In one embodiment of the column interchange system, the columns have means of created a fluidized bed of ion exchange material such as overhead stirrers or pumps. In one embodiment of the column interchange system, the columns contain fluidized beds of ion exchange material. In one embodiment of the ion exchange system, the system is an interchange system and the vessels are stirred tank reactors. In one embodiment of the interchange system, base may be added directly to the columns or other tanks containing the ion exchange material. In one embodiment of the interchange system, base may be added to the brine or another solution in a separate mixing tank and then added to the columns or other tanks containing the ion exchange material.

In one embodiment of the ion exchange system, ion exchange beads are loaded into ion exchange columns and following lithium uptake from brine, lithium is eluted from the ion exchange columns using an acid recirculation loop. In one embodiment of the acid recirculation loop, acid is flowed through an ion exchange column, into a tank, and then recirculated through the ion exchange column to optimize lithium elution. In one embodiment of the ion exchange system, ion exchange beads are loaded into ion exchange columns and following lithium uptake from brine, lithium is eluted from each ion exchange column using a once-through flow of acid. In one embodiment of the ion exchange system, ion exchange beads are loaded into an ion exchange column and following lithium uptake from brine, lithium is eluted from the ion exchange column using a column interchange circuit.

In one embodiment of the ion exchange system, ion exchange columns are loaded with lithium by flowing brine through the columns using a recirculating batch system and then lithium is eluted from the columns using a column interchange system. In one embodiment of the ion exchange system, ion exchange columns are loaded with lithium by flowing brine through the columns using a column interchange system and then lithium is eluted from the columns using a recirculating batch system. In one embodiment of the ion exchange system, ion exchange columns are loaded with lithium by flowing brine through the columns using a recirculating batch system and then lithium is eluted from the columns using a recirculating batch system. In one embodiment of the ion exchange system, ion exchange columns are loaded with lithium by flowing brine through the columns using a column interchange system and then lithium is eluted from the columns using a column interchange system.

Stirred Tank system

An aspect of the disclosure described herein is a system wherein the pH modulating setup is a tank comprising: a) one or more compartments; and b) a means for moving the liquid resource through the one or more compartments. In an embodiment, the ion exchange material is loaded in at least one compartment. In an embodiment, the means for moving the liquid resource through the one or more compartments is a pipe. In a further embodiment, the means for moving the liquid resource through the one or more compartments is a pipe and suitably a configured pump. In an embodiment, the tank further comprises a means for circulating the liquid resource throughout the tank. In an embodiment, the means for circulating the liquid resource throughout the tank is a mixing device. In an embodiment, the tank further comprises an injection port.

In some embodiments, the tank further comprises one or more injection ports. In some embodiments, the tank further comprises a plurality of injection ports.

An aspect of the disclosure described herein is a system for the extraction of lithium ions from a liquid resource, comprising a tank, wherein the tank further comprises: a) one or more compartments; b) an ion exchange material; c) a mixing device; and d) a pH modulating setup for changing the pH of the system, wherein the ion exchange material is used to extract lithium ions from the liquid resource. In one embodiment, the pH modulating setup changes the pH of the liquid resource in the system.

In some embodiments, the ion exchange material is loaded in at least one of the one or more compartments. In some embodiments, the ion exchange material is fluidized in at least one of the one or more compartments. In some embodiments, the ion exchange material is non-fluidized in at least one of the one or more compartments. In some embodiments, the ion exchange material occupies a fixed position in at least one of the one or more compartments.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes that provide filtration. In some embodiments, the porous partition comprises a polyether ether ketone mesh, a polypropylene mesh, a polyethylene mesh, a polysulfone mesh, a polyester mesh, a polyamide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In one embodiment of the ion exchange system, the system is a stirred tank system comprised of a tank of brine containing permeable bead compartments such as permeable pallets, cases, boxes, or other containers that are loaded with ion exchange beads, and the brine is stirred through the tank in a batch process. In one embodiment of the stirred tank system, the base is optionally added directly to the tank gradually or all at once as a solid or in an aqueous solution. In one embodiment of the stirred tank system, after a brine uptake stage is complete, the permeable bead containers are optionally moved to another tank for acid elution. In one embodiment of the stirred tank system, the permeable bead compartments are located at the bottom of the stirred tank during the brine stage and after the brine stage is completed, then brine is removed, and the bottom of the stirred tank is filled with acid to elute lithium in such a way that the permeable bead compartments are covered with an optimal volume of acid.

In one embodiment of the stirred tank system, the ion exchange beads are suspended using plastic structural supports in a tank with an internal mixing device. In one embodiment of the stirred tank system, a stream of brine is removed from the tank and passed through a column where hydrogen ions in the brine produced by ion exchange are neutralized using sacrificial base in solution or added as solid, or by an ion exchange resin. This pH-corrected stream is sent back into the system where the lithium can continue to be removed. In one embodiment of the stirred tank system, brine that has passed through the ion exchange bead compartment is returned to the opposite end of the tank through a pipe that is optionally internal or external to the tank. In one embodiment of the stirred tank system, base is optionally added to the brine inside the tank or in a base addition tank outside the tank.

In one embodiment of the stirred tank system, fresh brine is fed to the system so as to operate in continuous stirred tank system mode instead of batch mode. In one embodiment of the recirculating batch system, fresh brine is fed to the system so as to operate in continuous stirred tank system mode instead of batch mode.

In one embodiment of the ion exchange system, the ion exchange material is mixed with a liquid resource in a stirred tank reactor. In one embodiment, the ion exchange material may be comprised of coated particles, uncoated particles, porous ion exchange beads, or combinations thereof.

In one embodiment of the ion exchange system, a stirred tank reactor is used to fluidize the ion exchange material in a liquid resource to enable absorption of lithium from the liquid resource into the ion exchange material. In one embodiment, a stirred tank reactor is used to fluidize the ion exchange material in a washing fluid to remove residual brine, acid, or other contaminants from the ion exchange materials. In one embodiment, a stirred tank reactor is used to fluidize the ion exchange material in an acid solution to elute lithium from the ion exchange material while replacing the lithium in the ion exchange material with protons. In one embodiment, a single stirred tank reactor is used to mix ion exchange material with a liquid resource, washing fluid, and acid solution.

In some embodiments, the system for the extraction of lithium ions from a liquid resource, comprising a tank, wherein the tank further comprises: a) one or more compartments; b) an ion exchange material; c) a mixing device; and d) a pH modulating setup for changing the pH of the liquid resource in the system, wherein the ion exchange material is used to extract lithium ions from the liquid resource, further comprises another tank, wherein the other tank further comprises: a) one or more compartments; b) an ion exchange material; c) a mixing device; and d) a pH modulating setup for changing the pH of the liquid resource in the system. In some embodiments, the tank is in fluid communication with the other tank.

In some embodiments, the system for the extraction of lithium ions from a liquid resource, comprising a tank, wherein the system further comprises another tank, wherein the other tank further comprises: a) one or more compartments; b) an ion exchange material; c) a mixing device; and d) an acid inlet for adding acid to the system. In a further embodiment, the ion exchange material is moved between the tank and the other tank.

In some embodiments, the system for the extraction of lithium ions from a liquid resource, comprising a tank, wherein the tank further comprises: a) one or more compartments; b) an ion exchange material; c) a mixing device; and d) a pH modulating setup for changing the pH of the liquid resource in the system, wherein the ion exchange material is used to extract lithium ions from the liquid resource, further comprises a plurality of tanks, each tank further comprising: a) one or more compartments; b) an ion exchange material; c) a mixing device; and d) a pH modulating setup for changing the pH of the liquid resource in the system. In some embodiments, each tank of the system is in fluid communication with each other tank of the system.

In some embodiments, the system further comprises another plurality of tanks, wherein each tank further comprises: a) one or more compartments; b) an ion exchange material; and c) a mixing device.

In some embodiments, the system is configured to operate in a batch mode. In some embodiments, the system is configured to operate in a continuous mode. In some embodiments, the system is configured to operate in a batch mode and a continuous mode. In some embodiments, one or more tanks in the system are configured to operate in a batch mode and one or more tanks in the system are configured to operate in a continuous mode. In some embodiments, one or more tanks in the system are configured to operate in a batch mode and one or more tanks in the system are configured to operate in a semi-continuous mode. In some embodiments, one or more tanks in the system are configured to operate in a semi-continuous mode and one or more tanks in the system are configured to operate in a continuous mode. In some embodiments, one or more tanks in the system are configured to operate in a batch mode, one or more tanks in the system are configured to operate in a semi-continuous mode, and one or more tanks in the system are configured to operate in a continuous mode. In some embodiments, the system is configured to operate in a semi-continuous mode, a batch mode, a continuous mode, or combinations thereof.

In one embodiment of the ion exchange system, a plurality of stirred tank reactors are used to mix ion exchange material with a liquid resource, washing fluid, and acid solution. In one embodiment, the stirred tank reactors may be different sizes and may contain different volumes of a liquid resource, washing fluid, and acid solution. In one embodiment, the stirred tanks may be cylindrical, conical, rectangular, pyramidal, or a combination thereof. In one embodiment of the ion exchange system, the ion exchange material may move through the plurality of stirred tank reactors in the opposite direction of the liquid resource, the washing fluid, or the acid solution.

In one embodiment of the ion exchange system, a plurality of stirred tank reactors may be used where one or more stirred tank reactors mix the ion exchange material with a liquid resource, one or more stirred tank reactors mix the ion exchange material with a washing fluid, and one or more stirred tank reactors mix the ion exchange material with an acid solution.

In one embodiment of the ion exchange system, stirred tank reactors may be operated in a continuous, semi-continuous, or batch mode where a liquid resource flows continuously, semi-continuously, or batch-wise through the stirred tank reactor. In one embodiment of the ion exchange system, stirred tank reactors may be operated in a continuous, semi-continuous, or batch mode where the ion exchange material flows continuously, semi-continuously, or batch-wise through the stirred tank reactor. In one embodiment of the ion exchange system, stirred tank reactors may be operated in a mode where the ion exchange material remains in the tank while flows of liquid resource, washing fluid, or acid solution are flowed through the tank in continuous, semi-continuous, or batch flows.

In one embodiment, ion exchange material may be loaded into or removed from the stirred tank reactors through the top, the bottom, or the side of the tank.

In one embodiment of the ion exchange system, stirred tank reactors may comprise one or more compartments. In one embodiment, the compartments may contain ion exchange material in a bed that is fluidized, fixed, partially fluidized, partially fixed, alternatively fluidized, alternatively fixed, or combinations thereof. In one embodiment, the compartments may be comprised of a porous support at the bottom of the compartment, the sizes of the compartment, the top of the compartment, or combinations thereof. In one embodiment, the compartments may be conical, cylindrical, rectangular, pyramidal, other shapes, or combinations thereof. In one embodiment, the compartment may be located at the bottom of the tank. In one embodiment, the shape of the compartment may conform to the shape of the stirred tank reactor. In one embodiment, the compartment may be partially or fully comprised of the tank of the stirred tank reactor.

In one embodiment, the compartment may be comprised of a porous structure. In one embodiment, the compartment may be comprised of a polymer, a ceramic, a metal, or combinations thereof. In one embodiment, the compartment may be comprised be comprised partially or fully of a porous material or a mesh. In one embodiment, the compartment may be at the top of the tank. In one embodiment, the compartment may be separated from the rest of the tank with one or more porous materials. In one embodiment, the compartment may be at the top of the tank. In one embodiment, the compartment may be separated from the rest of the tank with a bilayer mesh comprising one layer of coarse mesh for strength and one layer of fine mesh to contain smaller particles in the compartment. In one embodiment, the compartment may allow liquid to flow freely through the stirred tank reactor and through the compartment. In one embodiment, the compartment may be open on the top. In one embodiment, the compartment may contain the ion exchange material in the tank but allow the ion exchange material to move throughout the tank. In one embodiment, the compartment may comprise a majority or minority of the tank volume. In one embodiment, the compartment may represent a fraction of the volume of the tank that is greater than 1 percent, greater than 10 percent, greater than 50 percent, greater than 90 percent, greater than 99 percent, or greater than 99.9 percent. In one embodiment, one or more devices for stirring, mixing, or pumping may be used to move fluid through the compartment, the stirred tank reactor, or combinations thereof.

In one embodiment of the ion exchange system, stirred tank reactors may be arranged into a network where flows of brine, washing fluid, and acid solutions are directly through different columns. In one embodiment, a network of stirred tank reactors may involve physical movement of the ion exchange material through the various stirred tank reactors. In one embodiment, a network of stirred tank reactors may involve no physical movement of the ion exchange material through the various stirred tank reactors. In one embodiment, a network of stirred tank reactors may involve switching of flows of brine, washing fluid, and acid solutions through the various stirred tank reactors. In one embodiment, brine may into stirred tank reactors in continuous or batch mode. In one embodiment, brine may be mixed with ion exchange material in one or more reactors before exiting the system. In one embodiment, a network of stirred tank reactors may involve a brine circuit with counter-current exposure of ion exchange material to flows of brine. In one embodiment, a network of stirred tank reactors may involve a washing circuit with counter-current exposure of ion exchange material to flows of washing fluid. In one embodiment, a network of stirred tank reactors may involve an acid circuit with counter-current exposure of ion exchange material to flows of acid solution. In one embodiment, the washing fluid may be water, an aqueous solution, or a solution containing an anti-scalant.

In one embodiment of the stirred tank reactor, acid is added at the beginning of elution. In one embodiment of the stirred tank reactor, acid is added at the beginning of elution and again during elution. In one embodiment of the stirred tank reactor, an acid of lower concentration is added at the start of elution and additional acid of high concentration is added to continue elution.

An aspect of the disclosure described herein is a system for the extraction of lithium ions from a liquid resource, comprising: a) an ion exchange material; b) a tank comprising one or more compartments; and c) a mixing device, wherein the ion exchange material is used to extract lithium ions from the liquid resource.

In some embodiments, the ion exchange material is loaded in at least one of the one or more compartments. In some embodiments, the ion exchange material is fluidized or partially fluidized in at least one of the one or more compartments. In some embodiments, the ion exchange material occupies a fixed position in at least one of the one or more compartments. In some embodiments, the ion exchange material is mounted in at least one of the one or more compartments.

An aspect of the disclosure described herein is a system for the extraction of lithium ions from a liquid resource, comprising: a) a column comprising an ion exchange material; and b) a pH modulating setup for changing the pH of the liquid resource in the system, wherein the pH modulating setup is in fluid communication with the column, wherein the ion exchange material is used to extract lithium ions from the liquid resource.

### Other Types of Systems

An aspect of the disclosure described herein is a system for the extraction of lithium ions from a liquid resource, comprising: a) a plurality of columns, wherein each of the plurality of columns comprises an ion exchange material; and b) a pH modulating setup for changing the pH of the liquid resource in the system, wherein the pH modulating setup is in fluid communication with each of the plurality of columns, wherein the ion exchange material is used to extract lithium ions from the liquid resource.

In some embodiments, the pH modulating setup comprises a plurality of tanks, wherein each of the plurality of tanks is immediately connected to one of the plurality of columns. In one embodiment, the pH modulating setup comprises a plurality of tanks, wherein each of the plurality of tanks is in immediate liquid communication with one of the plurality of columns. In some embodiments, two or more of the plurality of tanks connected to two or more of the plurality of columns forms at least one circuit. In some embodiments, two or more of the plurality of tanks connected to two or more of the plurality of columns forms at least two circuits. In some embodiments, three or more of the plurality of tanks connected to three or more of the plurality of columns forms at least two circuits. In some embodiments, three or more of the plurality of tanks connected to three or more of the plurality of columns forms at least three circuits.

In some embodiments, the pH modulating setup comprises a plurality of tanks, wherein each of the plurality of tanks is connected to the of the plurality of columns through a filtration system. In some embodiments, two or more of the plurality of tanks are connected to two or more of the plurality of columns through a filter system to form at least one circuit. In some embodiments, two or more of the plurality of tanks are connected to two or more of the plurality of columns through a filter system to form at least two circuits. In some embodiments, three or more of the plurality of tanks are connected to two or more of the plurality of columns through a filter system to form at least two circuits. In some embodiments, three or more of the plurality of tanks are connected to two or more of the plurality of columns through a filter system to form at least three circuits.

In some embodiments, the filtration system comprises a bag filter, a candle filter, a cartridge filter, a media filter, a depth filter, a sand filter, a membrane filter, an ultrafiltration system, a microfiltration filter, a nanofiltration filter, a cross-flow filter, a dead-end filter, a drum filter, a filter press, or a combination thereof. In some embodiments, the openings in this filter are of less than about 0.02 μm, less than about 0.1 μm, less than about 0.2 μm, less than about 1 μm, less than about 2 μm, less than about 5 μm, less than about 10 μm, less than about 25 μm, less than about 100 μm, less than about 1000 μm. In some embodiments, the perforated openings in outer-perforated walls are of dimension of more than about 0.02 μm, more than about 0.1 μm, more than about 0.2 μm, more than about 1 μm, more than about 2 μm, more than about 5 μm, more than about 10 μm, more than about 25 μm, more than about 100 μm. In some embodiments, the perforated openings in outer-perforated walls are of dimension of about 0.02 μm to about 0.1 μm, from about 0.1 μm to about 0.2 μm, from about 0.2 μm to about 0.5 μm, from about 0.5 μm to about 1 μm, from about 1 μm to about 5 μm, from about 5 μm to about 10 μm, from about 10 μm to about 25 μm, from about 25 μm to about 100 μm. In some embodiments, the filter martial comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly (4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In a further aspect, a coating material comprises polyvinylidene fluoride (PVDF), polyvinyl chloride (PVC), ethylene chlorotrifluoro ethylene (Halar), poly(4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In some embodiments, the filter martial comprises iron, stainless steel, nickel, carbon steel, titanium, Hastelloy, Inconel, zirconium, tantalum, alloys thereof, mixtures thereof, or combinations thereof.

In some embodiments, at least one circuit is a liquid resource circuit. In some embodiments, at least one circuit is a water washing circuit. In some embodiments, at least two circuits are water washing circuits. In some embodiments, at least one circuit is an acid solution circuit.

An aspect of the disclosure described herein is a system for the extraction of lithium ions from a liquid resource comprising an ion exchange material and a plurality of vessels, wherein each of the plurality of vessels is configured to transport the ion exchange material along the length of the vessel and the ion exchange material is used to extract lithium ions from the liquid resource. In some embodiments, at least one of the plurality of vessels comprises an acidic solution. In some embodiments, at least one of the plurality of vessels comprises the liquid resource. In some embodiments, each of the plurality of vessels is configured to transport the ion exchange material by a pipe system or an internal conveyer system.

An aspect of the disclosure described herein is a system for the extraction of lithium ions from a liquid resource comprising an ion exchange material and a plurality of columns, wherein each of the plurality of columns is configured to transport the ion exchange material along the length of the column and the ion exchange material is used to extract lithium ions from the liquid resource.

In some embodiments, at least one of the plurality of columns comprises an acidic solution. In some embodiments, at least one of the plurality of columns comprises the liquid resource. In some embodiments, each of the plurality of columns is configured to transport the ion exchange material by a pipe system or an internal conveyer system.

In some embodiments, the ion exchange material comprises ion exchange particles. In some embodiments, at least a portion of the ion exchange material is in the form of ion exchange particles. In some embodiments, the ion exchange particles are selected from uncoated ion exchange particles, coated ion exchange particles, and combinations thereof. In some embodiments, the ion exchange particles comprise uncoated ion exchange particles. In some embodiments, the ion exchange particles comprise coated ion exchange particles. In some embodiments, the ion exchange particles comprise a mixture of uncoated and coated ion exchange particles.

In some embodiments, the coated ion exchange particles comprise an ion exchange material and a coating material.

In some embodiments, the coating material of the coated ion exchange particles comprises a carbide, a nitride, an oxide, a phosphate, a fluoride, a polymer, carbon, a carbonaceous material, or combinations thereof. In some embodiments, the coating material of the coated ion exchange particles is selected from the group consisting of TiO₂, ZrO₂, MoO₂, SnO₂, Nb₂O₅, Ta₂O₅, SiO₂, Liz TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, MO₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, and combinations thereof.

In some embodiments, the ion exchange material of the coated ion exchange particles comprises an oxide, a phosphate, an oxyfluoride, a fluorophosphate, or combinations thereof. In some embodiments, the ion exchange material of the coated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof; wherein x is from 0.1-10; and y is from 0.1-10.

In some embodiments, the uncoated ion exchange particles comprise an ion exchange material. In some embodiments, the ion exchange material of the uncoated ion exchange particles comprises an oxide, a phosphate, an oxyfluoride, a fluorophosphate, or combinations thereof. In some embodiments, the ion exchange material of the uncoated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof; wherein x is from 0.1-10; and y is from 0.1-10.

In some embodiments, the ion exchange material is porous. In some embodiments, the porous ion exchange material comprises a network of pores that allows liquids to move quickly from the surface of the porous ion exchange material to a plurality of ion exchange particles. In some embodiments, the porous ion exchange material comprises a network of pores that allows a liquid to move from the surface of the porous ion exchange material to a plurality of ion exchange particles. In some embodiments, the porous ion exchange material comprises a network of pores that allows a liquid to move quickly from the surface of the porous ion exchange material to a plurality of ion exchange particles. In some embodiments, the porousion exchange material is porous ion exchange beads. In some embodiments, the porousion exchange material is comprised of porous ion exchange beads.

In some embodiments of the systems described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments of the systems described herein, the liquid resource is a brine. In some embodiments of the systems described herein, the liquid resource comprises a natural brine, a synthetic brine, or a mixture of a natural and a synthetic brine. In some embodiments of the systems described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, or combinations thereof.

An aspect of the disclosure described herein is a system, wherein the column further comprises a plurality of injection ports, wherein the plurality of injection ports are used to increase the pH of the liquid resource in the system

In one embodiment of the ion exchange system, the system is a mixed base system comprising an ion exchange column and a mixing chamber where base is mixed into the brine immediately prior to injection of the brine into the column.

In one embodiment of the ion exchange system, the system is a ported ion exchange column system with multiple ports for injection of aqueous base spaced at intervals along the direction of brine flow through the column. As brine flows through the column, there is a region of the column where the ion exchange beads experience the greatest rate of lithium absorption, and this region moves through the column in the direction of brine flow. In the ported ion exchange column system, base is injected near that region to neutralize protons released by the ion exchange reaction. In regions of the columns where the ion exchange beads have been saturated with lithium and the rate of release of protons has slowed, base injected is decreased or terminated to avoid formation of basic precipitates.

In one embodiment of the ion exchange system, the system has a moving bed of beads that moves in a direction opposite to the flow of brine and base is injected at one or more fixed points in the column in a region near where the ion exchange reaction occurs at a maximum rate in the column to neutralize the protons released from the ion exchange reaction. In one embodiment of the ion exchange system, the base added to the brine is optionally NaOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₄, Na₂HBO₄, Na₃BO₄, KH₂BO₄, K₂HBO₄, K₃BO₄, MgHBO₄, CaHBO₄, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile, other bases, or combinations thereof. In one embodiment, the base is optionally added to the brine in its pure form or as an aqueous solution. In one embodiment, the base is optionally added in a gaseous state such as gaseous NH₃. In one embodiment, the base is optionally added to the brine in a steady stream, a variable stream, in steady aliquots, or in variable aliquots. In one embodiment, the base is optionally created in the brine by using an electrochemical cell to remove H₂ and Cl₂ gas, which is optionally combined in a separate system to create HCl acid to be used for eluting lithium from the system or for other purposes.

In some embodiments, a solid base is mixed with a liquid resource to create a basic solution. In some embodiments, a solid base is mixed with a liquid resource to create a basic solution, and the resulting basic solution is added to a second volume of a liquid resource to increase the pH of the second volume of the liquid resource. In some embodiments, solid base is mixed with a liquid resource to create a basic solution, wherein the resulting basic solution is used to adjust or control the pH of a second solution. In some embodiments, a solid base is mixed with a liquid resource to create a basic slurry. In some embodiments, a solid base is mixed with a liquid resource to create a basic slurry, and the resulting basic slurry is added to a second volume of a liquid resource to increase the pH of the second volume of the liquid resource. In some embodiments, solid base is mixed with a liquid resource to create a basic slurry, wherein the resulting basic slurry is used to adjust or control the pH of a second solution. In some embodiments, base may be added to a liquid resource as a mixture or slurry of base and liquid resource.

In one embodiment of the ion exchange system, the brine flows through a pH control column containing solid sacrificial base particles such as NaOH, CaO, or Ca(OH)₂, which dissolve into the brine and raise the pH of the brine. In one embodiment of the ion exchange system, the brine flows through a pH control column containing immobilized regeneratable OH-containing ion exchange resins which react with hydrogen ions, or regeneratable base species such as immobilized polypyridine, which conjugate HCl, thereby neutralizing the acidified brine. When the ion exchange resin has been depleted of its OH groups or is saturated with HCl, it is optionally regenerated with a base such as NaOH.

In one embodiment of the ion exchange system, pH meters are optionally installed in tanks, pipes, column, and other components of the system to monitor pH and control the rates and amounts of base addition at various locations throughout the system.

In one embodiment of the ion exchange system, the columns, tanks, pipes, and other components of the system are optionally constructed using plastic, metal with a plastic lining, or other materials that are resistant to corrosion by brine or acid.

In one embodiment of the ion exchange system, the ion exchange columns are optionally washed with water that is mildly acidic, optionally including a buffer, to remove any basic precipitates from the column prior to acid elution.

After the ion exchange column is saturated or nearly saturated with lithium, the lithium is flushed out of the ion exchange column using acid. The acid is optionally flowed through the column one or more times to elute the lithium. In one embodiment, the acid is optionally flowed through the ion exchange column using a recirculating batch system comprised of the ion exchange column connected to a tank. In one embodiment, the tank used for acid flows is optionally the same tank used for the brine flows. In a further embodiment, the tank used for acid flows is optionally a different tank than the one used for brine flows. In a further embodiment, the acid is distributed at the top of the ion exchange column and allowed to percolate through and immediately recirculated into the column with no extra tank. In an embodiment, acid addition optionally occurs without a tank used for acid flows.

In one embodiment of the ion exchange system, the column is optionally washed with water after the brine and/or acid steps, and the effluent water from washing is optionally treated using pH neutralization and reverse osmosis to yield process water.

In one embodiment of the ion exchange system, the ion exchange column is optionally shaped like a cylinder, a rectangle, or another shape. In one embodiment, the ion exchange column optionally has a cylinder shape with a height that is greater or less than its diameter. In one embodiment, the ion exchange column optionally has a cylinder shape with a height that is less than 10 cm, less than 1 meter, or less than 10 meters. In one embodiment, the ion exchange column optionally has a cylinder shape with a diameter that is less than 10 cm, less than 1 meter, or less than 10 meters.

In one embodiment of the ion exchange system, the system is optionally resupplied with fresh ion exchange beads by swapping out an ion exchange column with a new column loaded with fresh ion exchange beads. In one embodiment of the ion exchange system, the system is optionally resupplied with fresh ion exchange beads by removing the ion exchange beads from the column and loading new beads into the column. In one embodiment of the ion exchange system, new beads are optionally supplied to all columns in the system simultaneously. In one embodiment of the ion exchange system, new beads are option ally supplied to one or more columns at a time. In one embodiment of the ion exchange system, new beads are optionally supplied to one or more columns without interruption to other columns that optionally continue operating.

In one embodiment of the ion exchange system, brine pumping optionally continues until the ion exchange beads approach a point of lithium saturation over a period of time that is optionally less than about 1 hours, less than about 2 hours, less than about 4 hours, less than about 8 hours, less than about 24 hours, less than about 48 hours, or less than about one week. In one embodiment of the ion exchange system, brine pumping optionally continues until the ion exchange beads approach a point of lithium saturation over a period of time that is optionally greater than about one week. In certain embodiments of the ion exchange system, brine pumping optionally continues until the ion exchange beads approach a point of lithium saturation over a period of time that is optionally between 30 minutes and 24 hours. In one embodiment of the ion exchange system, acid pumping optionally continues until the ion exchange beads approach a point of hydrogen saturation over a period of time that is optionally less than about 1 hours, less than about 2 hours, less than about 4 hours, less than about 8 hours, less than about 24 hours, or less than about 48 hours. In one embodiment of the ion exchange system, brine pumping optionally continues until the ion exchange beads approach a point of hydrogen saturation over a period of time that is optionally greater than about one 48 hours. In certain embodiments of the ion exchange system, brine pumping optionally continues until the ion exchange beads approach a point of hydrogen saturation over a period of time that is optionally between 30 minutes and 24 hours.

For commercial production of lithium using ion exchange, it is desirable to construct large-scale ion exchange modules containing large quantities of ion exchange beads. However, most large vessels capable of holding about one tonne or more of ion exchange beads have large fluid flow distances of about one meter or more. These fluid flow distances cause large pressure drops. To reduce the pressure drop across the ion exchange bed, the ion exchange beads can be loaded into vessels facilitating flow across the ion exchange beads with a shorter fluid flow distance. These vessels can be designed to evenly distribute flow of the liquid resource and other fluids through the ion exchange beads.

In some embodiments, ion exchange vessels are designed to facilitate flow across the ion exchange beads with a shorter fluid flow distance. In some embodiments, the vessel can be oriented vertically, horizontally, or at any angle relative to the horizontal axis. In some embodiments, the vessel can be cylindrical, rectangular, spherical, another shape, or a combinations thereof. In some embodiments, the vessel can have a constant cross-sectional area or a varying cross-sectional area.

In some embodiments, the typical thickness of the distribution compartment within the vessel containing the ion-exchange compartments is less than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the distribution compartment within the vessel containing the ion-exchange compartments is more than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the distribution compartment within the vessel containing the ion-exchange compartments is from about 1 cm to about 2 cm, from about 2 cm to about 4 cm, from about 4 cm to about 8 cm, from about 8 cm to about 20 cm, from about 20 cm to about 40 cm, from about 40 cm to about 80 cm, from about 80 cm to about 120 cm, from about 120 cm to about 2 m, from about 2 m to about 4 m.

In some embodiments, the typical thickness of the compartment containing ion-exchange beads within the vessel containing the ion-exchange compartments is less than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the compartment containing ion-exchange beads within the vessel containing the ion-exchange compartments is more than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the compartment containing ion-exchange beads within the vessel containing the ion-exchange compartments is from about 1 cm to about 2 cm, from about 2 cm to about 4 cm, from about 4 cm to about 8 cm, from about 8 cm to about 20 cm, from about 20 cm to about 40 cm, from about 40 cm to about 80 cm, from about 80 cm to about 120 cm, from about 120 cm to about 2 m, from about 2 m to about 4 m.

In some embodiments, an alternate phase is contacted with the ion exchange material within an ion exchange device. In some embodiments, contact between the ion exchange beads and the alternate phase is maximized and made possible by the design of this ion exchange device.

In some embodiments, the alternate phase improves lithium extraction performance by reducing the time required to absorb hydrogen to generate hydrogen-enriched beads and release lithium to generate a lithium-enriched solution; reducing the time and water required for washing the hydrogen-enriched beads with water to generate hydrogen-enriched beads substantially free of residual acid; reducing the time required for treating the hydrogen-enriched beads with the liquid resource under conditions suitable to absorb lithium to generate lithium-enriched beads; reducing the time and water required for washing the lithium-enriched beads with water to generate lithium-enriched beads substantially free of liquid resource; improving the life-time and total lithium produce by the ion exchange material; improving the speed of pH adjustment using alkali; improving the solid-liquid mixing efficiency; and reducing the time required to drain liquids from the ion exchange vessel.

In some embodiments, the alternate phase is a liquid or gas. In some embodiments, said alternate phase is a non-aqueous liquid. In some embodiments, the alternate phase is non-aqueous liquid. In some embodiments, the alternate phase is a non-aqueous solution. In some embodiments, the alternate phase is an organic liquid such as an alkane, alcohol, oil, bio-organic oil, ester, ether, hydrocarbon, or a combination thereof. In some embodiments, the alternate phase is butane, pentane, hexane, acetone, diethyl ether, butanol, or combinations thereof. In some embodiments, the alternate is a gas such as air, nitrogen, argon, or a combination thereof. In some embodiments, the alternate phase comprises a compressed or pressurized gas.

In some embodiments, the ion exchange bed is a fixed bed that does move during the ion exchange process. In some embodiments, the ion exchange bed is a fluidized bed that is agitated at one or more periods during the ion exchange process.

### Methods of Modulating pH for the Extraction of Lithium

An aspect of the disclosure described herein is a method of extracting lithium ions from a liquid resource, comprising: flowing the liquid resource through the column of the system described above to produce a lithiated ion exchange material; and treating the resulting lithiated ion exchange material with an acid solution (e.g., acidic solution) to produce a salt solution comprising lithium ions (e.g., lithium ion exchange eluate solution).

An aspect of the disclosure described herein is a method of extracting lithium ions from a liquid resource, comprising: flowing the liquid resource through the plurality of columns of the system described above to produce a lithiated ion exchange material; and treating the resulting lithiated ion exchange material with an acid solution (e.g., acidic solution) to produce a salt solution comprising lithium ions (e.g., lithium ion exchange eluate solution).

An aspect of the disclosure described herein is a method of extracting lithium ions from a liquid resource, comprising: flowing the liquid resource through the tank of the system described above to produce a lithiated ion exchange material; and treating the resulting lithiated ion exchange material with an acid solution (e.g., acidic solution) to produce a salt solution comprising lithium ions (e.g., lithium ion exchange eluate solution).

An aspect of the disclosure described herein is a method of extracting lithium ions from a liquid resource, comprising: flowing the liquid resource through the column of the system described above to produce a lithiated ion exchange material; and treating the resulting lithiated ion exchange material with an acid solution (e.g., acidic solution) to produce a salt solution comprising lithium ions (e.g., lithium ion exchange eluate solution).

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, or organic molecules. In some embodiments, the liquid resource is optionally entered the ion exchange reactor without any pre-treatment following from its source.

In an embodiment, the liquid resource is a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

In some embodiments, the acid used for recovering lithium from the ion exchange reactor is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for recovering lithium from the porous ion exchange beads is selected from the following list: hydrochloric acid, sulfuric acid, nitric acid, or combinations thereof.

In an embodiment, the acid solution comprises hydrochloric acid, sulfuric acid, phosphoric acid, hydrobromic acid, chloric acid, perchloric acid, nitric acid, formic acid, acetic acid, or combinations thereof.

In some embodiments, the acid used for recovering lithium from the ion exchange system has a concentration selected from the following list: less than 0.1 M, less than 1.0 M, less than 5 M, less than 10 M, or combinations thereof. In some embodiments, the acid used for recovering lithium from the porous ion exchange beads has a concentration greater than 10 M.

In an embodiment, acids with distinct concentrations are used during the elution process. In an embodiment, acid with a lower concentration is first added to elute lithium from the ion exchange material and then additional acid of a greater concentration is added to elute more lithium into the solution and increase the concentration of lithium in the eluate.

In some embodiments, the ion exchange beads perform the ion exchange reaction repeatedly while maintaining adequate lithium uptake capacity over a number of cycles selected from the following list: greater than 10 cycles, greater than 30 cycles, greater than 100 cycles, greater than 300 cycles, or greater than 1,000 cycles. In some embodiments, the porous ion exchange beads perform the ion exchange reaction repeatedly over a number of cycles selected from the following list: greater than 50 cycles, greater than 100 cycles, or greater than 200 cycles. In some embodiments, adequate lithium uptake capacity is optionally defined as a percentage of initial uptake capacity selected from the following list: greater than 95%, greater than 90%, greater than 80%, greater than 60%, or greater than 20%. In some embodiments, adequate lithium uptake capacity is optionally defined as a percentage of initial uptake capacity such as less than 20%.

In some embodiments, the concentrated lithium solution that is yielded from the ion exchange reactor is further processed into lithium raw materials using methods selected from the following list: solvent extraction, ion exchange, chemical precipitation, electrodialysis, electrowinning, electrolysis, evaporation with direct solar energy, evaporation with concentrated solar energy, evaporation with a heat transfer medium heated by concentrated solar energy, evaporation with heat from a geothermal brine, evaporation with heat from combustion, pH neutralization, or combinations thereof. In some embodiments, the concentrated lithium solution that is yielded from the ion exchange reactor is concentrated using reverse osmosis or membrane technologies.

In some embodiments, the concentrated lithium solution that is yielded from the ion exchange reactor is further processed into lithium chemicals selected from the following list:
lithium chloride, lithium carbonate, lithium hydroxide, lithium metal, lithium metal oxide, lithium metal phosphate, lithium sulfide, or combinations thereof. In some embodiments, the concentrated lithium solution that is yielded from the porous ion exchange beads is further processed into lithium chemicals that are solid, liquid, hydrated, or anhydrous.

In some embodiments, the lithium chemicals produced using the ion exchange reactor are used in an industrial application selected from the following list: lithium batteries, metal alloys, glass, grease, or combinations thereof. In some embodiments, the lithium chemicals produced using the coated ion exchange particles are used in an application selected from the following list: lithium batteries, lithium-ion batteries, lithium sulfur batteries, lithium solid-state batteries, and combinations thereof.

In some embodiments, the ion exchange materials are synthesized in a lithiated state with a sublattice fully or partly occupied by lithium. In some embodiments, the ion exchange materials are synthesized in a hydrated state with a sublattice fully or partly occupied by hydrogen.

In some embodiments, the ion exchange material extracts lithium ions from a liquid resource. During the extraction of lithium ions from a liquid resource by the ion exchange material, the pH of the liquid resource optionally decreases. Increasing the pH of the liquid resource in the system by using a pH modulating setup maintains the pH in a range that is suitable for lithium ion uptake by the ion exchange material. In an embodiment, the pH modulating setup comprises measuring the pH of the system and adjusting the pH of the system to an ideal pH range for lithium extraction. In an embodiment, for ion exchange material to absorb lithium from brine, an ideal pH range for the brine is optionally 6 to 9, a preferred pH range is optionally 4 to 9, and an acceptable pH range is optionally 2 to 9. In an embodiment, the pH modulating setup comprises measuring the pH of the system and wherein the pH of the system is less than 6, less than 4, or less than 2, the pH of the system is adjusted to a pH of 2 to 9, a pH of 4 to 9, or a pH of 6 to 9.

Another aspect described herein is a method of extracting lithium ions from a liquid resource, comprising: a) flowing the liquid resource into a system comprising a tank to produce a lithiated ion exchange material, wherein the tank further comprises (i) one or more compartments, (ii) an ion exchange material, (iii) a mixing device, and (iv) a pH modulating setup for changing the pH of the liquid resource in the system; and b) treating the lithiated ion exchange material from a) with an acid solution to produce a hydrogen-rich ion exchange material and a salt solution comprising lithium ions.

In some embodiments, the method further comprises, prior to b), washing the lithiated ion exchange material with an aqueous solution. In some embodiments, the method further comprises, subsequent to b), washing the hydrogen-rich ion exchange material with an aqueous solution. In some embodiments, the aqueous solution is water.

In some embodiments, the method further comprises, prior to b), flowing the lithiated ion exchange material into a washing system. In some embodiments, the method further comprises, prior to b), transferring a suspension comprising the lithiated ion exchange material. In some embodiments, the method further comprises, prior to b), flowing the lithiated ion exchange material into a washing system and washing the lithiated ion exchange material with a solution. In some embodiments, the method further comprises, prior to b), flowing the lithiated ion exchange material into a washing system and washing the lithiated ion exchange material with a solution comprising water. In some embodiments, the method further comprises, prior to b), flowing the lithiated ion exchange material into a washing system and washing the lithiated ion exchange material with an aqueous solution. In some embodiments, the lithiated ion exchange material is washed with an aqueous solution.

In some embodiments, the method further comprises, prior to b), flowing the lithiated ion exchange material into a stripping system. In some embodiments, the method further comprises, prior to b), flowing the lithiated ion exchange material into a stripping system and stripping the lithiated ion exchange material. In some embodiments, the method further comprises, prior to b), flowing the lithiated ion exchange material into a stripping system and stripping volatile components from the lithiated ion exchange material. In some embodiments, the method further comprises, prior to b), flowing the lithiated ion exchange material into a stripping system and stripping volatile components comprising water from the lithiated ion exchange material.

In some embodiments, the pH modulating setup comprises a pH measuring device and an inlet for adding base to the tank. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the measured change in pH triggers adding a base to maintain lithium uptake. In some embodiments, a change in pH to below a pH value of about 2 to about 9 triggers the addition of a base to maintain lithium uptake. In some embodiments, a change in pH to below a pH value of about 2, of about 3, of about 4, of about 5, of about 6, of about 7, of about 8, or of about 9 triggers the addition of a base to maintain lithium uptake. In some embodiments, a change in pH to below a pH of about 2 to about 4, of about 3 to about 5, of about 4 to about 6, of about 5 to about 7, of about 6 to about 8, or of about 7 to about 9 triggers the addition of a base to maintain lithium uptake. In some embodiments, base is added to the liquid resource to maintain the pH of the liquid resource in a range of about 2-3, 3-4, 4-5, 5-6, 6-7, 7-8, or 8-9. In some embodiments, base is added to the liquid resource to maintain the pH of the liquid resource in a range of about 4-5, 5-6, 6-7, or 7-8. In some embodiments, base is added to the liquid resource to maintain the pH of the liquid resource in a range of about 4.0-4.5, 4.5-5.0, 5.0-5.5, 5.5-6.0, 6.0-6.5, 6.5-7.0, 7.0-7.5, or 7.5-8.0. In some embodiments, the pH of a liquid resource is maintained in a target range that is high enough to facilitate lithium uptake and low enough to avoid precipitation of metal salts from the liquid resource. In some embodiments, the pH of a liquid resource is maintained below a pH of about 8 to avoid precipitation of Mg salts. In some embodiments, the pH of a liquid resource is maintained below a pH of about 2, below a pH of about 3, below a pH of about 4, below a pH of about 5, below a pH of about 6, below a pH of about 7, below a pH of about 8, or below a pH of about 9 to avoid precipitation of metal salts. In some embodiments, the pH of the liquid resource may drop out of a target pH range due to release of protons from an ion exchange material and a pH modulating setup may adjust the pH of the liquid resource back to within a target pH range. In some embodiments, the pH of the liquid resource may be adjusted above a target pH range prior to the liquid resource entering the system and then protons released from the ion exchange material may decrease the pH of the system into the target range. In some embodiments, the pH of the liquid resource may be controlled in a certain range and the range may be changed over time. In some embodiments, the pH of the liquid resource may be controlled in a certain range and then the pH of the liquid resource may be allowed to drop. In some embodiments, the pH of the liquid resource may be controlled in a certain range and then the pH of the liquid resource may be allowed to drop to solubilize colloids or solids. In some embodiments, base may be added to a liquid resource to neutralize protons without measuring pH. In some embodiments, base may be added to a liquid resource to neutralize protons with monitoring of volumes or quantities of the base. In some embodiments, the pH of the liquid resource may be measured to monitor lithium uptake by an ion exchange material. In some embodiments, the pH of the liquid resource may be monitored to determine when to separate a liquid resource from an ion exchange material. In some embodiments, the rate of change of the pH of the liquid resource may be measured to monitor the rate of lithium uptake. In some embodiments, the rate of change of the pH of the liquid resource may be measured to determine when to separate a liquid resource from an ion exchange material.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes that provide filtration. In some embodiments, the porous partition comprises a polyether ether ketone mesh, a polypropylene mesh, a polyethylene mesh, a polysulfone mesh, a polyester mesh, a poly amide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In some embodiments, the method further comprises, after a), draining the liquid resource through the porous partition after the production of the lithiated ion exchange material.

In some embodiments, the method further comprises, after b), draining the salt solution comprising lithium ions through the porous partition after the production of the hydrogen-rich ion exchange material.

In some embodiments, the method further comprises, subsequent to a), flowing the lithiated ion exchange material into another system comprising a tank to produce the hydrogen-rich ion exchange material and the salt solution comprising lithium ions, wherein the tank of the other system further comprises (i) one or more compartments, and (ii) a mixing device.

In some embodiments, the system comprises a plurality of tanks and each of the plurality of tanks further comprises (i) one or more compartments, (ii) an ion exchange material, (iii) a mixing device, and (iv) a pH modulating setup for changing the pH of the system.

An aspect of the disclosure described herein is a method of extracting lithium ions from a liquid resource, comprising: a) flowing the liquid resource into a first system comprising a tank, wherein the tank of the first system further comprises (i) one or more compartments, (ii) an ion exchange material, (iii) a mixing device, and (iv) a pH modulating setup for changing the pH of the liquid resource in the first system, to produce a lithiated ion exchange material; b) flowing the lithiated ion exchange material of a) into a second system comprising a tank, wherein the tank of the second system further comprises (i) one or more compartments, and (ii) a mixing device; and c) treating the lithiated ion exchange from b) with an acid solution to produce a hydrogen-rich ion exchange material and a salt solution comprising lithium ions.

In some embodiments, the method further comprises, subsequent to a), washing the lithiated ion exchange material with an aqueous solution.

In some embodiments, the method further comprises, prior to b), adding an aqueous solution to the lithiated ion exchange material to form a fluidized lithiated ion exchange material.

In some embodiments, the method further comprises, subsequent to c), washing the hydrogen-rich ion exchange material with an aqueous solution. In some embodiments, the aqueous solution is water.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the change in pH triggers adding a base to maintain lithium uptake.

An aspect of the disclosure described herein is a method of extracting lithium ions from a liquid resource, comprising: a) flowing the liquid resource into a first system comprising a plurality of tanks to produce a lithiated ion exchange material, wherein each of the plurality of tanks in the first system is in fluid communication with every other one of the plurality of tanks in the first system and, each of the plurality of tanks in the first system further comprises (i) one or more compartments, (ii) an ion exchange material, (iii) a mixing device, and (iv) a pH modulating setup for changing the pH of each of the plurality of tanks in the first system; b) flowing the lithiated ion exchange material into a second system comprising a plurality of tanks, wherein each of the plurality of tanks in the second system is in fluid communication with every other one of the plurality of tanks in the second system and, each of the plurality of tanks in the second system further comprises (i) one or more compartments, and (ii) a mixing device; and c) treating the lithiated ion exchange material from b) with an acid solution in at least one of the plurality of tanks in the second system to produce a hydrogen-rich ion exchange material and a salt solution comprising lithium ions.

In some embodiments, the method further comprises, subsequent to c), washing the hydrogen-rich ion exchange material with an aqueous solution in at least one of the plurality of tanks in the second system.

In some embodiments, the method is operated in a batch mode. In some embodiments, the method is operated in a continuous mode. In some embodiments, the method is operated in continuous and batch mode. In some embodiments, the method is operated in continuous mode, a batch mode, a semi-continuous mode, or combinations thereof.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the change in pH triggers adding a base to maintain lithium uptake.

An aspect of the disclosure described herein is a method of extracting lithium ions from a liquid resource, comprising: a) flowing the liquid resource into a first system comprising a tank to produce a lithiated ion exchange material, wherein the tank further comprises (i) one or more compartments, (ii) ion exchange material, and (iii) a mixing device; b) flowing the lithiated ion exchange material from a) into a second system comprising a tank, wherein the tank further comprises (i) one or more compartments, (ii) an acid solution, and (iii) a mixing device; and c) stripping the lithiated ion exchange material to produce hydrogen-rich ion exchange material and a salt solution comprising lithium ions.

In some embodiments, prior to b), the lithiated ion exchange material is washed. In some embodiments, the lithiated ion exchange material is washed with an aqueous solution.

An aspect of the disclosure described herein is a method of extracting lithium ions from a liquid resource, comprising: a) providing a system comprising an ion exchange material, a tank comprising one or more compartments; and a mixing device, wherein (i) the ion exchange material is oxide-based and exchanges hydrogen ions with lithium ions, and (ii) the mixing device is capable of moving the liquid resource around the tank comprising one or more compartments; b) flowing the liquid resource into the system of a), thereby contacting the liquid resource with the ion exchange material, wherein the ion exchange material exchanges hydrogen ions with lithium ions in the liquid resource to produce lithiated ion exchange material; c) removing the liquid resource from the system of b); d) flowing an acid solution into the system of c) thereby contacting the acid solution with the lithiated ion exchange material, wherein the lithiated ion exchange material exchanges lithium ions with the hydrogen ions in the acid solution to produce the ion exchange material and a salt solution comprising lithium ions from the lithiated ion exchange material; and e) collecting the salt solution comprising the lithium ions for further processing.

In some embodiments, the salt solution comprising lithium ions undergoes crystallization (e.g., one or more chemicals are isolated from the salt solution by crystallization, and/or the salt solution is subjected to conditions that promote crystallization, and/or one or more chemicals are added to the salt solution to promote crystallization and/or modulate the composition of the one more chemicals isolated from the salt solution by crystallization).

In some embodiments, discloses herein is a method of extracting lithium ions from a liquid resource, the method comprising: a) flowing the liquid resource through a system comprising an ion exchange material and a plurality of columns, wherein the plurality of columns is configured to transport the ion exchange material along the length of the column, to produce a lithiated ion exchange material; and b) treating the lithiated ion exchange material from a) with an acid solution to produce a salt solution comprising lithium ions (e.g., lithium ion exchange eluate solution).

An aspect of the disclosure described herein is a method of extracting lithium ions from a liquid resource, comprising: a) providing a system comprising an ion exchange material and a plurality of columns, wherein each of the plurality of columns is configured to transport the ion exchange material along the length of the column; b) flowing the liquid resource through a first one of the plurality of columns to produce a lithiated ion exchange material; c) flowing the lithiated ion exchange material from b) into a second one of the plurality of columns; and d) treating the lithiated ion exchange material from c) with an acid solution to produce a hydrogen-rich ion exchange material and a salt solution comprising lithium ions.

In some embodiments, the method further comprises, subsequent to b), flowing the lithiated ion exchange material into another one of the plurality of columns and washing the lithiated ion exchange material with an aqueous solution. In some embodiments, the method further comprises, subsequent to d), flowing the hydrogen-rich ion exchange material into another one of the plurality of columns and washing the hydrogen-rich ion exchange material with an aqueous solution.

An aspect of the disclosure described herein is a method of extracting lithium ion from a liquid resource, comprising: a) providing a system comprising an ion exchange material and a plurality of columns, wherein each of the plurality of columns is configured to transport the ion exchange material along the length of the column; b) flowing the liquid resource through a first one of the plurality of columns to produce a lithiated ion exchange material; c) flowing the lithiated ion exchange material from b) into a second one of the plurality of columns; d) washing the lithiated ion exchange material from c) with an aqueous solution; e) flowing the lithiated ion exchange material from d) into a third one of the plurality of columns; and f) treating the lithiated ion exchange material from e) with an acid solution to produce a hydrogen-rich ion exchange material and a salt solution comprising lithium ions.

In some embodiments, the method further comprises: g) flowing the hydrogen-rich ion exchange material into a fourth one of the plurality of columns; and h) washing the hydrogen-rich ion exchange material with an aqueous solution. In some embodiments, each of the plurality of columns is configured to transport the ion exchange material by a pipe system or an internal conveyer system. In some embodiments, each of the plurality of columns is configured to transport the ion exchange material by a pipe system. In some embodiments, each of the plurality of columns is configured to transport the ion exchange material by an internal conveyer system.

In some embodiments of the methods described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments of the methods described herein, the liquid resource is a brine. In some embodiments of the methods described herein, the liquid resource comprises a natural brine, a synthetic brine, or a mixture of a natural and a synthetic brine. In some embodiments of the methods described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, or combinations thereof.

In some embodiments of the methods described herein, the acid solution comprises hydrochloric acid, sulfuric acid, phosphoric acid, hydrobromic acid, chloric acid, perchloric acid, nitric acid, formic acid, acetic acid, or combinations thereof. In some embodiments of the methods described herein, the acid solution comprises hydrochloric acid, sulfuric acid, phosphoric acid, nitric acid, or combinations thereof. In some embodiments of the methods described herein, the acid solution comprises hydrochloric acid, sulfuric acid, phosphoric acid, or combinations thereof. In some embodiments of the methods described herein the acid solution comprises hydrochloric acid. In some embodiments of the methods described herein the acid solution comprises sulfuric acid. In some embodiments of the methods described herein the acid solution comprises phosphoric acid.

### Continuous Process for Lithium Extraction

Lithium is an essential element for batteries and other technologies. Lithium is found in a variety of liquid resources, including natural and synthetic brines and leachate solutions from minerals, clays, and recycled products. Lithium can be extracted from such liquid resources using an ion exchange process based on inorganic ion exchange materials. These inorganic ion exchange materials absorb lithium from a liquid resource while releasing hydrogen, and then elute lithium in acid while absorbing hydrogen. This ion exchange process can be repeated to extract lithium from a liquid resource and yield a concentrated lithium solution. The concentrated lithium solution can be further processed into chemicals for the battery industry or other industries.

Ion exchange materials are typically small particles, which together constitute a fine powder. Small particle size is required to minimize the diffusion distance that lithium must travel into the core of the ion exchange particles. In some cases, these particles may be coated with protective surface coatings to minimize dissolution of the ion exchange materials while allowing efficient transfer of lithium and hydrogen to and from the particles, as disclosed in co-pending U.S. provisional application 62/421,934, filed on Nov. 14, 2016, entitled “Lithium Extraction with Coated Ion Exchange Particles,” and incorporated in its entirety by reference.

One major challenge for lithium extraction using inorganic ion exchange particles is the loading of the particles into an ion exchange column in such a way that brine and acid can be pumped efficiently through the column with minimal clogging. The materials can be formed into ion exchange beads, and the ion exchange beads can be loaded into the column. This ion exchange bead loading creates void spaces between the ion exchange beads, and these void spaces facilitate pumping through the column. The ion exchange beads hold the ion exchange particles in place and prevent free movement of the particles throughout the column. When the ion exchange materials are formed into ion exchange beads, the penetration of brine and acid solutions into the ion exchange beads may become slow and challenging. A slow rate of convection and diffusion of the acid and brine solutions into the ion exchange bead slows the kinetics of lithium absorption and release. Such slow kinetics can create problems for column operation. Slow kinetics can require slow pumping rates through the column. Slow kinetics can also lead to low lithium recovery from the brine and inefficient use of acid to elute the lithium.

In one embodiment, an alternate phase is contacted with the ion exchange beads during on ore more of the steps of the process step. In some embodiments, the use of alternate phase speeds up the kinetics of ion exchange, enhances the forming of the ion exchange bed, controls liquid level height in one or more process tanks, or a combination thereof. In some embodiments, contact between the ion exchange beads and the alternate phase is maximized and made possible by the design of this ion exchange device.

In some embodiments, the alternate phase is a liquid or gas. In some embodiments, said alternate phase is a non-aqueous liquid. In some embodiments, the alternate phase is non-aqueous liquid. In some embodiments, the alternate phase is a non-aqueous solution. In some embodiments, the alternate phase is an organic liquid such as an alkane, alcohol, oil, bio-organic oil, ester, ether, hydrocarbon, or a combination thereof. In some embodiments, the alternate phase is butane, pentane, hexane, acetone, diethyl ether, butanol, or combinations thereof. In some embodiments, the alternate is a gas such as air, nitrogen, argon, or a combination thereof. In some embodiments, the alternate phase comprises a compressed or pressurized gas.

In some embodiments, the ion exchange beads are porous ion exchange beads with networks of pores that facilitate the transport into the ion exchange beads of solutions that are pumped through an ion exchange column. Pore networks can be strategically controlled to provide fast and distributed access for the brine and acid solutions to penetrate into the ion exchange bead and deliver lithium and hydrogen to the ion exchange particles.

In some embodiments, the ion exchange beads are formed by mixing of ion exchange particles, a matrix material, and a filler material. These components are mixed and formed into a bead. Then, the filler material is removed from the ion exchange bead to leave behind pores. The filler material is dispersed in the ion exchange bead in such a way to leave behind a pore structure that enables transport of lithium and hydrogen with fast kinetics. This method may involve multiple ion exchange materials, multiple polymer materials, and multiple filler materials.

Another major challenge for lithium extraction using inorganic ion exchange materials is dissolution and degradation of the materials, especially during lithium elution in acid but also during lithium uptake in liquid resources. To yield a concentrated lithium solution from the ion exchange process, it is desirable to use a concentrated acid solution to elute the lithium. However, concentrated acid solutions dissolve and degrade inorganic ion exchange materials, which decreases the performance and lifespan of the materials. Therefore, the porous ion exchange beads may contain coated ion exchange particle for lithium extraction that are comprised of an ion exchange material and a coating material protecting the particle surface. The coating protects the ion exchange material from dissolution and degradation during lithium elution in acid, during lithium uptake from a liquid resource, and during other aspects of an ion exchange process. This coated particle enables the use of concentrated acids in the ion exchange process to yield concentrated lithium solutions.

In one aspect described herein, the ion exchange material is selected for high lithium absorption capacity, high selectivity for lithium in a liquid resource relative to other ions such as sodium and magnesium, strong lithium uptake in liquid resources including those with low concentrations of lithium, facile elution of lithium with a small excess of acid, and fast ionic diffusion. In one aspect described herein, a coating material is selected to protect the particle from dissolution and chemical degradation during lithium recovery in acid and also during lithium uptake in various liquid resources. In some embodiments, the coating material may also be selected to facilitate one or more of the following objectives: diffusion of lithium and hydrogen between the particles and the liquid resources, enabling adherence of the particles to a structural support, and suppressing structural and mechanical degradation of the particles.

When the porous ion exchange beads are used in an ion exchange column, the liquid resource containing lithium is pumped through the ion exchange column so that the ion exchange particles absorb lithium from the liquid resource while releasing hydrogen. After the ion exchange beads have absorbed lithium, an acid solution is pumped through the column so that the particles release lithium into the acid solution while absorbing hydrogen. The column may be operated in co-flow mode with the liquid resource and acid solution alternately flowing through the column in the same direction, or the column may be operated in counter-flow mode with a liquid resource and acid solution alternately flowing through the column in opposite directions. Between flows of the liquid resource and the acid solution, the column may be treated or washed with water or other solutions for purposes such as adjusting pH in the column or removing potential contaminants. The ion exchange beads may form a fixed or moving bed, and the moving bed may move in counter-current to the brine and acid flows. The ion exchange beads may be moved between multiple columns with moving beds where different columns are used for brine, acid, water, or other flows. Before or after the liquid resource flows through the column, the pH of the liquid may be adjusted with NaOH or other chemicals to facilitate the ion exchange reaction as well as handling or disposal of the spent liquid resource. Before or after the liquid resource flows through the column, the liquid resource may be subjected to other processes including other ion exchange processes, solvent extraction, evaporation, chemical treatment, or precipitation to remove lithium, to remove other chemical species, or to otherwise treat the brine.

When the ion exchange particles are treated with acid, a lithium solution is produced. This lithium solution may be further processed to produce lithium chemicals. These lithium chemicals may be supplied for an industrial application.

In some embodiments, an ion exchange material is selected from the following list: an oxide, a phosphate, an oxyfluoride, a fluorophosphate, or combinations thereof. In some embodiments, an ion exchange material is selected from the following list: Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In some embodiments, an ion exchange material is selected from the following list: Li₄Mn₅O₁₂, Li₄Ti₅O₁₂, Li_{1.6}Mn_{1.6}O₄, Li₂MO₃ (M=Ti, Mn, Sn), LiFePO₄, solid solutions thereof, or combinations thereof.

In some embodiments, a coating material for protecting the surface of the ion exchange material is selected from the following list: a carbide, a nitride, an oxide, a phosphate, a fluoride, a polymer, carbon, a carbonaceous material, or combinations thereof. In some embodiments, a coating material is selected from the following list: TiO₂, ZrO₂, MoO₂, SnO₂, Nb₂O₅, Ta₂O₅, SiO₂, Li₂TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, MO₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In some embodiments, a coating material is selected from the following list: TiO₂, ZrO₂, MoO₂, SiO₂, Li₂TiO₃, Li₂ZrO₃, Li₇SiO₃, Li₂MnO₃, LiNbO₃, AlF₃, SiC, Si₃N₄, graphitic carbon, amorphous carbon, diamond-like carbon, or combinations thereof.

In some embodiments, the ion exchange particles may have an average diameter that is selected from the following list: less than 10 nm, less than 100 nm, less than 1,000 nm, less than 10,000 nm, or less than 100,000 nm. In some embodiments, the ion exchange particles may have an average size that is selected from the following list: less than 200 nm, less than 2,000 nm, or less than 20,000 nm.

In some embodiments, the ion exchange particles may be secondary particles comprised of smaller primary particles that may have an average diameter selected from the following list: less than 10 nm, less than 100 nm, less than 1,000 nm, or less than 10,000 nm.

In some embodiments, the ion exchange particles have a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm.

In some embodiments, the ion exchange material and a coating material may form one or more concentration gradients where the chemical composition of the particle ranges between two or more compositions. In some embodiments, the ion exchange materials and the coating materials may form a concentration gradient that extends over a thickness selected from the following list: less than 1 nm, less than 10 nm, less than 100 nm, less than 1,000 nm, less than 10,000 nm, or less than 100,000 nm.

In some embodiments, the ion exchange material is synthesized by a method selected from the following list: hydrothermal, solvothermal, sol-gel, solid state, molten salt flux, ion exchange, microwave, ball milling, precipitation, or vapor deposition. In some embodiments, the ion exchange material is synthesized by a method selected from the following list: hydrothermal, solid state, or microwave.

In some embodiments, a coating material is deposited by a method selected from the following list: chemical vapor deposition, atomic layer deposition, physical vapor deposition, hydrothermal, solvothermal, sol-gel, solid state, molten salt flux, ion exchange, microwave, wet impregnation, precipitation, titration, aging, ball milling, or combinations thereof. In some embodiments, the coating material is deposited by a method selected from the following list: chemical vapor deposition, hydrothermal, titration, solvothermal, wet impregnation, sol-gel, precipitation, microwave, or combinations thereof.

In some embodiments, a coating material is deposited with physical characteristics selected from the following list: crystalline, amorphous, full coverage, partial coverage, uniform, non-uniform, or combinations thereof.

In some embodiments, multiple coatings may be deposited on the ion exchange material in an arrangement selected from the following list: concentric, patchwork, or combinations thereof.

In some embodiments, the matrix material is selected from the following list: a polymer, an oxide, a phosphate, or combinations thereof. In some embodiments, a structural support is selected from the following list: polyvinyl fluoride, polyvinylidene difluoride, polyvinyl chloride, polyvinylidene dichloride, polyethylene, polypropylene, polyphenylene sulfide, polytetrafluoroethylene, polytetrofluoroethylene, sulfonated polytetrofluoroethylene, polystyrene, polydivinylbenzene, polybutadiene, sulfonated polymer, carboxylated polymer, Nafion, copolymers thereof, and combinations thereof. In some embodiments, a structural support is selected from the following list: polyvinylidene difluoride, polyvinyl chloride, sulfonated polytetrofluoroethylene, polystyrene, polydivinylbenzene, copolymers thereof, or combinations thereof. In some embodiments, a structural support is selected from the following list: titanium dioxide, zirconium dioxide, silicon dioxide, solid solutions thereof, or combinations thereof. In some embodiments, the matrix material is selected for thermal resistance, acid resistance, and/or other chemical resistance.

In some embodiments, the porous ion exchange bead is formed by mixing the ion exchange particles, the matrix material, and the filler material together at once. In some embodiments, the porous ion exchange bead is formed by first mixing the ion exchange particles and the matrix material, and then mixing with the filler material. In some embodiments, the porous ion exchange bead is formed by first mixing the ion exchange particles and the filler material, and then mixing with the matrix material. In some embodiments, the porous ion exchange bead is formed by first mixing the matrix material and the filler material, and then mixing with the ion exchange particles.

In some embodiments, the porous ion exchange bead is formed by mixing the ion exchange particles, the matrix material, and/or the filler material with a solvent that dissolves once or more of the components. In some embodiments, the porous ion exchange bead is formed by mixing the ion exchange particles, the matrix material, and/or the filler material as dry powders in a mixer or ball mill. In some embodiments, the porous ion exchange bead is formed by mixing the ion exchange particles, the matrix material, and/or the filler material in a spray drier.

In some embodiments, the matrix material is a polymer that is dissolved and mixed with the ion exchange particles and/or filler material using a solvent from the following list: n-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved and mixed with the ion exchange particles and/or matrix material using a solvent from the following list: water, ethanol, iso-propyl alcohol, acetone, or combinations thereof.

In some embodiments, the filler material is a salt that is dissolved out of the ion exchange bead to form pores using a solution selected from the following list: water, ethanol, iso-propyl alcohol, a surfactant mixture, an acid a base, or combinations thereof. In some embodiments, the filler material is a material that thermally decomposes to form a gas at high temperature so that the gas can leave the ion exchange bead to form pores, where the gas is selected from the following list: water vapor, oxygen, nitrogen, chlorine, carbon dioxide, nitrogen oxides, organic vapors, or combinations thereof.

In some embodiments, the porous ion exchange bead is formed from dry powder using a mechanical press, a pellet press, a tablet press, a pill press, a rotary press, or combinations thereof. In some embodiments, the porous ion exchange bead is formed from a solvent slurry by dripping the slurry into a different liquid solution. The solvent slurry may be formed using a solvent of n-methyl-2-pyrrolidone, dimethyl sulfoxide, tetrahydrofuran, dimethylformamide, dimethylacetamide, methyl ethyl ketone, or combinations thereof. The different liquid solution may be formed using water, ethanol, iso-propyl alcohol, acetone, or combinations thereof.

In some embodiments, the porous ion exchange bead is approximately spherical with an average diameter selected from the following list: less than 10 μm, less than 100 μm, less than 1 mm, less than 1 cm, or less than 10 cm. In some embodiments, the porous ion exchange bead is approximately spherical with an average diameter selected from the following list: less than 200 μm, less than 2 mm, or less than 20 mm.

In some embodiments, the porous ion exchange bead is tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm.

In some embodiments, the porous ion exchange bead is embedded in a support structure, which may be a membrane, a spiral-wound membrane, a hollow fiber membrane, or a mesh. In some embodiments, the porous ion exchange bead is embedded on a support structure comprised of a polymer, a ceramic, or combinations thereof. In some embodiments, the porous ion exchange bead is loaded directly into an ion exchange column with no additional support structure.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

In some embodiments, the acid used for recovering lithium from the porous ion exchange beads is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for recovering lithium from the porous ion exchange beads is selected from the following list: hydrochloric acid, sulfuric acid, nitric acid, or combinations thereof.

In some embodiments, the acid used for recovering lithium from the porous ion exchange beads has a concentration selected from the following list: less than 0.1 M, less than 1.0 M, less than 5 M, less than 10 M, or combinations thereof.

In some embodiments, the porous ion exchange beads perform the ion exchange reaction repeatedly over a number of cycles selected from the following list: greater than 10 cycles, greater than 30 cycles, greater than 100 cycles, greater than 300 cycles, or greater than 1,000 cycles. In some embodiments, the porous ion exchange beads perform the ion exchange reaction repeatedly over a number of cycles selected from the following list: greater than 50 cycles, greater than 100 cycles, or greater than 200 cycles.

In some embodiments, the concentrated lithium solution that is yielded from the porous ion exchange beads is further processed into lithium raw materials using methods selected from the following list: solvent extraction, ion exchange, chemical precipitation, electrodialysis, electrowinning, evaporation with direct solar energy, evaporation with concentrated solar energy, evaporation with a heat transfer medium heated by concentrated solar energy, evaporation with heat from a geothermal brine, evaporation with heat from combustion, or combinations thereof.

In some embodiments, the concentrated lithium solution that is yielded from the porous ion exchange beads is further processed into lithium chemicals selected from the following list: lithium chloride, lithium carbonate, lithium hydroxide, lithium metal, lithium metal oxide, lithium metal phosphate, lithium sulfide, or combinations thereof. In some embodiments, the concentrated lithium solution that is yielded from the porous ion exchange beads is further processed into lithium chemicals that are solid, liquid, hydrated, or anhydrous.

In some embodiments, the lithium chemicals produced using the porous ion exchange beads are used in an industrial application selected from the following list: lithium batteries, metal alloys, glass, grease, or combinations thereof. In some embodiments, the lithium chemicals produced using the coated ion exchange particles are used in an application selected from the following list: lithium batteries, lithium-ion batteries, lithium sulfur batteries, lithium solid-state batteries, and combinations thereof.

In some embodiments, the ion exchange materials are synthesized in a lithiated state with a sublattice fully or partly occupied by lithium. In some embodiments, the ion exchange materials are synthesized in a hydrated state with a sublattice fully or partly occupied by hydrogen.

### Base and Acid Generation

In one embodiment of this disclosure, acid and base are generated using an electrochemical cell. In one embodiment, acid and base are generated using electrodes. In one embodiment, acid and base are generated using a membrane. In some embodiments, the acid and base generated using an electrochemical cell are used in a process or system for lithium extraction from a liquid resource. In some embodiments, a lithium ion exchange eluate solution comprises acid and/or base generated using an electrochemical cell. In some embodiments, a lithium ion exchange eluate solution is fed into an electrochemical cell wherein acid and base are generated therefrom.

In one embodiment, said ion-conducting membrane is a cation-conducting membrane, an anion-conducting membrane or combinations thereof. In one embodiment, said ion-conducting membrane comprises sulfonated tetrafluoroethylene-based fluoropolymer-copolymer, sulfonated tetrafluoroethylene, sulfonated fluoropolymer, MK-40, co-polymers, or combinations thereof. In one embodiment, said anion-conducting membrane comprises a functionalized polymer structure.

In one embodiment, said functionalized polymer structure comprises polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment, said cation-conducting membrane allows for transfer of lithium ions but prevents transfer of anion groups. In one embodiment, said ion-conducting membrane has a thickness from about 1 μm to about 1000 μm. In one embodiment, said ion-conducting membrane has a thickness from about 1 mm to about 10 mm.

In one embodiment, said electrodes are comprised of titanium, niobium, zirconium, tantalum, magnesium, titanium dioxide, oxides thereof, or combinations thereof. In one embodiment, said electrodes further comprise a coating of platinum, TiO₂, ZrO₂, Nb₂O₅, Ta₂O₅, SnO₂, IrO₂, RuO₂, mixed metal oxides, graphene, derivatives thereof, or combinations thereof.

In one embodiment of an integrated system, a chlor-alkali setup is used to generate HCl and NaOH from an aqueous NaCl solution. In one embodiment, the HCl is used to elute lithium from an ion exchange system for selective lithium uptake to produce a lithium eluate solution. In one embodiment, the NaOH from the chlor-alkali setup is used to control the pH of the brine in the ion exchange system for selective lithium uptake. In one embodiment, the NaOH is used to precipitate impurities from a lithium eluate solution.

In one embodiment, the system includes one or more electrochemical or electrolysis systems. The terms “electrochemical” and “electrolysis” are used interchangeably in the present specification and these terms are synonymous unless specifically noted to the contrary. In one embodiment, an electrolysis system is comprised of one or more electrochemical cells. In one embodiment, an electrochemical system is used to produce HCl and NaOH. In one embodiment, an electrochemical system converts a salt solution into acid in base. In one embodiment, an electrochemical system converts a salt solution containing NaCl, KCl, and/or other chlorides into a base and an acid. In one embodiment, a salt solution precipitated or recovered from the brine is fed into an electrochemical system to produce acid and base. In one embodiment, an electrolysis system converts a lithium salt solution to form a lithium hydroxide solution, an acidified solution, and optionally a dilute lithium salt solution. In one embodiment, the lithium salt solution is or is derived from a lithium eluate solution, produced by an ion exchange system that has optionally been concentrated and/or purified. In one embodiment, acidified solution from an electrolysis system is returned to an ion exchange system to elute more lithium eluate solution.

In one embodiment of the integrated system, the integrated system includes one or more electrolysis systems. In one embodiment, an electrolysis system is comprised of one or more electrodialysis cells. In one embodiment, an electrolysis system converts a lithium salt solution to form a lithium hydroxide solution, an acidified solution, and optionally a dilute lithium salt solution. In one embodiment, the lithium salt solution is or is derived from a lithium eluate solution, produced by an ion exchange system that has optionally been concentrated and/or purified. In one embodiment, acidified solution from an electrolysis system is returned to an ion exchange system to elute more lithium eluate solution.

In one embodiment, a lithium salt solution contains unreacted acid from the ion exchange system. In one embodiment, unreacted acid in the lithium salt solution from an ion exchange system passes through an electrolysis system and is further acidified to form an acidified solution. In one embodiment, a lithium salt solution derived from an ion exchange system is purified to remove impurities without neutralizing the unreacted acid in the lithium salt solution and is then fed into an electrolysis system.

In one embodiment, an acidified solution produced by an electrolysis system contains lithium ions from the lithium salt solution fed into the electrolysis system. In one embodiment, an acidified solution containing lithium ions leaves the electrolysis system and is fed back to an ion exchange system to elute lithium and produce more lithium salt solution.

In one embodiment of an electrolysis system, the electrolysis cells are electrochemical cells. In one embodiment of a electrochemical cell, the membranes may be cation-conducting and/or anion-conducting membranes. In one embodiment, the electrochemical cell is a two-compartment cell with a cation-conducting membrane that allows for transfer of lithium ions between the chambers but prevents transfer of anion groups such as chloride, sulfate, and hydroxide groups.

In one embodiment of an electrolysis system, the electrolysis cells are electrodialysis cells. In one embodiment of a electrodialysis cell, the membranes may be cation-conducting and/or anion-conducting membranes. In one embodiment, the electrodialysis cell is a two-compartment cell with a cation-conducting membrane that allows for transfer of lithium ions between the chambers but prevents transfer of anion groups such as chloride, sulfate, and hydroxide groups.

In one embodiment of an electrolysis system, the electrolysis cells are membrane electrolysis cells. In one embodiment of a membrane electrolysis cell, the membranes may be cation-conducting and/or anion-conducting membranes. In one embodiment, the membrane electrolysis cell is a two-compartment cell with a cation-conducting membrane that allows for transfer of lithium ions between the chambers but prevents transfer of anion groups such as chloride, sulfate, and hydroxide groups.

In one embodiment, the membrane electrolysis cell is a three-compartment cell with a cation-conducting membrane that allows for transfer of lithium ions separating a compartment with an electrochemically reducing electrode from a central compartment and with an anion-conducting membrane that allows for transfer of anions ions separating a compartment with an electrochemically oxidizing electrode from the central compartment. In one embodiment, the cation-conducting membrane prevents transfer of anions such as chloride, sulfate, or hydroxide. In one embodiment, the anion-conducting membrane prevents transfer of cations such as lithium, sodium, or protons.

In one embodiment of the membrane electrolysis cell, the membranes may be comprised of Nafion®, sulfonated tetrafluoroethylene, sulfonated fluoropolymer, MK-40, co-polymers, other membrane materials, composites, or combinations thereof. In one embodiment of the membrane electrolysis cell, the cation exchange membranes are comprised of a functionalized polymer structure which may be Nafion®, sulfonated tetrafluoroethylene, sulfonated fluoropolymer, co-polymers, different polymers, composites of polymers, or combinations thereof. In one embodiment of the membrane electrolysis cell, the polymer structures of the cation exchange membrane are functionalized with sulfone groups, carboxylic acid groups, phosphate groups, other negatively charged functional groups, or combinations thereof.

In one embodiment of the electrochemical cell, the membranes may be comprised of Nafion®, sulfonated tetrafluoroethylene, sulfonated fluoropolymer, MK-40, co-polymers, other membrane materials, composites, or combinations thereof. In one embodiment of the electrochemical cell, the cation exchange membranes are comprised of a functionalized polymer structure which may be Nafion®, sulfonated tetrafluoroethylene, sulfonated fluoropolymer, co-polymers, different polymers, composites of polymers, or combinations thereof. In one embodiment of the electrochemical cell, the polymer structures of the cation exchange membrane are functionalized with sulfone groups, carboxylic acid groups, phosphate groups, other negatively charged functional groups, or combinations thereof.

In one embodiment of the electrodialysis cell, the membranes may be comprised of Nafion®, sulfonated tetrafluoroethylene, sulfonated fluoropolymer, MK-40, co-polymers, other membrane materials, composites, or combinations thereof. In one embodiment of the electrodialysis cell, the cation exchange membranes are comprised of a functionalized polymer structure which may be Nafion®, sulfonated tetrafluoroethylene, sulfonated fluoropolymer, co-polymers, different polymers, composites of polymers, or combinations thereof. In one embodiment of the electrodialysis cell, the polymer structures of the cation exchange membrane are functionalized with sulfone groups, carboxylic acid groups, phosphate groups, other negatively charged functional groups, or combinations thereof.

In one embodiment of the membrane electrolysis cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof. In one embodiment of the electrochemical cell, an anion exchange membrane is

comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the electrodialysis cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the membrane electrolysis cell, the membrane may have a thickness of less than 10 μm, less than 50 μm, less than 200 μm, less than 400 μm, or less than 1,000 μm. In one embodiment of the membrane electrolysis cell, the membranes may have a thickness of greater than 1,000 μm. In one embodiment of the membrane electrolysis cell, the membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment of the electrochemical cell, the membrane may have a thickness of less than 10 μm, less than 50 μm, less than 200 μm, less than 400 μm, or less than 1,000 μm. In one embodiment of the electrochemical cell, the membranes may have a thickness of greater than 1,000 μm. In one embodiment of the electrochemical cell, the membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment of the electrodialysis cell, the membrane may have a thickness of less than 10 μm, less than 50 μm, less than 200 μm, less than 400 μm, or less than 1,000 μm. In one embodiment of the electrodialysis cell, the membranes may have a thickness of greater than 1,000 μm. In one embodiment of the electrodialysis cell, the membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment, an electrolysis system contains electrolysis cells that may be two-compartment electrolysis cells or three-compartment electrolysis cells.

In one embodiment of a two-compartment electrolysis cell, the cell contains a first compartment that contains an electrochemically oxidizing electrode. A lithium salt solution enters the first compartment and is converted into an acidified solution. In one embodiment of a two-compartment electrolysis cell, the cell contains a second compartment containing an electrochemically reducing electrode. This second compartment takes as an input a water or dilute LiOH solution, and produces as an output a more concentrated LiOH solution. In one embodiment, the compartments are separated by a cation-conducting membrane that limits transport of anions.

In one embodiment of a three-compartment electrolysis cell, the cell contains a first compartment containing an electrochemically oxidizing electrode. The first compartment takes as an input water or a dilute salt solution, and produces as an output an acidified solution. In one embodiment of a three-compartment electrolysis cell, the cell contains a second compartment containing an electrochemically reducing electrode. This second compartment takes as an input a water or dilute hydroxide solution, and produces as an output a more concentrated hydroxide solution. In one embodiment of a three-compartment electrolysis cell, the cell contains a third compartment containing no electrode, which is located between the first and second compartment, and takes as an input a concentrated lithium salt solution, and produces as an output a dilute lithium salt solution. In one embodiment, the first and the third compartments are separated by an anion-conducting membrane that limits transport of cations. In one embodiment, the second and the third compartments are separated by a cation-conducting membrane that limits transport of anions.

In one embodiment of the electrolysis cell, the electrodes may be comprised of titanium, niobium, zirconium, tantalum, magnesium, titanium dioxide, oxides thereof, or combinations thereof. In one embodiment of the electrolysis cell, the electrodes may be coated with platinum, TiO₂, ZrO₂, Nb₂O₅, Ta₂O₅, SnO₂, IrO₂, RuO₂, PtOₓ, mixed metal oxides, graphene, derivatives thereof, or combinations thereof. In one embodiment of the electrolysis cell, the electrodes may be comprised of steel, stainless steel, nickel, nickel alloys, steel alloys, or graphite.

In one embodiment of the electrolysis system, the lithium salt solution is a LiCl solution optionally containing HCl. In one embodiment of the electrolysis system, the electrochemically oxidizing electrode oxides chloride ions to produce chlorine gas.

In one embodiment of the electrolysis system, the lithium salt solution is a Li₂SO₄ solution optionally containing H₂SO₄. In one embodiment of the electrolysis system, the electrochemically oxidizing electrode oxidizes water, hydroxide, or other species to produce oxygen gas.

In one embodiment of the electrolysis system, the electrochemically reducing electrode reduces hydrogen ions to produce hydrogen gas. In one embodiment of the electrolysis system, the chamber containing the electrochemically reducing electrode produces a hydroxide solution or increases the hydroxide concentration of a solution.

In one embodiment of the electrolysis system, chlorine and hydrogen gas are burned to produce HCl in an HCl burner. In one embodiment, the HCl burner is a column maintained at approximately 100-300 or 300-2,000 degrees Celsius. In one embodiment, HCl produced in the HCl burner is cooled through a heat exchange and absorbed into water in an absorption tower to produce aqueous HCl solution. In one embodiment, the HCl solution produced from the HCl burner is used to elute lithium from an ion exchange system.

In one embodiment, the pH of the acidified solution leaving the electrolysis cell may be 0 to 1, −2 to 0, 1 to 2, less than 2, less than 1, or less than 0. In some embodiments, the membrane electrolysis cell is an electrodialysis cell with multiple compartments. In some embodiments, the electrodialysis cell may have more than about two, more than about five, more than about 10, or more than about twenty compartments.

In one embodiment, the base added to precipitate metals from the liquid resource may be calcium hydroxide or sodium hydroxide. In one embodiment, the base may be added to the liquid resource as an aqueous solution with a base concentration that may be less than 1 N, 1-2 N, 2-4 N, 4-10 N, 10-20 N, or 20-40 N. In one embodiment, the base may be added to the liquid resource as a solid.

In one embodiment, the acid may be added to the precipitated metals to dissolve the precipitated metals before mixing the redissolved metals with the liquid resource. In one embodiment, the acid may be added to the liquid resource to acidify the liquid resource, and the precipitated metals may be combined with the acidified liquid resource to redissolve the precipitated metals.

In some embodiments, acid from the electrochemical cell may be used to elute lithium from the selective ion exchange material. In some embodiments, base from the electrochemical cell may be used to neutralize protons released from the selective ion exchange material.

### Methods of Generating a Lithium Eluate

An aspect of the disclosure described herein is a method of generating a lithium eluate solution (e.g., a lithium ion exchange eluate solution) from a liquid resource, comprising: providing an ion exchange reactor comprising a tank, ion exchange particles that selectively absorb lithium from a liquid resource and elute a lithium eluate solution when treated with an acid solution after absorbing lithium ions from said liquid resource, one or more particle traps, and provision to modulate pH of said liquid resource; flowing a liquid resource into said ion exchange reactor thereby allowing said ion exchange particles to selectively absorb lithium from said liquid resource; treating said ion exchange particles with an acid solution to yield said lithium eluate solution; and passing said lithium eluate solution through said one or more particle traps to collect said lithium eluate solution.

In some embodiments, the tank has a conical shape. In some embodiments, the tank has a partial conical shape. In some embodiments, the conical shape allows the ion exchange particles to settle into a settled bed so that liquid can be removed from above the settled bed. In some embodiments, the partial conical shape allows the ion exchange particles to settle into a settled bed so that liquid can be removed from above the settled bed.

In some embodiments, modulation of the pH of the liquid resource occurs in the tank. In some embodiments, modulation of the pH of the liquid resource occurs prior to injection into the tank. In some embodiments, one or more particle traps comprise one or more filters inside the tank. In some embodiments, one or more particle traps comprise one filter. In some embodiments, one or more particle traps comprise one filter. In some embodiments, one or more particle traps comprise two filters. In some embodiments, one or more particle traps comprise three filters. In some embodiments, one or more particle traps comprise four filters. In some embodiments, one or more particle traps comprise five filters.

In some embodiments, one or more particle traps is located at the bottom of the tank. In some embodiments, one or more particle traps is located close to the bottom of the tank. In some embodiments, one or more particle traps is located above the bottom of the tank.

In some embodiments, one or more particle traps comprise one or more meshes. In some embodiments, one or more particle traps comprises one mesh. In some embodiments, one or more particle traps comprises two meshes. In some embodiments, one or more particle traps comprises three meshes. In some embodiments, one or more particle traps comprises four meshes. In some embodiments, one or more particle traps comprises five meshes. In some embodiments, all the meshes of the one or more particle traps are identical. In some embodiments, at least one of the meshes of the one or more particle traps is not identical to the rest of the meshes of the one or more particle traps.

In some embodiments, one or more meshes comprise a pore space of less than about 200 microns, less than about 174 microns, less than about 150 microns, less than about 100 microns, less than about 75 microns, less than about 50 microns, less than about 25 microns, less than about 10 microns, more than about 1 micron, more than about 5 micron, more than about 10 microns, more than about 20 microns, more than about 30 microns, more than about 40 microns, more than about 50 microns, more than about 60 microns, more than about 70 microns, more than about 80 microns, more than about 90 microns, more than about 100 microns, more than about 125 microns, more than about 150 microns, more than about 174 microns from about 1 micron to about 200 microns, from about 5 microns to about 174 microns, from about 10 microns to about 150 microns, from about 10 microns to about 100 microns, from about 10 microns to about 90 microns, from about 10 microns to about 80 microns, from about 10 microns to about 70 microns, from about 10 microns to about 60 microns, or from about 10 microns to about 50 microns.

In some embodiments, one or more particle traps comprise multi-layered meshes. In some embodiments, the multi-layered meshes comprise at least one finer mesh for filtration and at least one coarser mesh for structural support. In some embodiments, one or more particle traps comprise one or more meshes supported by a structural support. In some embodiments, one or more particle traps comprise one or more polymer meshes. In some embodiments, the one or more polymer meshes are selected from the group consisting of polyetheretherketone, ethylene, tetrafluoroethylene, polyethylene terephthalate, polypropylene, and combinations thereof.

In some embodiments, one or more particle traps comprise one or more meshes comprising a metal wire mesh. In some embodiments, the metal wire mesh is coated with a polymer. In some embodiments, the ion exchange reactor is configured to move said ion exchange particles into one or more columns for washing. In some embodiments, the ion exchange reactor is configured to allow the ion exchange particles to settle into one or more columns for washing. In some embodiments, the columns are affixed to the bottom of said tank. In some embodiments, the one or more particle traps comprise one or more filters mounted in one or more ports through the wall of said tank.

In some embodiments, the one or more particle traps comprise one or more filters external to said tank, and with provision for fluid communication between said one or more filters and said tank. In some embodiments, the one or more particle traps comprise one or more gravity sedimentation devices external to said tank, and with provision for fluid communication between said one or more gravity sedimentation devices and said tank.

In some embodiments, one or more particle traps comprise one or more gravity sedimentation devices internal to said tank. In some embodiments, one or more particle traps comprise one or more centrifugal sedimentation devices external to said tank, and with provision for fluid communication between said one or more centrifugal sedimentation devices and said tank In some embodiments, one or more particle traps comprise one or more centrifugal sedimentation devices internal to said tank. In some embodiments, one or more particle traps comprise one or more settling tanks, one or more centrifugal devices, or combinations thereof external to said tank, and with provision for fluid communication between said one or more settling tanks, centrifugal devices, or combinations thereof, and said tank. In some embodiments, one or more particle traps comprise one or more meshes, one or more centrifugal devices, or combinations thereof external to said tank, and with provision for fluid communication between said one or more meshes, centrifugal devices, or combinations thereof, and said tank. In some embodiments, one or more particle traps comprise one or more settling tanks, one or more meshes, or combinations thereof external to said tank, and with provision for fluid communication between said one or more settling tanks, meshes, or combinations thereof, and said tank. In some embodiments, one or more particle traps comprise one or more meshes, one or more settling tanks, one or more centrifugal devices, or combinations thereof external to said tank, and with provision for fluid communication between said one or more meshes, one or more settling tanks, centrifugal devices, or combinations thereof, and said tank.

In some embodiments, the ion exchange particles are stirred. In some embodiments, the ion exchange particles are stirred by a mixer. In some embodiments, the ion exchange particles are stirred by a propeller. In some embodiments, the ion exchange particles are fluidized by pumping solution into the tank near the bottom of the tank. In some embodiments, the ion exchange particles are fluidized by pumping solution from the tank back into the tank near the bottom of the tank. In some embodiments, the ion exchange particles are fluidized by pumping a slurry of the ion exchange particles from near the bottom of the tank to a higher level in the tank.

In some embodiments, the method further comprises one or more staged elution tanks, wherein intermediate eluate solutions comprising mixtures of protons and lithium ions are stored and used further to elute lithium from said ion exchange particles that are freshly lithiated. In some embodiments, the method further comprises one or more staged elution tanks, wherein intermediate eluate solutions comprising mixtures of protons and lithium ions are mixed with additional acid and used further to elute lithium from said ion exchange particles.

In some embodiments, the ion exchange particles further comprise a coating material. In some embodiments, the coating material is a polymer. In some embodiments, the coating of the coating material comprises a chloro-polymer, a fluoro-polymer, a chloro-fluoro-polymer, a hydrophilic polymer, a hydrophobic polymer, co-polymers thereof, mixtures thereof, or combinations thereof.

As disclosed herein, in some embodiments, and for any process of lithium extraction disclosed herein, the pH of the lithium-enriched acidic eluent solution is regulated to control elution of lithium and/or non-lithium impurities. In some embodiments, pH of the lithium-enriched acidic solution is regulated by adding protons, such as an acid and/or an acidic solution, to the lithium-enriched acidic solution. In some embodiments, pH of the lithium-enriched acidic solution is regulated by adding protons, such as an acid and/or an acidic solution, to the impurities-enriched lithiated acidic solution prior to removing impurities.

In some embodiments, the acid (e.g., acidic solution) comprises sulfuric acid, phosphoric acid, hydrochloric acid, hydrobromic acid, carbonic acid, nitric acid, or combinations thereof. In some embodiments, the acidic solution is the same as the acidic solution originally contacted with the first lithium-enriched ion exchange material. In some embodiments, the acidic solution is the different from the acidic solution originally contacted with the first lithium-enriched ion exchange material.

In some embodiments, more protons are added to the lithium-enriched acidic solution, forming a protonated lithium-enriched acidic solution that is again contacted with a lithium-enriched ion exchange material to elute more lithium into the protonated lithium-enriched acidic solution. In some embodiments, more protons are added to the lithium-enriched acidic solution by adding an acid or acidic solution thereto to form the protonated lithium-enriched acidic solution. In some embodiments, protons are added to a lithium-enriched acidic solution before passing through each vessel in a network of lithium-selective ion exchange vessels, as described herein.

### Embodiments for Limiting or Eliminating Precipitation of Impurities in the Eluate Solution

In one embodiment, lithium and non-lithium impurities are absorbed from a lithium resource into an ion exchange material. In one embodiment, lithium and non-lithium impurities are eluted from an ion exchange material into an acidic solution. In one embodiment, lithium and non-lithium impurities are eluted from an ion exchange material into an acidic solution containing dissolved species that may precipitate at certain concentrations. In one embodiment, lithium and non-lithium impurities are eluted from an ion exchange material into an acidic solution containing dissolved species that may be reduced in concentration to avoid precipitation. In one embodiment, lithium and non-lithium impurities are eluted from an ion exchange material into an acidic solution where said non-lithium impurities may precipitate at certain concentrations.

In one embodiment, lithium and multivalent impurities are absorbed from a lithium resource into an ion exchange material. In one embodiment, lithium and multivalent impurities are eluted from an ion exchange material into an acidic solution. In one embodiment, lithium and multivalent impurities are eluted from an ion exchange material into an acidic solution containing sulfate anions. In one embodiment, lithium and multivalent impurities are eluted from an ion exchange material into an acidic solution containing sulfate anions such that the multivalent impurities and sulfate anions may react to form insoluble salts that can precipitate. In one embodiment, lithium and multivalent impurities are eluted from an ion exchange material into a solution containing sulfate anions such that the multivalent impurities and sulfate anions that may react to form insoluble salts that can precipitate. In one embodiment, lithium and multivalent cations are eluted from an ion exchange material into a solution containing sulfate anions wherein the concentrations of sulfate anions and multivalent cations are limited to avoid precipitation of insoluble sulfate compounds.

In one embodiment, lithium and multivalent cations are eluted from an ion exchange material into a solution containing sulfate anions wherein the concentrations of multivalent cations are limited to avoid precipitation of insoluble sulfate compounds. In one embodiment, lithium and multivalent cations are eluted from an ion exchange material into a solution containing sulfate anions wherein the concentrations of multivalent cations are limited using nanofiltration to avoid precipitation of insoluble sulfate compounds. In one embodiment, lithium and multivalent cations are eluted from a first ion exchange material into a solution containing sulfate anions wherein the concentrations of multivalent cations are decreased using a second ion exchange material to avoid precipitation of insoluble sulfate compounds. In one embodiment, lithium and multivalent cations are eluted from a first ion exchange material into a solution containing sulfate anions wherein the concentrations of multivalent cations are limited using a second ion exchange material that is selective for multivalent cations to avoid precipitation of insoluble sulfate compounds.

In one embodiment, lithium and multivalent cations are eluted from an ion exchange material into a solution containing sulfate anions wherein the concentrations of multivalent cations are decreased to avoid precipitation of insoluble sulfate compounds. In one embodiment, lithium and multivalent cations are eluted from an ion exchange material into a solution containing sulfate anions and the concentration of multivalent cations in the sulfate solution is decreased to avoid precipitation of insoluble sulfate compounds.

In one embodiment, a sulfate solution is contacted with an ion exchange material to elute lithium along with impurities, the sulfate solution is processed to reduce the concentration of impurities, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, the sulfate solution is again contacted with an ion exchange material to elute more lithium along with impurities, and the concentration of multivalent cations is maintained at a sufficiently low level to avoid precipitation of insoluble salts.

In one embodiment, a sulfate solution is contacted with an ion exchange material to elute a target metal along with impurities, the sulfate solution is processed to reduce the concentration of impurities, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, the sulfate solution is again contacted with an ion exchange material to elute more of the target metal along with impurities, and the concentration of multivalent cations is maintained at a sufficiently low level to avoid precipitation of insoluble salts.

In one embodiment, an acidic sulfate solution is contacted with an ion exchange material to elute lithium along with impurities, the acidic sulfate solution is processed to reduce the concentration of impurities, and the acidic sulfate solution is again contacted with an ion exchange material to elute more lithium along with more impurities. In one embodiment, the pH of the acidic sulfate solution is regulated to control elution of lithium and/or impurities. In one embodiment, pH of the acidic sulfate solution is regulated by measuring pH with a pH probe and adding sulfuric acid and/or a solution containing sulfuric acid to the acidic sulfate solution. In one embodiment, pH of the acidic sulfate solution is regulated adding sulfuric acid and/or a solution containing sulfuric acid to the acidic sulfate solution.

In one embodiment, the sulfate solution used to elute lithium from the ion exchange material is replaced with a different solution. In one embodiment, the sulfate solution used to elute lithium from the ion exchange material is replaced with a solution comprising sulfate, nitrate, phosphate, chloride, bromide, fluoride, borate, iodide, carbonate, or combinations thereof. In one embodiment, a solution comprising anions is contacted with an ion exchange material to elute lithium along with impurities, the solution is processed to reduce the concentration of impurities, and the solution is again contacted with an ion exchange material to elute more lithium along with impurities, where the anions are selected from a list including sulfate, nitrate, phosphate, chloride, bromide, fluoride, borate, iodide, carbonate, or combinations thereof.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution to avoid the formation of precipitates. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic sulfate solution to elute lithium into the acidic solution, and multivalent impurities are removed from the acidic solution to avoid the formation of sulfate precipitates.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is returned to the fluidized bed.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is passed to a second fluidized bed of ion exchange material for elution of more lithium into the acidic solution. In one embodiment, the acidic solution flows through multiple fluidized beds of ion exchange material for elution of lithium and impurities, and impurities are removed from the acidic solution between the multiple fluidized beds. In one embodiment, the acidic solution flows through multiple fluidized beds of ion exchange material for elution of lithium and impurities, and impurities are removed from the acidic solution between the multiple fluidized beds using nanofiltration. In one embodiment, the acidic solution flows through multiple fluidized beds of a first ion exchange material which is lithium-selective for elution of lithium and impurities, and impurities are removed from the acidic solution between the multiple fluidized beds using a second ion exchange material that is selective for multivalent ions.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution to avoid the formation of precipitates. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic sulfate solution to elute lithium into the acidic solution, and multivalent impurities are removed from the acidic solution to avoid the formation of sulfate precipitates.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is returned to the packed bed.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is passed to a second packed bed of ion exchange material for elution of more lithium into the acidic solution. In one embodiment, the acidic solution flows through multiple packed beds of ion exchange material for elution of lithium and impurities, and impurities are removed from the acidic solution between the multiple packed beds. In one embodiment, the acidic solution flows through multiple packed beds of ion exchange material for elution of lithium and impurities, and impurities are removed from the acidic solution between the multiple packed beds using nanofiltration. In one embodiment, the acidic solution flows through multiple packed beds of a first ion exchange material which is lithium-selective for elution of lithium and impurities, and impurities are removed from the acidic solution between the multiple packed beds using a second ion exchange material that is selective for multivalent ions.

In some embodiments, the packed beds may be partially or occasionally fluidized. In some embodiments, the fluidized beds may be partially or occasionally packed. In some embodiments, the packed or fluidized beds may be washed before and/or after contracting with brine and/or acid using water or washing solutions containing water, salt, chelating compounds, ethylenediaminetetraacetic acid, salt of ethylenediaminetetraacetate, compounds of ethylenediaminetetraacetate, and/or anti-scalants. In some embodiments, the acidic solution used to elute lithium from the lithium-selective ion exchange material may contain water, salt, chelating compounds, ethylenediaminetetraacetic acid, salt of ethylenediaminetetraacetate, compounds of ethylenediaminetetraacetate, and/or anti-scalants. In some embodiments, dilution water is used to limit and/or prevent formation of insoluble precipitates.

In some embodiments, multivalent impurities may be removed from a lithium salt solution using precipitation. In some embodiments, multivalent impurities may be removed from a lithium salt solution using precipitation through addition of base. In some embodiments, multivalent impurities may be removed from a lithium salt solution using precipitation through addition of sodium hydroxide, sodium carbonate, and/or other compounds.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, and the lithium selective ion exchange material is contacted with an acidic solution to elute lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more protons are added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more acid is added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a first vessel, more protons are added to the acidic solution, and the acidic solution is again contacted with lithium selective ion exchange material to elute more lithium into the acidic solution in a second vessel. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a vessel, more protons are added to the acidic solution, and the acidic solution is again contacted with lithium selective ion exchange material to elute more lithium into the acidic solution in the vessel.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution, and the acidic solution is again contacted with lithium selective ion exchange material to elute more lithium into the acidic solution.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution using nanofiltration or multivalent-selective ion exchange materials, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution using nanofiltration or multivalent-selective ion exchange materials, and the acidic solution is again contacted with lithium selective ion exchange material to elute more lithium into the acidic solution.

In some embodiments, an acidic solution is contacted with a lithium selective ion exchange material that has previously been loaded with lithium by contacting the lithium selective ion exchange material with a liquid resource, the acidic solution is treated to remove multivalent impurities, and the acidic solutions is again contacted with a lithium selective ion exchange material that has previously been loaded with lithium by contacting the lithium selective ion exchange material with a liquid resource. In some embodiments, an acidic solution is contacted with a lithium selective ion exchange material to elute lithium, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium, the acidic solution is treated to remove multivalent impurities, more protons are added to the acidic solution, and the acidic solutions is again contacted with a lithium selective ion exchange material to elute lithium. In some embodiments, an acidic solution is contacted with a lithium selective ion exchange material to elute lithium, more protons are added to the acidic solution, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium in a vessel, the acidic solution is treated to remove multivalent impurities, and the acidic solutions is contacted with a lithium selective ion exchange material to elute lithium in said vessel. In some embodiments, an acidic solution is contacted with a lithium selective ion exchange material to elute lithium in a first vessel, the acidic solution is treated to remove multivalent impurities, and the acidic solutions is contacted with a lithium selective ion exchange material to elute lithium in a second vessel. In some embodiments, multivalent impurities are removed with a multivalent cation selective ion exchange material. In some embodiments, multivalent impurities are removed using nanofiltration membranes. In some embodiments, the lithium selective ion exchange materials is in a tank, a column, or a stirred tank reactor. In some embodiments, the lithium selective ion exchange material is in a fixed or fluidized bed.

In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium and multivalent cation impurities are removed between the vessels. In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium, multivalent cation impurities are removed between the multiple vessels, and more protons are added to the acid solution between the multiple vessels. In some embodiments, an acidic solution is recirculated through a vessel loaded a lithium selective ion exchange material to elute lithium. In some embodiments, an acidic solution is recirculated through a vessel loaded a lithium selective ion exchange material to elute lithium and multivalent cation impurities are removed between each recirculation. In some embodiments, an acidic solution is recirculated through a vessel loaded a lithium selective ion exchange material to elute lithium, multivalent cation impurities are removed between each recirculation, and more protons are added to the acid solution between each recirculation.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, and the acidic solution is prepared in an acidic solution mixing unit. In one embodiment, the acidic solution mixing unit is a tank, an in-line mixing device, a stirred tank reactor, another mixing unit, or combinations thereof. In one embodiment, the acid solution mixing tank is used to service one vessel containing lithium selective ion exchange material. In one embodiment, the acid solution mixing tank is used to service multiple vessels containing lithium selective ion exchange material in parallel or series. In one embodiment, the acid solution mixing tank is used to service multiple vessels containing lithium selective ion exchange material in sequence.

In one embodiment, the acidic solution is comprised of sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed using a combination of nanofiltration, multivalent cation selective ion exchange material, other methods of removing multivalent impurities, or combinations thereof. In one embodiment, impurities are removed from an acidic lithium solutions using combinations of nanofiltration, multivalent cation selective ion exchange material, other methods of removing multivalent impurities in parallel, series, or combinations thereof.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using nanofiltration membrane units arranged in series and/or parallel, more protons are added to the acidic solution, and the acid solutions is contacted with lithium selective ion exchange material to elute more lithium into the acidic solution. In one embodiment, anti-scalants, chelants (e.g., one or more chelating agents), or other means of anti-scaling are used to avoid scaling in the nanofiltration membrane units.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange materials, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material in a packed bed, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns with a first absorption column position for absorbing impurities and a last absorption column position for absorbing trace amounts of impurities, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a lead-lag configuration, and the acid solutions is contacted with lithium selective ion exchange material to elute more lithium into the acidic solution. In one embodiment, a multivalent cation selective ion exchange material is arranged in a variation of a lead-lag setup. In one embodiment, a multivalent cation selective ion exchange material is eluted using a second acidic solution. In one embodiment, a multivalent cation selective ion exchange material is eluted using hydrochloric acid. In one embodiment, a multivalent cation selective ion exchange material is regenerated using sodium hydroxide. In one embodiment, a multivalent cation selective ion exchange material is operated in stirred tank reactors, fluidized beds, or packed beds arranged in series and/or parallel. In one embodiment, a lithium selective ion exchange material is operated in stirred tank reactors, fluidized beds, or packed beds arranged in series and/or parallel.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphate to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphoric acid to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, Ca, Mg, Sr, and/or Ba are removed from the acidic solution by adding phosphoric acid to precipitate Ca, Mg, Sr, and/or Ba phosphate compounds, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding oxalate, oxalic acid, citrate, citric acid, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding a precipitant comprising oxalate, oxalic acid, citrate, citric acid, or combinations thereof, the precipitant concentration is decreased by adding cations to the acidic solution, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding oxalate, oxalate anions are precipitated and removed from the acidic solution by adding zinc, iron, manganese, other transition metals, other cations, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding citrate, citrate anions are precipitated and removed from the acidic solution by adding cations, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated from the acidic solution by adding anion precipitants, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated and removed from the acidic solution by adding anion precipitants, the anions precipitants are precipitated and removed from the acidic solution by adding cation precipitants, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by temporarily reducing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by changing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by decreasing the temperature of the acidic solution, protons are added to the acidic solution and the acidic solution is heated or allowed to warm, and the acid solutions is contacted with lithium selective ion exchange material to elute more lithium into the acidic solution.

In one embodiment, a chelating agent or anti-scalant is used to form a soluble complex to avoid precipitation in an acidic lithium solution. In one embodiment, a chelating agent or anti-scalant is used to form a soluble complex to avoid or redissolve precipitates. In one embodiment, a chelating agent or anti-scalants is used to limit or reduce precipitation of multivalent cations and the chelating agent or antiscalant is selected from the list of ethylenediaminetetraacetic acid (EDTA), disodium EDTA, calcium disodium EDTA, tetrasodium EDTA, citric acid, maleic acid, silicate compounds, amorphous silicate compounds, crystalline layered silicate compounds, phosphonic acid compounds, aminotris(methylenephosphonic acid) (ATMP), nitrilotrimethylphosphonic acid (NTMP), ethylenediamine tetra(methylene phosphonic acid) (EDTMP), diethylenetriamine penta(methylene phosphonic acid) (DTPMP), polyphosphonate, polyacrylate, polyacrylic acid, nitrilotriacetic acid (NTA), sodium hexametaphosphate (SHMP), or combinations thereof. In one embodiment, a threshold inhibitor is used to block development of nuclei in an acidic lithium solution. In one embodiment, a retarded is used to block the growth of precipitates in an acidic lithium solution. In one embodiment, compounds are used to limit, control, eliminate, or redissolve precipitates including phosphinopolycarboxylic acid, sulfonated polymer, polyacrylic acid, p-tagged sulfonated polymer, diethylenetriamine penta, bis-hexamethylene triamine, compounds thereof, modifications thereof, or combinations thereof.

In one embodiment, the acidic solution comprises lithium sulfate, lithium hydrogen sulfate, sulfuric acid, or combinations thereof. In one embodiment, the acidic solution comprises lithium sulfate, lithium hydrogen sulfate, sulfuric acid, lithium chloride, hydrochloric acid, lithium nitrate, nitric acid, lithium phosphate, lithium hydrogen phosphate, lithium dihydrogen phosphate, phosphoric acid, lithium bromide, bromic acid, or combinations thereof.

In some embodiments, lithium and other metals are recovered from the liquid resource. In some embodiments, the methods described for lithium recovery are applied to recover other metals.

Compositions of Eluates Produced by Lithium Extraction from a Liquid Resource Using Ion Exchange

Lithium extraction via any of the aforementioned methods produces an eluate enriched in lithium (e.g., a lithium ion exchange eluate solution), whereby the majority of impurities in the liquid resource are rejected and a purified lithium stream is produced. The concentrated lithium solution is an aqueous solution comprising lithium and other dissolved ions, and is donated as an eluate. Said eluate is produced by treatment of an ion exchange material that has absorbed lithium with an acidic eluent to produce an eluent. Said eluent is acidic and contains lithium in combination with other cations and anions that are present in the liquid resource from which lithium is extracted.

Said eluent can be contacted with ion exchange material in one or more of the aforementioned ion exchange vessels to produce an eluate. Said eluate is stored in one or more different vessels that are part of an ion exchange network.

The concentration of lithium and other ions in solution vary depending on the liquid resource from which lithium is extracted. In some embodiments, the eluate is produced by contacting the lithiated ion exchange materials with an acidic solution which comprises sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

In some embodiments, the concentration of acid (e.g., the concentration of acid in the acidic solution) used to produce the eluate (e.g., the lithium ion exchange eluate solution) is from about 0.01 moles per liter to 0.1 moles per liter. In some embodiments, the concentration of acid used to produce the eluate is from about 0.1 moles per liter to 0.2 moles per liter. In some embodiments, the concentration of acid used to produce the eluate is from about 0.2 moles per liter to 0.5 moles per liter. In some embodiments, the concentration of acid used to produce the eluate is from about 0.5 moles per liter to 1.0 moles per liter. In some embodiments, the concentration of acid used to produce the eluate is from about 1.0 moles per liter to 2.0 moles per liter. In some embodiments, the concentration of acid used to produce the eluate is from about 2.0 moles per liter to 5.0 moles per liter. In some embodiments, the concentration of acid used to produce the eluate is from about 5.0 moles per liter to 10 moles per liter. In some embodiments, the concentration of acid used to produce the eluate is from about 10 moles per liter to 50 moles per liter

Exemplary embodiments of the present disclosure include compositions of the concentrated lithium eluate produced by contacting an acid with an ion exchange material lithiated by lithium from a liquid resource. In some embodiments, the concentrated lithium solution contains other ions, comprising but not limited to one or more ions of lithium, sodium, calcium, magnesium, potassium, boron, strontium, barium, zirconium, titanium, vanadium, iron, copper, manganese, molybdenum, aluminum, niobium, sulfate, chloride, fluoride, bromide, nitrate, carbonate, bicarbonate, hydrogencarbonate, phosphate, borate, mixtures thereof or combinations thereof.

In some embodiments, the concentration of lithium (e.g., concentration of lithium in the lithium ion exchange eluate solution) is greater than about 200.0 milligrams per liter and less than about 8000 milligrams per liter. In some embodiments, the concentration of lithium is greater than about 200 milligrams per liter and less than about 4000 milligrams per liter. In some embodiments, the concentration of lithium is greater than about 2000 milligrams per liter and less than about 8000 milligrams per liter. In some embodiments, the concentration of lithium is greater than about 200 milligrams per liter and less than about 1000 milligrams per liter. In some embodiments, the concentration of lithium is greater than about 200 milligrams per liter and less than about 500 milligrams per liter. In some embodiments, the concentration of lithium is greater than about 1000 milligrams per liter and less than about 4000 milligrams per liter. In some embodiments, the concentration of lithium is greater than about 1000.0 milligrams per liter and less than about 2000.0 milligrams per liter. In some embodiments, the concentration of lithium is greater than about 2000.0 milligrams per liter and less than about 3000.0 milligrams per liter. In some embodiments, the concentration of lithium is greater than about 3000.0 milligrams per liter and less than about 4000.0 milligrams per liter. In some embodiments, the concentration of lithium is greater than about 4000.0 milligrams per liter and less than about 5000.0 milligrams per liter. In some embodiments, the concentration of lithium is greater than about 5000.0 milligrams per liter and less than about 6000.0 milligrams per liter. In some embodiments, the concentration of lithium is greater than about 6000.0 milligrams per liter and less than about 8000.0 milligrams per liter. In some embodiments, the concentration of lithium is greater than about 8000.0 milligrams per liter and less than about 10000.0 milligrams per liter. In some embodiments, the concentration of lithium is greater than about 10000.0 milligrams per liter and less than about 12000.0 milligrams per liter. In some embodiments, the concentration of lithium is greater than about 12000.0 milligrams per liter and less than about 20000.0 milligrams per liter. In some embodiments, the concentration of lithium is greater than about 15000.0 milligrams per liter and less than about 25000.0 milligrams per liter. In some embodiments, the concentration of lithium is greater than about 20000.0 milligrams per liter and less than about 25000.0 milligrams per liter. In some embodiments, one or more cationic metals comprise barium. In some embodiments, cationic impurities comprise barium.

In some embodiments, the concentration of barium (e.g., concentration of barium in the lithium ion exchange eluate solution) is greater than about 0.1 milligrams per liter and less than about 750 milligrams per liter. In some embodiments, the concentration of barium is greater than about 1 milligrams per liter and less than about 50 milligrams per liter. In some embodiments, the concentration of barium is greater than about 50 milligrams per liter and less than about 100 milligrams per liter. In some embodiments, the concentration of barium is greater than about 100 milligrams per liter and less than about 200 milligrams per liter. In some embodiments, the concentration of barium is greater than about 200 milligrams per liter and less than about 300 milligrams per liter. In some embodiments, the concentration of barium is greater than about 300 milligrams per liter and less than about 400 milligrams per liter. In some embodiments, the concentration of barium is greater than about 400.0 milligrams per liter and less than about 500.0 milligrams per liter. In some embodiments, the concentration of barium is greater than about 500.0 milligrams per liter and less than about 600.0 milligrams per liter. In some embodiments, the concentration of barium is greater than about 600.0 milligrams per liter and less than about 700.0 milligrams per liter. In some embodiments, the concentration of barium is greater than about 700.0 milligrams per liter and less than about 800.0 milligrams per liter.

In some embodiments, the concentration of boron (e.g., concentration of boron in the lithium ion exchange eluate solution) is greater than about 10.0 milligrams per liter and less than about 5000 milligrams per liter. In some embodiments, the concentration of boron is greater than about 20 milligrams per liter and less than about 1000 milligrams per liter. In some embodiments, the concentration of boron is greater than about 1000 milligrams per liter and less than about 2000 milligrams per liter. In some embodiments, the concentration of boron is greater than about 2000 milligrams per liter and less than about 3000 milligrams per liter. In some embodiments, the concentration of boron is greater than about 3000 milligrams per liter and less than about 4000 milligrams per liter. In some embodiments, the concentration of boron is greater than about 4000 milligrams per liter and less than about 6000 milligrams per liter. In some embodiments, the concentration of boron is greater than about 10.0 milligrams per liter and less than about 500.0 milligrams per liter. In some embodiments, the concentration of boron is greater than about 500.0 milligrams per liter and less than about 1000.0 milligrams per liter. In some embodiments, the concentration of boron is greater than about 6000.0 milligrams per liter and less than about 10000.0 milligrams per liter.

In some embodiments, the concentration of calcium (e.g., concentration of calcium in the lithium ion exchange eluate solution) is greater than about 10.0 milligrams per liter and less than about 5000 milligrams per liter. In some embodiments, the concentration of calcium is greater than about 20 milligrams per liter and less than about 1000 milligrams per liter. In some embodiments, the concentration of calcium is greater than about 1000 milligrams per liter and less than about 2000 milligrams per liter. In some embodiments, the concentration of calcium is greater than about 2000 milligrams per liter and less than about 3000 milligrams per liter. In some embodiments, the concentration of calcium is greater than about 3000 milligrams per liter and less than about 4000 milligrams per liter. In some embodiments, the concentration of calcium is greater than about 4000 milligrams per liter and less than about 6000 milligrams per liter. In some embodiments, the concentration of calcium is greater than about 10.0 milligrams per liter and less than about 500.0 milligrams per liter. In some embodiments, the concentration of calcium is greater than about 500.0 milligrams per liter and less than about 1000.0 milligrams per liter. In some embodiments, the concentration of calcium is greater than about 6000.0 milligrams per liter and less than about 10000.0 milligrams per liter. In some embodiments, the concentration of calcium is greater than about 4000 milligrams per liter and less than about 5000 milligrams per liter. In some embodiments, the concentration of calcium is greater than about 5000 milligrams per liter and less than about 6000 milligrams per liter.

In some embodiments, the concentration of magnesium (e.g., concentration of magnesium in the lithium ion exchange eluate solution) is greater than about 10.0 milligrams per liter and less than about 5000 milligrams per liter. In some embodiments, the concentration of magnesium is greater than about 20 milligrams per liter and less than about 1000 milligrams per liter. In some embodiments, the concentration of magnesium is greater than about 1000 milligrams per liter and less than about 2000 milligrams per liter. In some embodiments, the concentration of magnesium is greater than about 2000 milligrams per liter and less than about 3000 milligrams per liter. In some embodiments, the concentration of magnesium is greater than about 3000 milligrams per liter and less than about 4000 milligrams per liter. In some embodiments, the concentration of magnesium is greater than about 4000 milligrams per liter and less than about 6000 milligrams per liter. In some embodiments, the concentration of magnesium is greater than about 10.0 milligrams per liter and less than about 500.0 milligrams per liter. In some embodiments, the concentration of magnesium is greater than about 500.0 milligrams per liter and less than about 1000.0 milligrams per liter. In some embodiments, the concentration of magnesium is greater than about 6000.0 milligrams per liter and less than about 10000.0 milligrams per liter.

In some embodiments, the concentration of potassium (e.g., concentration of potassium in the lithium ion exchange eluate solution) is greater than about 10.0 milligrams per liter and less than about 5000 milligrams per liter. In some embodiments, the concentration of potassium is greater than about 20 milligrams per liter and less than about 1000 milligrams per liter. In some embodiments, the concentration of potassium is greater than about 1000 milligrams per liter and less than about 2000 milligrams per liter. In some embodiments, the concentration of potassium is greater than about 2000 milligrams per liter and less than about 3000 milligrams per liter. In some embodiments, the concentration of potassium is greater than about 3000 milligrams per liter and less than about 4000 milligrams per liter. In some embodiments, the concentration of potassium is greater than about 4000 milligrams per liter and less than about 6000 milligrams per liter. In some embodiments, the concentration of potassium is greater than about 10.0 milligrams per liter and less than about 500.0 milligrams per liter. In some embodiments, the concentration of potassium is greater than about 500.0 milligrams per liter and less than about 1000.0 milligrams per liter. In some embodiments, the concentration of potassium is greater than about 6000.0 milligrams per liter and less than about 10000.0 milligrams per liter.

In some embodiments, the concentration of sodium (e.g., concentration of sodium in the lithium ion exchange eluate solution) is greater than about 10.0 milligrams per liter and less than about 5000 milligrams per liter. In some embodiments, the concentration of sodium is greater than about 20 milligrams per liter and less than about 1000 milligrams per liter. In some embodiments, the concentration of sodium is greater than about 1000 milligrams per liter and less than about 2000 milligrams per liter. In some embodiments, the concentration of sodium is greater than about 2000 milligrams per liter and less than about 3000 milligrams per liter. In some embodiments, the concentration of sodium is greater than about 3000 milligrams per liter and less than about 4000 milligrams per liter. In some embodiments, the concentration of sodium is greater than about 4000 milligrams per liter and less than about 6000 milligrams per liter. In some embodiments, the concentration of sodium is greater than about 10.0 milligrams per liter and less than about 500.0 milligrams per liter. In some embodiments, the concentration of sodium is greater than about 500.0 milligrams per liter and less than about 1000.0 milligrams per liter. In some embodiments, the concentration of sodium is greater than about 6000.0 milligrams per liter and less than about 10000.0 milligrams per liter. In some embodiments, the concentration of sodium is greater than about 10000.0 milligrams per liter and less than about 15000.0 milligrams per liter. In some embodiments, the concentration of sodium is greater than about 15000.0 milligrams per liter and less than about 20000.0 milligrams per liter. In some embodiments, the concentration of sodium is greater than about 20000.0 milligrams per liter and less than about 25000.0 milligrams per liter. In some embodiments, the concentration of sodium is greater than about 10000.0 milligrams per liter and less than about 25000.0 milligrams per liter.

In some embodiments, the concentration of strontium (e.g., concentration of strontium in the lithium ion exchange eluate solution) is greater than about 10.0 milligrams per liter and less than about 5000 milligrams per liter. In some embodiments, the concentration of strontium is greater than about 20 milligrams per liter and less than about 1000 milligrams per liter. In some embodiments, the concentration of strontium is greater than about 1000 milligrams per liter and less than about 2000 milligrams per liter. In some embodiments, the concentration of strontium is greater than about 2000 milligrams per liter and less than about 3000 milligrams per liter. In some embodiments, the concentration of strontium is greater than about 3000 milligrams per liter and less than about 4000 milligrams per liter. In some embodiments, the concentration of strontium is greater than about 4000 milligrams per liter and less than about 6000 milligrams per liter. In some embodiments, the concentration of strontium is greater than about 10.0 milligrams per liter and less than about 500.0 milligrams per liter. In some embodiments, the concentration of strontium is greater than about 500.0 milligrams per liter and less than about 1000.0 milligrams per liter. In some embodiments, the concentration of strontium is greater than about 6000.0 milligrams per liter and less than about 10000.0 milligrams per liter.

In some embodiments, the concentration of aluminum (e.g., concentration of aluminum in the lithium ion exchange eluate solution) is greater than about 0.1 milligrams per liter and less than about 750 milligrams per liter. In some embodiments, the concentration of aluminum is greater than about 1 milligrams per liter and less than about 50 milligrams per liter. In some embodiments, the concentration of aluminum is greater than about 50 milligrams per liter and less than about 100 milligrams per liter. In some embodiments, the concentration of aluminum is greater than about 100 milligrams per liter and less than about 200 milligrams per liter. In some embodiments, the concentration of aluminum is greater than about 200 milligrams per liter and less than about 300 milligrams per liter. In some embodiments, the concentration of aluminum is greater than about 300 milligrams per liter and less than about 400 milligrams per liter. In some embodiments, the concentration of aluminum is greater than about 400.0 milligrams per liter and less than about 500.0 milligrams per liter. In some embodiments, the concentration of aluminum is greater than about 500.0 milligrams per liter and less than about 600.0 milligrams per liter. In some embodiments, the concentration of aluminum is greater than about 600.0 milligrams per liter and less than about 700.0 milligrams per liter. In some embodiments, the concentration of aluminum is greater than about 700.0 milligrams per liter and less than about 800.0 milligrams per liter. In some embodiments, one or more cationic metals comprise aluminum. In some embodiments, cationic impurities comprise aluminum.

In some embodiments, the concentration of copper (e.g., concentration of copper in the lithium ion exchange eluate solution) is greater than about 0.1 milligrams per liter and less than about 750 milligrams per liter. In some embodiments, the concentration of copper is greater than about 1 milligrams per liter and less than about 50 milligrams per liter. In some embodiments, the concentration of copper is greater than about 50 milligrams per liter and less than about 100 milligrams per liter. In some embodiments, the concentration of copper is greater than about 100 milligrams per liter and less than about 200 milligrams per liter. In some embodiments, the concentration of copper is greater than about 200 milligrams per liter and less than about 300 milligrams per liter. In some embodiments, the concentration of copper is greater than about 300 milligrams per liter and less than about 400 milligrams per liter. In some embodiments, the concentration of copper is greater than about 400.0 milligrams per liter and less than about 500.0 milligrams per liter. In some embodiments, the concentration of copper is greater than about 500.0 milligrams per liter and less than about 600.0 milligrams per liter. In some embodiments, the concentration of copper is greater than about 600.0 milligrams per liter and less than about 700.0 milligrams per liter. In some embodiments, the concentration of copper is greater than about 700.0 milligrams per liter and less than about 800.0 milligrams per liter. In some embodiments, one or more cationic metals comprise copper. In some embodiments, cationic impurities comprise copper. In some embodiments, one or more transition metals comprise copper.

In some embodiments, the concentration of iron (e.g., concentration of iron in the lithium ion exchange eluate solution) is greater than about 0.1 milligrams per liter and less than about 750 milligrams per liter. In some embodiments, the concentration of iron is greater than about 1 milligrams per liter and less than about 50 milligrams per liter. In some embodiments, the concentration of iron is greater than about 50 milligrams per liter and less than about 100 milligrams per liter. In some embodiments, the concentration of iron is greater than about 100 milligrams per liter and less than about 200 milligrams per liter. In some embodiments, the concentration of iron is greater than about 200 milligrams per liter and less than about 300 milligrams per liter. In some embodiments, the concentration of iron is greater than about 300 milligrams per liter and less than about 400 milligrams per liter. In some embodiments, the concentration of iron is greater than about 400.0 milligrams per liter and less than about 500.0 milligrams per liter. In some embodiments, the concentration of iron is greater than about 500.0 milligrams per liter and less than about 600.0 milligrams per liter. In some embodiments, the concentration of iron is greater than about 600.0 milligrams per liter and less than about 700.0 milligrams per liter. In some embodiments, the concentration of iron is greater than about 700.0 milligrams per liter and less than about 800.0 milligrams per liter. In some embodiments, one or more cationic metals comprise iron. In some embodiments, cationic impurities comprise iron. In some embodiments, one or more transition metals comprise iron.

In some embodiments, the concentration of manganese (e.g., concentration of manganese in the lithium ion exchange eluate solution) is greater than about 0.1 milligrams per liter and less than about 750 milligrams per liter. In some embodiments, the concentration of manganese is greater than about 1 milligrams per liter and less than about 50 milligrams per liter. In some embodiments, the concentration of manganese is greater than about 50 milligrams per liter and less than about 100 milligrams per liter. In some embodiments, the concentration of manganese is greater than about 100 milligrams per liter and less than about 200 milligrams per liter. In some embodiments, the concentration of manganese is greater than about 200 milligrams per liter and less than about 300 milligrams per liter. In some embodiments, the concentration of manganese is greater than about 300 milligrams per liter and less than about 400 milligrams per liter. In some embodiments, the concentration of manganese is greater than about 400.0 milligrams per liter and less than about 500.0 milligrams per liter. In some embodiments, the concentration of manganese is greater than about 500.0 milligrams per liter and less than about 600.0 milligrams per liter. In some embodiments, the concentration of manganese is greater than about 600.0 milligrams per liter and less than about 700.0 milligrams per liter. In some embodiments, the concentration of manganese is greater than about 700.0 milligrams per liter and less than about 800.0 milligrams per liter. In some embodiments, one or more cationic metals comprise manganese. In some embodiments, cationic impurities comprise manganese. In some embodiments, one or more transition metals comprise manganese.

In some embodiments, the concentration of molybdenum (e.g., concentration of molybdenum in the lithium ion exchange eluate solution) is greater than about 0.1 milligrams per liter and less than about 750 milligrams per liter. In some embodiments, the concentration of molybdenum is greater than about 1 milligrams per liter and less than about 50 milligrams per liter. In some embodiments, the concentration of molybdenum is greater than about 50 milligrams per liter and less than about 100 milligrams per liter. In some embodiments, the concentration of molybdenum is greater than about 100 milligrams per liter and less than about 200 milligrams per liter. In some embodiments, the concentration of molybdenum is greater than about 200 milligrams per liter and less than about 300 milligrams per liter. In some embodiments, the concentration of molybdenum is greater than about 300 milligrams per liter and less than about 400 milligrams per liter. In some embodiments, the concentration of molybdenum is greater than about 400.0 milligrams per liter and less than about 500.0 milligrams per liter. In some embodiments, the concentration of molybdenum is greater than about 500.0 milligrams per liter and less than about 600.0 milligrams per liter. In some embodiments, the concentration of molybdenum is greater than about 600.0 milligrams per liter and less than about 700.0 milligrams per liter. In some embodiments, the concentration of molybdenum is greater than about 700.0 milligrams per liter and less than about 800.0 milligrams per liter. In some embodiments, one or more cationic metals comprise molybdenum. In some embodiments, cationic impurities comprise molybdenum. In some embodiments, one or more transition metals comprise molybdenum.

In some embodiments, the concentration of niobium (e.g., concentration of niobium in the lithium ion exchange eluate solution) is greater than about 0.1 milligrams per liter and less than about 750 milligrams per liter. In some embodiments, the concentration of niobium is greater than about 1 milligrams per liter and less than about 50 milligrams per liter. In some embodiments, the concentration of niobium is greater than about 50 milligrams per liter and less than about 100 milligrams per liter. In some embodiments, the concentration of niobium is greater than about 100 milligrams per liter and less than about 200 milligrams per liter. In some embodiments, the concentration of niobium is greater than about 200 milligrams per liter and less than about 300 milligrams per liter. In some embodiments, the concentration of niobium is greater than about 300 milligrams per liter and less than about 400 milligrams per liter. In some embodiments, the concentration of niobium is greater than about 400.0 milligrams per liter and less than about 500.0 milligrams per liter. In some embodiments, the concentration of niobium is greater than about 500.0 milligrams per liter and less than about 600.0 milligrams per liter. In some embodiments, the concentration of niobium is greater than about 600.0 milligrams per liter and less than about 700.0 milligrams per liter. In some embodiments, the concentration of niobium is greater than about 700.0 milligrams per liter and less than about 800.0 milligrams per liter. In some embodiments, one or more cationic metals comprise niobium. In some embodiments, cationic impurities comprise niobium. In some embodiments, one or more transition metals comprise niobium.

In some embodiments, the concentration of titanium (e.g., concentration of titanium in the lithium ion exchange eluate solution) is greater than about 0.1 milligrams per liter and less than about 750 milligrams per liter. In some embodiments, the concentration of titanium is greater than about 1 milligrams per liter and less than about 50 milligrams per liter. In some embodiments, the concentration of titanium is greater than about 50 milligrams per liter and less than about 100 milligrams per liter. In some embodiments, the concentration of titanium is greater than about 100 milligrams per liter and less than about 200 milligrams per liter. In some embodiments, the concentration of titanium is greater than about 200 milligrams per liter and less than about 300 milligrams per liter. In some embodiments, the concentration of titanium is greater than about 300 milligrams per liter and less than about 400 milligrams per liter. In some embodiments, the concentration of titanium is greater than about 400.0 milligrams per liter and less than about 500.0 milligrams per liter. In some embodiments, the concentration of titanium is greater than about 500.0 milligrams per liter and less than about 600.0 milligrams per liter. In some embodiments, the concentration of titanium is greater than about 600.0 milligrams per liter and less than about 700.0 milligrams per liter. In some embodiments, the concentration of titanium is greater than about 700.0 milligrams per liter and less than about 800.0 milligrams per liter. In some embodiments, one or more cationic metals comprise titanium. In some embodiments, cationic impurities comprise titanium. In some embodiments, one or more transition metals comprise titanium.

In some embodiments, the concentration of vanadium (e.g., concentration of vanadium in the lithium ion exchange eluate solution) is greater than about 0.1 milligrams per liter and less than about 750 milligrams per liter. In some embodiments, the concentration of vanadium is greater than about 1 milligrams per liter and less than about 50 milligrams per liter. In some embodiments, the concentration of vanadium is greater than about 50 milligrams per liter and less than about 100 milligrams per liter. In some embodiments, the concentration of vanadium is greater than about 100 milligrams per liter and less than about 200 milligrams per liter. In some embodiments, the concentration of vanadium is greater than about 200 milligrams per liter and less than about 300 milligrams per liter. In some embodiments, the concentration of vanadium is greater than about 300 milligrams per liter and less than about 400 milligrams per liter. In some embodiments, the concentration of vanadium is greater than about 400.0 milligrams per liter and less than about 500.0 milligrams per liter. In some embodiments, the concentration of vanadium is greater than about 500.0 milligrams per liter and less than about 600.0 milligrams per liter. In some embodiments, the concentration of vanadium is greater than about 600.0 milligrams per liter and less than about 700.0 milligrams per liter. In some embodiments, the concentration of vanadium is greater than about 700.0 milligrams per liter and less than about 800.0 milligrams per liter. In some embodiments, one or more cationic metals comprise vanadium. In some embodiments, cationic impurities comprise vanadium. In some embodiments, one or more transition metals comprise vanadium.

In some embodiments, the concentration of zirconium (e.g., concentration of zirconium in the lithium ion exchange eluate solution) is greater than about 0.1 milligrams per liter and less than about 750 milligrams per liter. In some embodiments, the concentration of zirconium is greater than about 1 milligrams per liter and less than about 50 milligrams per liter. In some embodiments, the concentration of zirconium is greater than about 50 milligrams per liter and less than about 100 milligrams per liter. In some embodiments, the concentration of zirconium is greater than about 100 milligrams per liter and less than about 200 milligrams per liter. In some embodiments, the concentration of zirconium is greater than about 200 milligrams per liter and less than about 300 milligrams per liter. In some embodiments, the concentration of zirconium is greater than about 300 milligrams per liter and less than about 400 milligrams per liter. In some embodiments, the concentration of zirconium is greater than about 400.0 milligrams per liter and less than about 500.0 milligrams per liter. In some embodiments, the concentration of zirconium is greater than about 500.0 milligrams per liter and less than about 600.0 milligrams per liter. In some embodiments, the concentration of zirconium is greater than about 600.0 milligrams per liter and less than about 700.0 milligrams per liter. In some embodiments, the concentration of zirconium is greater than about 700.0 milligrams per liter and less than about 800.0 milligrams per liter. In some embodiments, one or more cationic metals comprise zirconium. In some embodiments, cationic impurities comprise zirconium. In some embodiments, one or more transition metals comprise zirconium.

In some embodiments, of a lithium ion exchange eluate solution, the solution comprises one or more transition metals (e.g., a transition metal). In some embodiments, the concentration of said one or more transition metals is greater than 0.01 milligrams per liter and less than about 1000 milligrams per liter. In some embodiments, the concentration of one or more transition metals is greater than about 0.1 milligrams per liter and less than about 750 milligrams per liter.

In some embodiments, the concentration of said one or more transition metals is greater than about 1 milligram per liter and less than about 50 milligrams per liter. In some embodiments, the concentration of said one or more transition metals is greater than about 50 milligrams per liter and less than about 100 milligrams per liter. In some embodiments, the concentration of said one or more transition metals is greater than about 100 milligrams per liter and less than about 200 milligrams per liter. In some embodiments, the concentration of said one or more transition metals is greater than about 200 milligrams per liter and less than about 300 milligrams per liter. In some embodiments, the concentration of said one or more transition metals is greater than about 300 milligrams per liter and less than about 400 milligrams per liter. In some embodiments, the concentration of said one or more transition metals is greater than about 400 milligrams per liter and less than about 500 milligrams per liter. In some embodiments, the concentration of said one or more transition metals is greater than about 500 milligrams per liter and less than about 600 milligrams per liter. In some embodiments, the concentration of said one or more transition metals is greater than about 600 milligrams per liter and less than about 700 milligrams per liter. In some embodiments, the concentration of said one or more transition metals is greater than about 700 milligrams per liter and less than about 800 milligrams per liter. In some embodiments, the one or more transition metals comprises zirconium. In some embodiments, the one or more transition metals comprises titanium. In some embodiments, the one or more transition metals comprises vanadium. In some embodiments, the one or more transition metals comprises iron. In some embodiments, the one or more transition metals comprises copper. In some embodiments, the one or more transition metals comprises manganese. In some embodiments, the one or more transition metals comprises molybdenum. In some embodiments, the one or more transition metals comprises niobium. In some embodiments, the one or more transition metals comprises zirconium, titanium, vanadium, iron, copper, manganese, molybdenum, aluminum, or niobium, or combinations thereof.

In some embodiments, the molar ratio of lithium to the sum of all other dissolved cations (all other cations dissolved in the lithium ion exchange eluate solution that are not lithium and not hydrogen) is about 1000:1. In some embodiments, the molar ratio of lithium to the sum of all other dissolved cations is about 500:1. In some embodiments, the molar ratio of lithium to the sum of all other dissolved cations is about 100:1. In some embodiments, the molar ratio of lithium to the sum of all other dissolved cations is about 50:1. In some embodiments, the molar ratio of lithium to the sum of all other dissolved cations is about 10:1. In some embodiments, the molar ratio of lithium to the sum of all other dissolved cations is about 5:1. In some embodiments, the molar ratio of lithium to the sum of all other dissolved cations is about 2:1. In some embodiments, the molar ratio of lithium to the sum of all other dissolved cations is about 1:1.

In some embodiments, the concentration of bicarbonate (e.g., concentration of bicarbonate in the lithium ion exchange eluate solution) is greater than about 1000.0 milligrams per liter and less than about 30000 milligrams per liter. In some embodiments, the concentration of bicarbonate is greater than about 10 milligrams per liter and less than about 100 milligrams per liter. In some embodiments, the concentration of bicarbonate is greater than about 100 milligrams per liter and less than about 500 milligrams per liter. In some embodiments, the concentration of bicarbonate is greater than about 500 milligrams per liter and less than about 1000 milligrams per liter. In some embodiments, the concentration of bicarbonate is greater than about 1000 milligrams per liter and less than about 5000 milligrams per liter. In some embodiments, the concentration of bicarbonate is greater than about 5000 milligrams per liter and less than about 10000 milligrams per liter. In some embodiments, the concentration of bicarbonate is greater than about 10000.0 milligrams per liter and less than about 50000.0 milligrams per liter. In some embodiments, the concentration of bicarbonate is greater than about 50000.0 milligrams per liter and less than about 100000.0 milligrams per liter. In some embodiments, the concentration of bicarbonate is greater than about 100000.0 milligrams per liter and less than about 200000.0 milligrams per liter. In some embodiments, the concentration of bicarbonate is greater than about 200000.0 milligrams per liter and less than about 300000.0 milligrams per liter. In some embodiments, the concentration of bicarbonate is greater than about 300000.0 milligrams per liter and less than about 500000.0 milligrams per liter.

In some embodiments, the concentration of borate (e.g., concentration of borate in the lithium ion exchange eluate solution) is greater than about 1000.0 milligrams per liter and less than about 30000 milligrams per liter. In some embodiments, the concentration of borate is greater than about 10 milligrams per liter and less than about 100 milligrams per liter. In some embodiments, the concentration of borate is greater than about 100 milligrams per liter and less than about 500 milligrams per liter. In some embodiments, the concentration of borate is greater than about 500 milligrams per liter and less than about 1000 milligrams per liter. In some embodiments, the concentration of borate is greater than about 1000 milligrams per liter and less than about 5000 milligrams per liter. In some embodiments, the concentration of borate is greater than about 5000 milligrams per liter and less than about 10000 milligrams per liter. In some embodiments, the concentration of borate is greater than about 10000.0 milligrams per liter and less than about 50000.0 milligrams per liter. In some embodiments, the concentration of borate is greater than about 50000.0 milligrams per liter and less than about 100000.0 milligrams per liter. In some embodiments, the concentration of borate is greater than about 100000.0 milligrams per liter and less than about 200000.0 milligrams per liter. In some embodiments, the concentration of borate is greater than about 200000.0 milligrams per liter and less than about 300000.0 milligrams per liter. In some embodiments, the concentration of borate is greater than about 300000.0 milligrams per liter and less than about 500000.0 milligrams per liter.

In some embodiments, the concentration of bromide (e.g., concentration of bromide in the lithium ion exchange eluate solution) is greater than about 1000.0 milligrams per liter and less than about 30000 milligrams per liter. In some embodiments, the concentration of bromide is greater than about 10 milligrams per liter and less than about 100 milligrams per liter. In some embodiments, the concentration of bromide is greater than about 100 milligrams per liter and less than about 500 milligrams per liter. In some embodiments, the concentration of bromide is greater than about 500 milligrams per liter and less than about 1000 milligrams per liter. In some embodiments, the concentration of bromide is greater than about 1000 milligrams per liter and less than about 5000 milligrams per liter. In some embodiments, the concentration of bromide is greater than about 5000 milligrams per liter and less than about 10000 milligrams per liter. In some embodiments, the concentration of bromide is greater than about 10000.0 milligrams per liter and less than about 50000.0 milligrams per liter. In some embodiments, the concentration of bromide is greater than about 50000.0 milligrams per liter and less than about 100000.0 milligrams per liter. In some embodiments, the concentration of bromide is greater than about 100000.0 milligrams per liter and less than about 200000.0 milligrams per liter. In some embodiments, the concentration of bromide is greater than about 200000.0 milligrams per liter and less than about 300000.0 milligrams per liter. In some embodiments, the concentration of bromide is greater than about 300000.0 milligrams per liter and less than about 500000.0 milligrams per liter.

In some embodiments, the concentration of carbonate (e.g., concentration of carbonate in the lithium ion exchange eluate solution) is greater than about 1000.0 milligrams per liter and less than about 30000 milligrams per liter. In some embodiments, the concentration of carbonate is greater than about 10 milligrams per liter and less than about 100 milligrams per liter. In some embodiments, the concentration of carbonate is greater than about 100 milligrams per liter and less than about 500 milligrams per liter. In some embodiments, the concentration of carbonate is greater than about 500 milligrams per liter and less than about 1000 milligrams per liter. In some embodiments, the concentration of carbonate is greater than about 1000 milligrams per liter and less than about 5000 milligrams per liter. In some embodiments, the concentration of carbonate is greater than about 5000 milligrams per liter and less than about 10000 milligrams per liter. In some embodiments, the concentration of carbonate is greater than about 10000.0 milligrams per liter and less than about 50000.0 milligrams per liter. In some embodiments, the concentration of carbonate is greater than about 50000.0 milligrams per liter and less than about 100000.0 milligrams per liter. In some embodiments, the concentration of carbonate is greater than about 100000.0 milligrams per liter and less than about 200000.0 milligrams per liter. In some embodiments, the concentration of carbonate is greater than about 200000.0 milligrams per liter and less than about 300000.0 milligrams per liter. In some embodiments, the concentration of carbonate is greater than about 300000.0 milligrams per liter and less than about 500000.0 milligrams per liter.

In some embodiments, the concentration of chloride (e.g., concentration of chloride in the lithium ion exchange eluate solution) is greater than about 1000.0 milligrams per liter and less than about 30000 milligrams per liter. In some embodiments, the concentration of chloride is greater than about 10 milligrams per liter and less than about 100 milligrams per liter. In some embodiments, the concentration of chloride is greater than about 100 milligrams per liter and less than about 500 milligrams per liter. In some embodiments, the concentration of chloride is greater than about 500 milligrams per liter and less than about 1000 milligrams per liter. In some embodiments, the concentration of chloride is greater than about 1000 milligrams per liter and less than about 5000 milligrams per liter. In some embodiments, the concentration of chloride is greater than about 5000 milligrams per liter and less than about 10000 milligrams per liter. In some embodiments, the concentration of chloride is greater than about 10000.0 milligrams per liter and less than about 50000.0 milligrams per liter. In some embodiments, the concentration of chloride is greater than about 50000.0 milligrams per liter and less than about 100000.0 milligrams per liter. In some embodiments, the concentration of chloride is greater than about 100000.0 milligrams per liter and less than about 200000.0 milligrams per liter. In some embodiments, the concentration of chloride is greater than about 200000.0 milligrams per liter and less than about 300000.0 milligrams per liter. In some embodiments, the concentration of chloride is greater than about 300000.0 milligrams per liter and less than about 500000.0 milligrams per liter.

In some embodiments, the concentration of fluoride (e.g., concentration of fluoride in the lithium ion exchange eluate solution) is greater than about 1000.0 milligrams per liter and less than about 30000 milligrams per liter. In some embodiments, the concentration of fluoride is greater than about 10 milligrams per liter and less than about 100 milligrams per liter. In some embodiments, the concentration of fluoride is greater than about 100 milligrams per liter and less than about 500 milligrams per liter. In some embodiments, the concentration of fluoride is greater than about 500 milligrams per liter and less than about 1000 milligrams per liter. In some embodiments, the concentration of fluoride is greater than about 1000 milligrams per liter and less than about 5000 milligrams per liter. In some embodiments, the concentration of fluoride is greater than about 5000 milligrams per liter and less than about 10000 milligrams per liter. In some embodiments, the concentration of fluoride is greater than about 10000.0 milligrams per liter and less than about 50000.0 milligrams per liter. In some embodiments, the concentration of fluoride is greater than about 50000.0 milligrams per liter and less than about 100000.0 milligrams per liter. In some embodiments, the concentration of fluoride is greater than about 100000.0 milligrams per liter and less than about 200000.0 milligrams per liter. In some embodiments, the concentration of fluoride is greater than about 200000.0 milligrams per liter and less than about 300000.0 milligrams per liter. In some embodiments, the concentration of fluoride is greater than about 300000.0 milligrams per liter and less than about 500000.0 milligrams per liter.

In some embodiments, the concentration of hydrogencarbonate (e.g., concentration of hydrogencarbonate in the lithium ion exchange eluate solution) is greater than about 1000.0 milligrams per liter and less than about 30000 milligrams per liter. In some embodiments, the concentration of hydrogencarbonate is greater than about 10 milligrams per liter and less than about 100 milligrams per liter. In some embodiments, the concentration of hydrogencarbonate is greater than about 100 milligrams per liter and less than about 500 milligrams per liter. In some embodiments, the concentration of hydrogencarbonate is greater than about 500 milligrams per liter and less than about 1000 milligrams per liter. In some embodiments, the concentration of hydrogencarbonate is greater than about 1000 milligrams per liter and less than about 5000 milligrams per liter. In some embodiments, the concentration of hydrogencarbonate is greater than about 5000 milligrams per liter and less than about 10000 milligrams per liter. In some embodiments, the concentration of hydrogencarbonate is greater than about 10000.0 milligrams per liter and less than about 50000.0 milligrams per liter. In some embodiments, the concentration of hydrogencarbonate is greater than about 50000.0 milligrams per liter and less than about 100000.0 milligrams per liter. In some embodiments, the concentration of hydrogencarbonate is greater than about 100000.0 milligrams per liter and less than about 200000.0 milligrams per liter. In some embodiments, the concentration of hydrogencarbonate is greater than about 200000.0 milligrams per liter and less than about 300000.0 milligrams per liter. In some embodiments, the concentration of hydrogencarbonate is greater than about 300000.0 milligrams per liter and less than about 500000.0 milligrams per liter.

In some embodiments, the concentration of nitrate (e.g., concentration of nitrate in the lithium ion exchange eluate solution) is greater than about 1000.0 milligrams per liter and less than about 30000 milligrams per liter. In some embodiments, the concentration of nitrate is greater than about 10 milligrams per liter and less than about 100 milligrams per liter. In some embodiments, the concentration of nitrate is greater than about 100 milligrams per liter and less than about 500 milligrams per liter. In some embodiments, the concentration of nitrate is greater than about 500 milligrams per liter and less than about 1000 milligrams per liter. In some embodiments, the concentration of nitrate is greater than about 1000 milligrams per liter and less than about 5000 milligrams per liter. In some embodiments, the concentration of nitrate is greater than about 5000 milligrams per liter and less than about 10000 milligrams per liter. In some embodiments, the concentration of nitrate is greater than about 10000.0 milligrams per liter and less than about 50000.0 milligrams per liter. In some embodiments, the concentration of nitrate is greater than about 50000.0 milligrams per liter and less than about 100000.0 milligrams per liter. In some embodiments, the concentration of nitrate is greater than about 100000.0 milligrams per liter and less than about 200000.0 milligrams per liter. In some embodiments, the concentration of nitrate is greater than about 200000.0 milligrams per liter and less than about 300000.0 milligrams per liter. In some embodiments, the concentration of nitrate is greater than about 300000.0 milligrams per liter and less than about 500000.0 milligrams per liter.

In some embodiments, the concentration of phosphate (e.g., concentration of phosphate in the lithium ion exchange eluate solution) is greater than about 1000.0 milligrams per liter and less than about 30000 milligrams per liter. In some embodiments, the concentration of phosphate is greater than about 10 milligrams per liter and less than about 100 milligrams per liter. In some embodiments, the concentration of phosphate is greater than about 100 milligrams per liter and less than about 500 milligrams per liter. In some embodiments, the concentration of phosphate is greater than about 500 milligrams per liter and less than about 1000 milligrams per liter. In some embodiments, the concentration of phosphate is greater than about 1000 milligrams per liter and less than about 5000 milligrams per liter. In some embodiments, the concentration of phosphate is greater than about 5000 milligrams per liter and less than about 10000 milligrams per liter. In some embodiments, the concentration of phosphate is greater than about 10000.0 milligrams per liter and less than about 50000.0 milligrams per liter. In some embodiments, the concentration of phosphate is greater than about 50000.0 milligrams per liter and less than about 100000.0 milligrams per liter. In some embodiments, the concentration of phosphate is greater than about 100000.0 milligrams per liter and less than about 200000.0 milligrams per liter. In some embodiments, the concentration of phosphate is greater than about 200000.0 milligrams per liter and less than about 300000.0 milligrams per liter. In some embodiments, the concentration of phosphate is greater than about 300000.0 milligrams per liter and less than about 500000.0

In some embodiments, the concentration of sulfate (e.g., concentration of sulfate in the lithium ion exchange eluate solution) is greater than about 1000.0 milligrams per liter and less than about 30000 milligrams per liter. In some embodiments, the concentration of sulfate is greater than about 10 milligrams per liter and less than about 100 milligrams per liter. In some embodiments, the concentration of sulfate is greater than about 100 milligrams per liter and less than about 500 milligrams per liter. In some embodiments, the concentration of sulfate is greater than about 500 milligrams per liter and less than about 1000 milligrams per liter. In some embodiments, the concentration of sulfate is greater than about 1000 milligrams per liter and less than about 5000 milligrams per liter. In some embodiments, the concentration of sulfate is greater than about 5000 milligrams per liter and less than about 10000 milligrams per liter. In some embodiments, the concentration of sulfate is greater than about 10000.0 milligrams per liter and less than about 50000.0 milligrams per liter. In some embodiments, the concentration of sulfate is greater than about 50000.0 milligrams per liter and less than about 100000.0 milligrams per liter. In some embodiments, the concentration of sulfate is greater than about 100000.0 milligrams per liter and less than about 200000.0 milligrams per liter. In some embodiments, the concentration of sulfate is greater than about 200000.0 milligrams per liter and less than about 300000.0 milligrams per liter. In some embodiments, the concentration of sulfate is greater than about 300000.0 milligrams per liter and less than about 500000.0 milligrams per liter.

In some embodiments, the value of pH (e.g., the pH of the lithium ion exchange eluate solution) is greater than about 1.0 and less than about 4.0. In some embodiments, the value of pH is greater than about 0.0 and less than about 1.0. In some embodiments, the value of pH is greater than about 1.0 and less than about 2.0. In some embodiments, the value of pH is greater than about 2.0 and less than about 3.0. In some embodiments, the value of pH is greater than about 3.0 and less than about 4.0. In some embodiments, the value of pH is greater than about 4.0 and less than about 5.0. In some embodiments, the value of pH is greater than about 5.0 and less than about 6.0. In some embodiments, the value of pH is greater than about 6.0 and less than about 7.0. In some embodiments, the value of pH is greater than about 7.0 and less than about 8.0. In some embodiments, the value of pH is greater than about 8.0 and less than about 9.0. In some embodiments, the value of pH is greater than about 9.0 and less than about 10.0. In some embodiments, the value of pH is greater than about 10.0 and less than about 11.0. In some embodiments, the value of pH is greater than about 11.0 and less than about 12.0.

In some embodiments, the value of oxidation-reduction potential (e.g., the oxidation-reduction potential of the lithium ion exchange eluate solution versus standard hydrogen electrode) is greater than about 50.0 m V and less than about 800.0 mV. In some embodiments, the value of oxidation-reduction potential is greater than about 100.0 mV and less than about 500.0 mV. In some embodiments, the value of oxidation-reduction potential is greater than about 200.0 m V and less than about 400.0 mV. In some embodiments, the value of oxidation-reduction potential is greater than about-450.0 mV and less than about 0.0 m V. In some embodiments, the value of oxidation-reduction potential is greater than about-200.0 m V and less than about 50.0 mV. In some embodiments, the value of oxidation-reduction potential is greater than about-50.0 mV and less than about 100.0 mV. In some embodiments, the value of oxidation-reduction potential is greater than about 50.0 m V and less than about 300.0 m V. In some embodiments, the value of oxidation-reduction potential is greater than about 100.0 mV and less than about 400.0 mV. In some embodiments, the value of oxidation-reduction potential is greater than about 200.0 mV and less than about 600.0 mV. In some embodiments, the value of oxidation-reduction potential is greater than about 300.0 mV and less than about 800.0 mV. In some embodiments, the value of oxidation-reduction potential is greater than about 500.0 m V and less than about 1000.0 mV. In some embodiments, the value of oxidation-reduction potential is greater than about 750.0 mV and less than about 1100.0 mV.

### SOME EMBODIMENTS OF THE DISCLOSURE

Below are provided some non-limiting embodiments of the present disclosure.

Embodiment 1. A lithium ion exchange eluate solution comprising:
a. water;
b. lithium, wherein the concentration of lithium is greater than about 100 milligrams per liter and less than about 20,000 milligrams per liter;
c. sodium, wherein the concentration of sodium is greater than about 10 milligrams per liter and less than about 10,000 milligrams per liter;
d. calcium, wherein the concentration of calcium is greater than about 1 milligram per liter and less than about 10,000 milligrams per liter;
e. magnesium, wherein the concentration of magnesium is greater than about 10 milligrams per liter and less than about 10,000 milligrams per liter;
f. potassium, wherein the concentration of potassium is greater than about 10 milligrams per liter and less than about 10,000 milligrams per liter.

Embodiment 2. The solution of Embodiment 1, wherein the molar ratio of lithium to the sum of all other dissolved cations is greater than 2:1.

Embodiment 3. The solution of Embodiment 1, wherein the molar ratio of lithium to the sum of all other dissolved cations is greater than 5:1.

Embodiment 4. The solution of Embodiment 1, wherein the molar ratio of lithium to the sum of all other dissolved cations is greater than 10:1.

Embodiment 5. The solution of Embodiment 1, wherein the molar ratio of lithium to the sum of all other dissolved cations is greater than 20:1.

Embodiment 6. The solution of Embodiment 1, wherein the molar ratio of lithium to the sum of all other dissolved cations is greater than 50:1.

Embodiment 7. The solution of any one of Embodiments 1 to 6, wherein the concentration of lithium is greater than about 200 milligrams per liter and less than about 8000 milligrams per liter.

Embodiment 8. The solution of any one of Embodiments 1 to 6, wherein the concentration of lithium is greater than about 200 milligrams per liter and less than about 4000 milligrams per liter.

Embodiment 9. The solution of any one of Embodiments 1 to 6, wherein the concentration of lithium is greater than about 2000 milligrams per liter and less than about 8000 milligrams per liter.

Embodiment 10. The solution of any one of Embodiments 1 to 6, wherein the concentration of lithium is greater than about 200 milligrams per liter and less than about 1000 milligrams per liter.

Embodiment 11. The solution of any one of Embodiments 1 to 6, wherein the concentration of lithium is greater than about 200 milligrams per liter and less than about 500 milligrams per liter.

Embodiment 12. The solution of any one of Embodiments 1 to 6, wherein the concentration of lithium is greater than about 1000 milligrams per liter and less than about 4000 milligrams per liter.

Embodiment 13. The solution of any one of Embodiments 1 to 6, wherein the concentration of lithium is greater than about 1000 milligrams per liter and less than about 2000 milligrams per liter.

Embodiment 14. The solution of any one of Embodiments 1 to 6, wherein the concentration of lithium is greater than about 2000 milligrams per liter and less than about 3000 milligrams per liter.

Embodiment 15. The solution of any one of Embodiments 1 to 6, wherein the concentration of lithium is greater than about 3000 milligrams per liter and less than about 4000 milligrams per liter.

Embodiment 16. The solution of any one of Embodiments 1 to 6, wherein the concentration of lithium is greater than about 4000 milligrams per liter and less than about 5000 milligrams per liter.

Embodiment 17. The solution of any one of Embodiments 1 to 6, wherein the concentration of lithium is greater than about 5000 milligrams per liter and less than about 6000 milligrams per liter.

Embodiment 18. The solution of any one of Embodiments 1 to 6, wherein the concentration of lithium is greater than about 6000 milligrams per liter and less than about 8000 milligrams per liter.

Embodiment 19. The solution of any one of Embodiments 1 to 18, wherein the concentration of sodium is greater than about 10 milligrams per liter and less than about 5000 milligrams per liter.

Embodiment 20. The solution of any one of Embodiments 1 to 18, wherein the concentration of sodium is greater than about 20 milligrams per liter and less than about 1000 milligrams per liter.

Embodiment 21. The solution of any one of Embodiments 1 to 18, wherein the concentration of sodium is greater than about 1000 milligrams per liter and less than about 2000 milligrams per liter.

Embodiment 22. The solution of any one of Embodiments 1 to 18, wherein the concentration of sodium is greater than about 2000 milligrams per liter and less than about 3000 milligrams per liter.

Embodiment 23. The solution of any one of Embodiments 1 to 18, wherein the concentration of sodium is greater than about 3000 milligrams per liter and less than about 4000 milligrams per liter.

Embodiment 24. The solution of any one of Embodiments 1 to 18, wherein the concentration of sodium is greater than about 4000 milligrams per liter and less than about 6000 milligrams per liter.

Embodiment 25. The solution of any one of Embodiments 1 to 18, wherein the concentration of sodium is greater than about 10 milligrams per liter and less than about 500 milligrams per liter.

Embodiment 26. The solution of any one of Embodiments 1 to 18, wherein the concentration of sodium is greater than about 500 milligrams per liter and less than about 1000

Embodiment 27. The solution of any one of Embodiments 1 to 18, wherein the concentration of sodium is greater than about 6000 milligrams per liter and less than about 10000 milligrams per liter.

Embodiment 28. The solution of any one of Embodiments 1 to 18, wherein the concentration of sodium is greater than about 10 milligrams per liter and less than about 2,000 milligrams per liter.

Embodiment 29. The solution of any one of Embodiments 1 to 18, wherein the concentration of sodium is greater than about 10 milligrams per liter and less than about 1,500 milligrams per liter.

Embodiment 30. The solution of any one of Embodiments 1 to 18, wherein the concentration of sodium is greater than about 10 milligrams per liter and less than about 1,000 milligrams per liter.

Embodiment 31. The solution of any one of Embodiments 1 to 18, wherein the concentration of sodium is greater than about 10 milligrams per liter and less than about 100 milligrams per liter.

Embodiment 32. The solution of any one of Embodiments 1 to 18, wherein the concentration of sodium is greater than about 500 milligrams per liter and less than about 1,500 milligrams per liter.

Embodiment 33. The solution of any one of Embodiments 1 to 18, wherein the concentration of sodium is greater than about 50 milligrams per liter and less than about 150 milligrams per liter.

Embodiment 34. The solution of any one of Embodiments 1 to 33, wherein the concentration of calcium is greater than about 10 milligrams per liter and less than about 5000 milligrams per liter.

Embodiment 35. The solution of any one of Embodiments 1 to 33, wherein the concentration of calcium is greater than about 20 milligrams per liter and less than about 1000 milligrams per liter.

Embodiment 36. The solution of any one of Embodiments 1 to 33, wherein the concentration of calcium is greater than about 1000 milligrams per liter and less than about 2000 milligrams per liter.

Embodiment 37. The solution of any one of Embodiments 1 to 33, wherein the concentration of calcium is greater than about 2000 milligrams per liter and less than about 3000

Embodiment 38. The solution of any one of Embodiments 1 to 33, wherein the concentration of calcium is greater than about 3000 milligrams per liter and less than about 4000 milligrams per liter.

Embodiment 39. The solution of any one of Embodiments 1 to 33, wherein the concentration of calcium is greater than about 4000 milligrams per liter and less than about 6000 milligrams per liter.

Embodiment 40. The solution of any one of Embodiments 1 to 33, wherein the concentration of calcium is greater than about 10 milligrams per liter and less than about 500 milligrams per liter.

Embodiment 41. The solution of any one of Embodiments 1 to 33, wherein the concentration of calcium is greater than about 500 milligrams per liter and less than about 1000 milligrams per liter.

Embodiment 42. The solution of any one of Embodiments 1 to 33, wherein the concentration of calcium is greater than about 6000 milligrams per liter and less than about 10000 milligrams per liter.

Embodiment 43. The solution of any one of Embodiments 1 to 33, wherein the concentration of calcium is greater than about 10 milligrams per liter and less than about 2,000 milligrams per liter.

Embodiment 44. The solution of any one of Embodiments 1 to 33, wherein the concentration of calcium is greater than about 10 milligrams per liter and less than about 1,500 milligrams per liter.

Embodiment 45. The solution of any one of Embodiments 1 to 33, wherein the concentration of calcium is greater than about 10 milligrams per liter and less than about 1,000 milligrams per liter.

Embodiment 46. The solution of any one of Embodiments 1 to 33, wherein the concentration of calcium is greater than about 10 milligrams per liter and less than about 300 milligrams per liter.

Embodiment 47. The solution of any one of Embodiments 1 to 33, wherein the concentration of calcium is greater than about 500 milligrams per liter and less than about 1,500 milligrams per liter.

Embodiment 48. The solution of any one of Embodiments 1 to 33, wherein the concentration of calcium is greater than about 700 milligrams per liter and less than about 1,200

Embodiment 49. The solution of any one of Embodiments 1 to 48, wherein the concentration of magnesium is greater than about 1 milligram per liter and less than about 5000 milligrams per liter.

Embodiment 50. The solution of any one of Embodiments 1 to 48, wherein the concentration of magnesium is greater than about 2 milligrams per liter and less than about 1000 milligrams per liter.

Embodiment 51. The solution of any one of Embodiments 1 to 48, wherein the concentration of magnesium is greater than about 1000 milligrams per liter and less than about 2000 milligrams per liter.

Embodiment 52. The solution of any one of Embodiments 1 to 48, wherein the concentration of magnesium is greater than about 2000 milligrams per liter and less than about 3000 milligrams per liter.

Embodiment 53. The solution of any one of Embodiments 1 to 48, wherein the concentration of magnesium is greater than about 3000 milligrams per liter and less than about 4000 milligrams per liter.

Embodiment 54. The solution of any one of Embodiments 1 to 48, wherein the concentration of magnesium is greater than about 4000 milligrams per liter and less than about 6000 milligrams per liter.

Embodiment 55. The solution of any one of Embodiments 1 to 48, wherein the concentration of magnesium is greater than about 1 milligram per liter and less than about 500 milligrams per liter.

Embodiment 56. The solution of any one of Embodiments 1 to 48, wherein the concentration of magnesium is greater than about 500 milligrams per liter and less than about 1000 milligrams per liter.

Embodiment 57. The solution of any one of Embodiments 1 to 48, wherein the concentration of magnesium is greater than about 6000 milligrams per liter and less than about 10000 milligrams per liter.

Embodiment 58. The solution of any one of Embodiments 1 to 48, wherein the concentration of magnesium is greater than about 1 milligram per liter and less than about 500 milligrams per liter.

Embodiment 59. The solution of any one of Embodiments 1 to 48, wherein the concentration of magnesium is greater than about 1 milligram per liter and less than about 300

Embodiment 60. The solution of any one of Embodiments 1 to 48, wherein the concentration of magnesium is greater than about 1 milligram per liter and less than about 200 milligrams per liter.

Embodiment 61. The solution of any one of Embodiments 1 to 48, wherein the concentration of magnesium is greater than about 5 milligrams per liter and less than about 150 milligrams per liter.

Embodiment 62. The solution of any one of Embodiments 1 to 61, wherein the concentration of potassium is greater than about 10 milligrams per liter and less than about 5000 milligrams per liter.

Embodiment 63. The solution of any one of Embodiments 1 to 61, wherein the concentration of potassium is greater than about 20 milligrams per liter and less than about 1000 milligrams per liter.

Embodiment 64. The solution of any one of Embodiments 1 to 61, wherein the concentration of potassium is greater than about 1000 milligrams per liter and less than about 2000 milligrams per liter.

Embodiment 65. The solution of any one of Embodiments 1 to 61, wherein the concentration of potassium is greater than about 2000 milligrams per liter and less than about 3000 milligrams per liter.

Embodiment 66. The solution of any one of Embodiments 1 to 61, wherein the concentration of potassium is greater than about 3000 milligrams per liter and less than about 4000 milligrams per liter.

Embodiment 67. The solution of any one of Embodiments 1 to 61, wherein the concentration of potassium is greater than about 4000 milligrams per liter and less than about 6000 milligrams per liter.

Embodiment 68. The solution of any one of Embodiments 1 to 61, wherein the concentration of potassium is greater than about 10 milligrams per liter and less than about 500 milligrams per liter.

Embodiment 69. The solution of any one of Embodiments 1 to 61, wherein the concentration of potassium is greater than about 500 milligrams per liter and less than about 1000 milligrams per liter.

Embodiment 70. The solution of any one of Embodiments 1 to 61, wherein the concentration of potassium is greater than about 6000 milligrams per liter and less than about 10000 milligrams per liter.

Embodiment 71. The solution of any one of Embodiments 1 to 61, wherein the concentration of potassium is greater than about 10 milligrams per liter and less than about 300 milligrams per liter.

Embodiment 72. The solution of any one of Embodiments 1 to 61, wherein the concentration of potassium is greater than about 10 milligrams per liter and less than about 200 milligrams per liter.

Embodiment 73. The solution of any one of Embodiments 1 to 61, wherein the concentration of potassium is greater than about 10 milligrams per liter and less than about 100 milligrams per liter.

Embodiment 74. The solution of any one of Embodiments 1 to 61, wherein the concentration of potassium is greater than about 20 milligrams per liter and less than about 80 milligrams per liter.

Embodiment 75. The solution of any one of Embodiments 1 to 74, wherein the solution further comprises boron, wherein the concentration of boron is greater than about 0.01 milligrams per liter and less than about 10,000 milligrams per liter.

Embodiment 76. The solution of Embodiment 75, wherein the concentration of boron is greater than about 10 milligrams per liter and less than about 5000 milligrams per liter.

Embodiment 77. The solution of Embodiment 75, wherein the concentration of boron is greater than about 20 milligrams per liter and less than about 1000 milligrams per liter.

Embodiment 78. The solution of Embodiment 75, wherein the concentration of boron is greater than about 1000 milligrams per liter and less than about 2000 milligrams per liter.

Embodiment 79. The solution of Embodiment 75, wherein the concentration of boron is greater than about 10 milligrams per liter and less than about 500 milligrams per liter.

Embodiment 80. The solution of Embodiment 75, wherein the concentration of boron is greater than about 500 milligrams per liter and less than about 1000 milligrams per liter.

Embodiment 81. The solution of Embodiment 75 wherein the concentration of boron is greater than about 0.01 milligrams per liter and less than about 1,000 milligrams per liter.

Embodiment 82. The solution of Embodiment 75, wherein the concentration of boron is greater than about 0.1 milligrams per liter and less than about 750 milligrams per liter.

Embodiment 83. The solution of Embodiment 75, wherein the concentration of boron is greater than about 1 milligrams per liter and less than about 50 milligrams per liter.

Embodiment 84. The solution of Embodiment 75, wherein the concentration of boron is greater than about 50 milligrams per liter and less than about 100 milligrams per liter.

Embodiment 85. The solution of any one of Embodiments 1 to 84, wherein the solution further comprises strontium, wherein the concentration of strontium is greater than about 10 milligrams per liter and less than about 10,000 milligrams per liter.

Embodiment 86. The solution of Embodiment 85, wherein the concentration of strontium is greater than about 10 milligrams per liter and less than about 5000 milligrams per liter.

Embodiment 87. The solution of Embodiment 85, wherein the concentration of strontium is greater than about 1 milligrams per liter and less than about 1000 milligrams per liter.

Embodiment 88. The solution of Embodiment 85, wherein the concentration of strontium is greater than about 1000 milligrams per liter and less than about 2000 milligrams per liter.

Embodiment 89. The solution of Embodiment 85, wherein the concentration of strontium is greater than about 2000 milligrams per liter and less than about 3000 milligrams per liter.

Embodiment 90. The solution of Embodiment 85, wherein the concentration of strontium is greater than about 10 milligrams per liter and less than about 500 milligrams per liter.

Embodiment 91. The solution of Embodiment 85, wherein the concentration of strontium is greater than about 500 milligrams per liter and less than about 1000 milligrams per liter.

Embodiment 92. The solution of Embodiment 85, wherein the concentration of strontium is greater than about 1 milligram per liter and less than about 50 milligrams per liter.

Embodiment 93. The solution of Embodiment 85, wherein the concentration of strontium is greater than about 1 milligram per liter and less than about 30 milligrams per liter.

Embodiment 94. The solution of Embodiment 85, wherein the concentration of strontium is greater than about 1 milligram per liter and less than about 25 milligrams per liter.

Embodiment 95. The solution of any one of Embodiments 1 to 94 wherein the solution further comprises aluminum, wherein the concentration of aluminum is greater than about 0.01 milligrams per liter and less than about 1,000 milligrams per liter.

Embodiment 96. The solution of Embodiment 95, wherein the concentration of aluminum is greater than about 0.1 milligrams per liter and less than about 750 milligrams per liter.

Embodiment 97. The solution of Embodiment 95, wherein the concentration of aluminum is greater than about 1 milligrams per liter and less than about 50 milligrams per liter.

Embodiment 98. The solution of Embodiment 95, wherein the concentration of aluminum is greater than about 50 milligrams per liter and less than about 100 milligrams per liter.

Embodiment 99. The solution of Embodiment 95, wherein the concentration of aluminum is greater than about 100 milligrams per liter and less than about 200 milligrams per liter.

Embodiment 100. The solution of Embodiment 95, wherein the concentration of aluminum is greater than about 200 milligrams per liter and less than about 300 milligrams per liter.

Embodiment 101. The solution of Embodiment 95, wherein the concentration of aluminum is greater than about 300 milligrams per liter and less than about 400 milligrams per liter.

Embodiment 102. The solution of Embodiment 95, wherein the concentration of aluminum is greater than about 400 milligrams per liter and less than about 500 milligrams per liter.

Embodiment 103. The solution of Embodiment 95, wherein the concentration of aluminum is greater than about 500 milligrams per liter and less than about 600 milligrams per liter.

Embodiment 104. The solution of Embodiment 95, wherein the concentration of aluminum is greater than about 600 milligrams per liter and less than about 700 milligrams per liter.

Embodiment 105. The solution of Embodiment 95, wherein the concentration of aluminum is greater than about 700 milligrams per liter and less than about 800 milligrams per liter.

Embodiment 106. The solution of any one of Embodiments 1 to 105, wherein the solution further comprises a transition metal, wherein the concentration of said transition metal is greater than 0.01 milligrams per liter and less than about 1000 milligrams per liter.

Embodiment 107. The solution of Embodiment 106, wherein the concentration of said transition metal is greater than about 0.1 milligrams per liter and less than about 750 milligrams per liter.

Embodiment 108. The solution of Embodiment 106, wherein the concentration of said transition metal is greater than about 1 milligram per liter and less than about 50 milligrams per liter.

Embodiment 109. The solution of Embodiment 106, wherein the concentration of said transition metal is greater than about 1 milligram per liter and less than about 25 milligrams per liter.

Embodiment 110. The solution of Embodiment 106, wherein the concentration of said transition metal is greater than about 50 milligrams per liter and less than about 100 milligrams per liter.

Embodiment 111. The solution of Embodiment 106, wherein the concentration of said transition metal is greater than about 100 milligrams per liter and less than about 200 milligrams per liter.

Embodiment 112. The solution of Embodiment 106, wherein the concentration of said transition metal is greater than about 200 milligrams per liter and less than about 300 milligrams per liter.

Embodiment 113. The solution of Embodiment 106, wherein the concentration of said transition metal is greater than about 300 milligrams per liter and less than about 400 milligrams per liter.

Embodiment 114. The solution of Embodiment 106, wherein the concentration of said transition metal is greater than about 400 milligrams per liter and less than about 500 milligrams per liter.

Embodiment 115. The solution of Embodiment 106, wherein the concentration of said transition metal is greater than about 600 milligrams per liter and less than about 700 milligrams per liter.

Embodiment 116. The solution of Embodiment 106, wherein the concentration of said transition metal is greater than about 700 milligrams per liter and less than about 800 milligrams per liter.

Embodiment 117. The solution of any one of Embodiments 106 to 116, wherein the transition metal comprises zirconium.

Embodiment 118. The solution of any one of Embodiments 106 to 117, wherein the transition metal comprises titanium.

Embodiment 119. The solution of any one of Embodiments 106 to 118, wherein the transition metal comprises vanadium.

Embodiment 120. The solution of any one of Embodiments 106 to 119, wherein the transition metal comprises iron.

Embodiment 121. The solution of any one of Embodiments 106 to 120, wherein the transition metal comprises copper.

Embodiment 122. The solution of any one of Embodiments 106 to 121, wherein the transition metal comprises manganese.

Embodiment 123. The solution of any one of Embodiments 106 to 122, wherein the transition metal comprises molybdenum.

Embodiment 124. The solution of any one of Embodiments 106 to 123, wherein the transition metal comprises niobium.

Embodiment 125. The solution of any one of Embodiments 106 to 124, wherein the transition metal comprises zirconium, titanium, vanadium, iron, copper, manganese, molybdenum, aluminum, or niobium, or combinations thereof.

Embodiment 126. The solution of any one of Embodiments 1 to 125, wherein the pH of said solution of greater than about 0 and less than about 4.

Embodiment 127. The solution of any one of Embodiments 1 to 125, wherein the value of pH is greater than about 1 and less than about 4.

Embodiment 128. The solution of any one of Embodiments 1 to 125, wherein the value of pH is greater than about 0 and less than about 1.

Embodiment 129. The solution of any one of Embodiments 1 to 125, wherein the value of pH is greater than about 1 and less than about 2.

Embodiment 130. The solution of any one of Embodiments 1 to 125, wherein the value of pH is greater than about 2 and less than about 3.

Embodiment 131. The solution of any one of Embodiments 1 to 125, wherein the value of pH is greater than about 3 and less than about 4.

Embodiment 132. The solution of any one of Embodiments 1 to 125, wherein the value of pH is greater than about 4 and less than about 5.

Embodiment 133. The solution of any one of Embodiments 1 to 125, wherein the value of pH is greater than about 5 and less than about 7.

Embodiment 134. The solution of any one of Embodiments 1 to 125, wherein the value of pH is greater than about 7 and less than about 10.

Embodiment 135. The solution of any one of Embodiments 1 to 125, wherein the value of pH is greater than about 10 and less than about 13.

Embodiment 136. The solution of any one of Embodiments 1 to 135, wherein the value of oxidation reduction potential is greater than about 50 m V and less than about 150 m V.

Embodiment 137. The solution of any one of Embodiments 1 to 135, wherein the value of oxidation reduction potential is greater than about 150 mV and less than about 300 mV.

Embodiment 138. The solution of any one of Embodiments 1 to 135, wherein the value of oxidation reduction potential is greater than about 300 m V and less than about 500 m V.

Embodiment 139. The solution of any one of Embodiments 1 to 135, wherein the value of oxidation reduction potential is greater than about 500 m V and less than about 800 m V.

Embodiment 140. A process for generating the solution of any one of Embodiments 1 to 139, wherein said solution of produced by contacting an acidic solution with an ion exchange material.

Embodiment 141. The process of Embodiment 140, wherein the solution is produced by contacting an ion exchange material with a liquid resource and then contacting said ion exchange material with an acidic solution.

Embodiment 142. The process of Embodiment 141, wherein said liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

Embodiment 143. The process of Embodiments 140 or 142, wherein said acidic solution comprises hydrochloric acid, sulfuric acid, phosphoric acid, hydrobromic acid, chloric acid, perchloric acid, nitric acid, formic acid, citric acid, or acetic acid, or combinations thereof.

Embodiment 144. The process of Embodiment 143, wherein said acidic solution comprises acid at a concentration of from about 0.01 to about 0.1 mol per liter.

Embodiment 145. The process of Embodiment 143, wherein said acidic solution comprises acid at a concentration of from about 0.1 to about 0.25 mol per liter.

Embodiment 146. The process of Embodiment 143, wherein said acidic solution comprises acid at a concentration of from about 0.25 to about 0.5 mol per liter.

Embodiment 147. The solution of Embodiment 143, wherein said acidic solution comprises acid at a concentration of from about 0.4 to about 0.75 mol per liter.

Embodiment 148. The process of Embodiment 143, wherein said acidic solution comprises acid at a concentration of from about 0.7 to about 1.0 mol per liter.

Embodiment 149. The process of Embodiment 143, wherein said acidic solution comprises acid at a concentration of from about 0.9 to about 1.5 mol per liter.

Embodiment 150. The process of Embodiment 143, wherein said acidic solution comprises acid at a concentration of from about 1.5 to about 2.5 mol per liter.

Embodiment 151. The process of Embodiment 143, wherein said acidic solution comprises acid at a concentration of from about 2.0 to about 5.0 mol per liter.

Embodiment 152. The process of Embodiment 143, wherein said acidic solution comprises acid at a concentration of from about 5.0 to about 10.0 mol per liter.

Embodiment 153. The process of any one of Embodiments 1 to 152, wherein the acidic solution further comprising chloride, sulfate, phosphate, bromide, chlorate, perchlorate, nitrate, formate, citrate, acetate, or combinations thereof.

Embodiment 154. A lithium ion exchange eluate solution comprising:
a. water;
b. lithium, wherein the concentration of lithium is greater than about 100 milligrams per liter and less than about 20,000 milligrams per liter;
c. sodium, wherein the concentration of sodium is greater than about 10 milligrams per liter and less than about 10,000 milligrams per liter;
d. one or more cationic metal, wherein the concentration of the one or more cationic metal is greater than about 1 milligram per liter and less than about 10,000 milligrams per liter.

Embodiment 155. The solution of Embodiment 154, wherein the one or more metal comprises:
a. calcium, wherein the concentration of calcium is greater than about 10 milligrams per liter and less than about 10,000 milligrams per liter; and
b. a transition metal, wherein the concentration of said transition metal is greater than 0.01 milligrams per liter and less than about 1000 milligrams per liter.

Embodiment 156. The solution of Embodiment 154, wherein the one or more metal comprises:
a. magnesium, wherein the concentration of magnesium is greater than about 1 milligram per liter and less than about 10,000 milligrams per liter; and
b. a transition metal, wherein the concentration of said transition metal is greater than 0.01 milligrams per liter and less than about 1000 milligrams per liter.

Embodiment 157. The solution of Embodiment 154, wherein the one or more metal comprises:
a. calcium, wherein the concentration of calcium is greater than about 10 milligrams per liter and less than about 10,000 milligrams per liter;
b. magnesium, wherein the concentration of magnesium is greater than about 10 milligrams per liter and less than about 10,000 milligrams per liter; and
c. potassium, wherein the concentration of potassium is greater than about 10 milligrams per liter and less than about 10,000 milligrams per liter.

Embodiment 158. The solution of any one of Embodiments 154 to 157, wherein the molar ratio of lithium to the sum of all other dissolved cations is greater than 2:1.

Embodiment 159. The solution of any one of Embodiments 154 to 157, wherein the molar ratio of lithium to the sum of all other dissolved cations is greater than 5:1.

Embodiment 160. The solution of any one of Embodiments 154 to 157, wherein the molar ratio of lithium to the sum of all other dissolved cations is greater than 10:1.

Embodiment 161. The solution of any one of Embodiments 154 to 157, wherein the molar ratio of lithium to the sum of all other dissolved cations is greater than 20:1.

Embodiment 162. The solution of any one of Embodiments 154 to 157, wherein the molar ratio of lithium to the sum of all other dissolved cations is greater than 50:1.

Embodiment 163. The solution of any one of Embodiments 154 to 162, wherein the concentration of lithium is greater than about 200 milligrams per liter and less than about 8000 milligrams per liter.

Embodiment 164. The solution of any one of Embodiments 154 to 162, wherein the concentration of lithium is greater than about 200 milligrams per liter and less than about 4000

Embodiment 165. The solution of any one of Embodiments 154 to 162, wherein the concentration of lithium is greater than about 2000 milligrams per liter and less than about 8000 milligrams per liter.

Embodiment 166. The solution of any one of Embodiments 154 to 162, wherein the concentration of lithium is greater than about 200 milligrams per liter and less than about 1000 milligrams per liter.

Embodiment 167. The solution of any one of Embodiments 154 to 162, wherein the concentration of lithium is greater than about 200 milligrams per liter and less than about 500 milligrams per liter.

Embodiment 168. The solution of any one of Embodiments 154 to 162, wherein the concentration of lithium is greater than about 1000 milligrams per liter and less than about 4000 milligrams per liter.

Embodiment 169. The solution of any one of Embodiments 154 to 162, wherein the concentration of lithium is greater than about 1000 milligrams per liter and less than about 2000 milligrams per liter.

Embodiment 170. The solution of any one of Embodiments 154 to 162, wherein the concentration of lithium is greater than about 2000 milligrams per liter and less than about 3000 milligrams per liter.

Embodiment 171. The solution of any one of Embodiments 154 to 162, wherein the concentration of lithium is greater than about 3000 milligrams per liter and less than about 4000 milligrams per liter.

Embodiment 172. The solution of any one of Embodiments 154 to 162, wherein the concentration of lithium is greater than about 4000 milligrams per liter and less than about 5000 milligrams per liter.

Embodiment 173. The solution of any one of Embodiments 154 to 162, wherein the concentration of lithium is greater than about 5000 milligrams per liter and less than about 6000 milligrams per liter.

Embodiment 174. The solution of any one of Embodiments 154 to 162, wherein the concentration of lithium is greater than about 6000 milligrams per liter and less than about 8000 milligrams per liter.

Embodiment 175. The solution of any one of Embodiments 154 to 174, wherein the concentration of sodium is greater than about 10 milligrams per liter and less than about 5000

Embodiment 176. The solution of any one of Embodiments 154 to 174, wherein the concentration of sodium is greater than about 20 milligrams per liter and less than about 1000 milligrams per liter.

Embodiment 177. The solution of any one of Embodiments 154 to 174, wherein the concentration of sodium is greater than about 1000 milligrams per liter and less than about 2000 milligrams per liter.

Embodiment 178. The solution of any one of Embodiments 154 to 174, wherein the concentration of sodium is greater than about 2000 milligrams per liter and less than about 3000 milligrams per liter.

Embodiment 179. The solution of any one of Embodiments 154 to 174, wherein the concentration of sodium is greater than about 3000 milligrams per liter and less than about 4000 milligrams per liter.

Embodiment 180. The solution of any one of Embodiments 154 to 174, wherein the concentration of sodium is greater than about 4000 milligrams per liter and less than about 6000 milligrams per liter.

Embodiment 181. The solution of any one of Embodiments 154 to 174, wherein the concentration of sodium is greater than about 10 milligrams per liter and less than about 500 milligrams per liter.

Embodiment 182. The solution of any one of Embodiments 154 to 174, wherein the concentration of sodium is greater than about 500 milligrams per liter and less than about 1000 milligrams per liter.

Embodiment 183. The solution of any one of Embodiments 154 to 174, wherein the concentration of sodium is greater than about 6000 milligrams per liter and less than about 10000 milligrams per liter.

Embodiment 184. The solution of any one of Embodiments 154 to 174, wherein the concentration of sodium is greater than about 10 milligrams per liter and less than about 2,000 milligrams per liter.

Embodiment 185. The solution of any one of Embodiments 154 to 174, wherein the concentration of sodium is greater than about 10 milligrams per liter and less than about 1,500 milligrams per liter.

Embodiment 186. The solution of any one of Embodiments 154 to 174, wherein the concentration of sodium is greater than about 10 milligrams per liter and less than about 1,000

Embodiment 187. The solution of any one of Embodiments 154 to 174, wherein the concentration of sodium is greater than about 10 milligrams per liter and less than about 100 milligrams per liter.

Embodiment 188. The solution of any one of Embodiments 154 to 174, wherein the concentration of sodium is greater than about 500 milligrams per liter and less than about 1,500 milligrams per liter.

Embodiment 189. The solution of any one of Embodiments 154 to 174, wherein the concentration of sodium is greater than about 50 milligrams per liter and less than about 150 milligrams per liter.

Embodiment 190. The solution of any one of Embodiments 154 to 189, wherein the concentration of calcium is greater than about 10 milligrams per liter and less than about 5000 milligrams per liter.

Embodiment 191. The solution of any one of Embodiments 154 to 189, wherein the concentration of calcium is greater than about 20 milligrams per liter and less than about 1000 milligrams per liter.

Embodiment 192. The solution of any one of Embodiments 154 to 189, wherein the concentration of calcium is greater than about 1000 milligrams per liter and less than about 2000 milligrams per liter.

Embodiment 193. The solution of any one of Embodiments 154 to 189, wherein the concentration of calcium is greater than about 2000 milligrams per liter and less than about 3000 milligrams per liter.

Embodiment 194. The solution of any one of Embodiments 154 to 189, wherein the concentration of calcium is greater than about 3000 milligrams per liter and less than about 4000 milligrams per liter.

Embodiment 195. The solution of any one of Embodiments 154 to 189, wherein the concentration of calcium is greater than about 4000 milligrams per liter and less than about 6000 milligrams per liter.

Embodiment 196. The solution of any one of Embodiments 154 to 189, wherein the concentration of calcium is greater than about 10 milligrams per liter and less than about 500 milligrams per liter.

Embodiment 197. The solution of any one of Embodiments 154 to 189, wherein the concentration of calcium is greater than about 500 milligrams per liter and less than about 1000

Embodiment 198. The solution of any one of Embodiments 154 to 189, wherein the concentration of calcium is greater than about 6000 milligrams per liter and less than about 10000 milligrams per liter.

Embodiment 199. The solution of any one of Embodiments 154 to 189, wherein the concentration of calcium is greater than about 10 milligrams per liter and less than about 2,000 milligrams per liter.

Embodiment 200. The solution of any one of Embodiments 154 to 189, wherein the concentration of calcium is greater than about 10 milligrams per liter and less than about 1,500 milligrams per liter.

Embodiment 201. The solution of any one of Embodiments 154 to 189, wherein the concentration of calcium is greater than about 10 milligrams per liter and less than about 1,000 milligrams per liter.

Embodiment 202. The solution of any one of Embodiments 154 to 189, wherein the concentration of calcium is greater than about 10 milligrams per liter and less than about 300 milligrams per liter.

Embodiment 203. The solution of any one of Embodiments 154 to 189, wherein the concentration of calcium is greater than about 500 milligrams per liter and less than about 1,500 milligrams per liter.

Embodiment 204. The solution of any one of Embodiments 154 to 189, wherein the concentration of calcium is greater than about 700 milligrams per liter and less than about 1,200 milligrams per liter.

Embodiment 205. The solution of any one of Embodiments 154 to 204, wherein the concentration of magnesium is greater than about 1 milligram per liter and less than about 5000 milligrams per liter.

Embodiment 206. The solution of any one of Embodiments 154 to 204, wherein the concentration of magnesium is greater than about 2 milligrams per liter and less than about 1000 milligrams per liter.

Embodiment 207. The solution of any one of Embodiments 154 to 204, wherein the concentration of magnesium is greater than about 1000 milligrams per liter and less than about 2000 milligrams per liter.

Embodiment 208. The solution of any one of Embodiments 154 to 204, wherein the concentration of magnesium is greater than about 2000 milligrams per liter and less than about 3000 milligrams per liter.

Embodiment 209. The solution of any one of Embodiments 154 to 204, wherein the concentration of magnesium is greater than about 3000 milligrams per liter and less than about 4000 milligrams per liter.

Embodiment 210. The solution of any one of Embodiments 154 to 204, wherein the concentration of magnesium is greater than about 4000 milligrams per liter and less than about 6000 milligrams per liter.

Embodiment 211. The solution of any one of Embodiments 154 to 204, wherein the concentration of magnesium is greater than about 1 milligram per liter and less than about 500 milligrams per liter.

Embodiment 212. The solution of any one of Embodiments 154 to 204, wherein the concentration of magnesium is greater than about 500 milligrams per liter and less than about 1000 milligrams per liter.

Embodiment 213. The solution of any one of Embodiments 154 to 204, wherein the concentration of magnesium is greater than about 6000 milligrams per liter and less than about 10000 milligrams per liter.

Embodiment 214. The solution of any one of Embodiments 154 to 204, wherein the concentration of magnesium is greater than about 1 milligram per liter and less than about 500 milligrams per liter.

Embodiment 215. The solution of any one of Embodiments 154 to 204, wherein the concentration of magnesium is greater than about 1 milligram per liter and less than about 300 milligrams per liter.

Embodiment 216. The solution of any one of Embodiments 154 to 204, wherein the concentration of magnesium is greater than about 1 milligram per liter and less than about 200 milligrams per liter.

Embodiment 217. The solution of any one of Embodiments 154 to 204, wherein the concentration of magnesium is greater than about 5 milligrams per liter and less than about 150 milligrams per liter.

Embodiment 218. The solution of any one of Embodiments 154 to 217, wherein the concentration of potassium is greater than about 10 milligrams per liter and less than about 5000 milligrams per liter.

Embodiment 219. The solution of any one of Embodiments 154 to 217, wherein the concentration of potassium is greater than about 20 milligrams per liter and less than about 1000

Embodiment 220. The solution of any one of Embodiments 154 to 217, wherein the concentration of potassium is greater than about 1000 milligrams per liter and less than about 2000 milligrams per liter.

Embodiment 221. The solution of any one of Embodiments 154 to 217, wherein the concentration of potassium is greater than about 2000 milligrams per liter and less than about 3000 milligrams per liter.

Embodiment 222. The solution of any one of Embodiments 154 to 217, wherein the concentration of potassium is greater than about 3000 milligrams per liter and less than about 4000 milligrams per liter.

Embodiment 223. The solution of any one of Embodiments 154 to 217, wherein the concentration of potassium is greater than about 4000 milligrams per liter and less than about 6000 milligrams per liter.

Embodiment 224. The solution of any one of Embodiments 154 to 217, wherein the concentration of potassium is greater than about 10 milligrams per liter and less than about 500 milligrams per liter.

Embodiment 225. The solution of any one of Embodiments 154 to 217, wherein the concentration of potassium is greater than about 500 milligrams per liter and less than about 1000 milligrams per liter.

Embodiment 226. The solution of any one of Embodiments 154 to 217, wherein the concentration of potassium is greater than about 6000 milligrams per liter and less than about 10000 milligrams per liter.

Embodiment 227. The solution of any one of Embodiments 154 to 217, wherein the concentration of potassium is greater than about 10 milligrams per liter and less than about 300 milligrams per liter.

Embodiment 228. The solution of any one of Embodiments 154 to 217, wherein the concentration of potassium is greater than about 10 milligrams per liter and less than about 200 milligrams per liter.

Embodiment 229. The solution of any one of Embodiments 154 to 217, wherein the concentration of potassium is greater than about 10 milligrams per liter and less than about 100 milligrams per liter.

Embodiment 230. The solution of any one of Embodiments 154 to 217, wherein the concentration of potassium is greater than about 20 milligrams per liter and less than about 80

Embodiment 231. The solution of any one of Embodiments 154 to 230, wherein the solution further comprises boron, wherein the concentration of boron is greater than about 0.01 milligrams per liter and less than about 10,000 milligrams per liter.

Embodiment 232. The solution of any of the Embodiments 154 to 231, wherein the concentration of boron is greater than about 10 milligrams per liter and less than about 5000 milligrams per liter.

Embodiment 233. The solution of any of the Embodiments 154 to 231, wherein the concentration of boron is greater than about 20 milligrams per liter and less than about 1000 milligrams per liter.

Embodiment 234. The solution of any of the Embodiments 154 to 231, wherein the concentration of boron is greater than about 1000 milligrams per liter and less than about 2000 milligrams per liter.

Embodiment 235. The solution of any of the Embodiments 154 to 231, wherein the concentration of boron is greater than about 10 milligrams per liter and less than about 500 milligrams per liter.

Embodiment 236. The solution of any of the Embodiments 154 to 231, wherein the concentration of boron is greater than about 500 milligrams per liter and less than about 1000 milligrams per liter.

Embodiment 237. The solution of Embodiment 231 wherein the concentration of boron is greater than about 0.01 milligrams per liter and less than about 1,000 milligrams per liter.

Embodiment 238. The solution of Embodiment 231, wherein the concentration of boron is greater than about 0.1 milligrams per liter and less than about 750 milligrams per liter.

Embodiment 239. The solution of Embodiment 231, wherein the concentration of boron is greater than about 1 milligrams per liter and less than about 50 milligrams per liter.

Embodiment 240. The solution of Embodiment 231, wherein the concentration of boron is greater than about 50 milligrams per liter and less than about 100 milligrams per liter.

Embodiment 241. The solution of any one of Embodiments 154 to 240, wherein the solution further comprises strontium, wherein the concentration of strontium is greater than about 10 milligrams per liter and less than about 10,000 milligrams per liter.

Embodiment 242. The solution of Embodiment 241, wherein the concentration of strontium is greater than about 10 milligrams per liter and less than about 5000 milligrams per liter.

Embodiment 243. The solution of Embodiment 241, wherein the concentration of strontium is greater than about 1 milligrams per liter and less than about 1000 milligrams per liter.

Embodiment 244. The solution of Embodiment 241, wherein the concentration of strontium is greater than about 1000 milligrams per liter and less than about 2000 milligrams per liter.

Embodiment 245. The solution of Embodiment 241, wherein the concentration of strontium is greater than about 2000 milligrams per liter and less than about 3000 milligrams per liter.

Embodiment 246. The solution of Embodiment 241, wherein the concentration of strontium is greater than about 10 milligrams per liter and less than about 500 milligrams per liter.

Embodiment 247. The solution of Embodiment 241, wherein the concentration of strontium is greater than about 500 milligrams per liter and less than about 1000 milligrams per liter.

Embodiment 248. The solution of Embodiment 241, wherein the concentration of strontium is greater than about 1 milligram per liter and less than about 50 milligrams per liter.

Embodiment 249. The solution of Embodiment 241, wherein the concentration of strontium is greater than about 1 milligram per liter and less than about 30 milligrams per liter.

Embodiment 250. The solution of Embodiment 241, wherein the concentration of strontium is greater than about 1 milligram per liter and less than about 25 milligrams per liter.

Embodiment 251. The solution of any one of Embodiments 154 to 250 wherein the solution further comprises aluminum, wherein the concentration of aluminum is greater than about 0.01 milligrams per liter and less than about 1,000 milligrams per liter.

Embodiment 252. The solution of Embodiment 251, wherein the concentration of aluminum is greater than about 0.1 milligrams per liter and less than about 750 milligrams per liter.

Embodiment 253. The solution of Embodiment 251, wherein the concentration of aluminum is greater than about 1 milligrams per liter and less than about 50 milligrams per liter.

Embodiment 254. The solution of Embodiment 251, wherein the concentration of aluminum is greater than about 50 milligrams per liter and less than about 100 milligrams per liter.

Embodiment 255. The solution of Embodiment 251, wherein the concentration of aluminum is greater than about 100 milligrams per liter and less than about 200 milligrams per liter.

Embodiment 256. The solution of Embodiment 251, wherein the concentration of aluminum is greater than about 200 milligrams per liter and less than about 300 milligrams per liter.

Embodiment 257. The solution of Embodiment 251, wherein the concentration of aluminum is greater than about 300 milligrams per liter and less than about 400 milligrams per liter.

Embodiment 258. The solution of Embodiment 251, wherein the concentration of aluminum is greater than about 400 milligrams per liter and less than about 500 milligrams per liter.

Embodiment 259. The solution of Embodiment 251, wherein the concentration of aluminum is greater than about 500 milligrams per liter and less than about 600 milligrams per liter.

Embodiment 260. The solution of Embodiment 251, wherein the concentration of aluminum is greater than about 600 milligrams per liter and less than about 700 milligrams per liter.

Embodiment 261. The solution of Embodiment 251, wherein the concentration of aluminum is greater than about 700 milligrams per liter and less than about 800 milligrams per liter.

Embodiment 262. The solution of any one of Embodiments 154 to 261, wherein the concentration of said transition metal is greater than 0.01 milligrams per liter and less than about 1000 milligrams per liter.

Embodiment 263. The solution of Embodiment 262, wherein the concentration of said transition metal is greater than about 0.1 milligrams per liter and less than about 750 milligrams per liter.

Embodiment 264. The solution of Embodiment 262, wherein the concentration of said transition metal is greater than about 1 milligram per liter and less than about 50 milligrams per liter.

Embodiment 265. The solution of Embodiment 262, wherein the concentration of said transition metal is greater than about 50 milligrams per liter and less than about 100 milligrams per liter.

Embodiment 266. The solution of Embodiment 262, wherein the concentration of said transition metal is greater than about 100 milligrams per liter and less than about 200 milligrams per liter.

Embodiment 267. The solution of Embodiment 262, wherein the concentration of said transition metal is greater than about 200 milligrams per liter and less than about 300 milligrams per liter.

Embodiment 268. The solution of Embodiment 262, wherein the concentration of said transition metal is greater than about 300 milligrams per liter and less than about 400 milligrams per liter.

Embodiment 269. The solution of Embodiment 262, wherein the concentration of said transition metal is greater than about 400 milligrams per liter and less than about 500 milligrams per liter.

Embodiment 270. The solution of Embodiment 262, wherein the concentration of said transition metal is greater than about 500 milligrams per liter and less than about 600 milligrams per liter.

Embodiment 271. The solution of Embodiment 262, wherein the concentration of said transition metal is greater than about 600 milligrams per liter and less than about 700 milligrams per liter.

Embodiment 272. The solution of Embodiment 262, wherein the concentration of said transition metal is greater than about 700 milligrams per liter and less than about 800 milligrams per liter.

Embodiment 273. The solution of any one of Embodiments 155 to 272, wherein the transition metal comprises zirconium.

Embodiment 274. The solution of any one of Embodiments 155 to 273, wherein the transition metal comprises titanium.

Embodiment 275. The solution of any one of Embodiments 155 to 274, wherein the transition metal comprises vanadium.

Embodiment 276. The solution of any one of Embodiments 155 to 275, wherein the transition metal comprises iron.

Embodiment 277. The solution of any one of Embodiments 155 to 276, wherein the transition metal comprises copper.

Embodiment 278. The solution of any one of Embodiments 155 to 277, wherein the transition metal comprises manganese.

Embodiment 279. The solution of any one of Embodiments 155 to 278, wherein the transition metal comprises molybdenum.

Embodiment 280. The solution of any one of Embodiments 155 to 279, wherein the transition metal comprises niobium.

Embodiment 281. The solution of any one of Embodiments 155 to 280, wherein the transition metal comprises zirconium, titanium, vanadium, iron, copper, manganese, molybdenum, aluminum, or niobium, or combinations thereof.

Embodiment 282. The solution of any one of Embodiments 154 to 281, wherein the pH of said solution of greater than about 0 and less than about 4.

Embodiment 283. The solution of any one of Embodiments 154 to 281, wherein the value of pH is greater than about 1 and less than about 4.

Embodiment 284. The solution of any one of Embodiments 154 to 281, wherein the value of pH is greater than about 0 and less than about 1.

Embodiment 285. The solution of any one of Embodiments 154 to 281, wherein the value of pH is greater than about 1 and less than about 2.

Embodiment 286. The solution of any one of Embodiments 154 to 281, wherein the value of pH is greater than about 2 and less than about 3.

Embodiment 287. The solution of any one of Embodiments 154 to 281, wherein the value of pH is greater than about 3 and less than about 4.

Embodiment 288. The solution of any one of Embodiments 154 to 281, wherein the value of pH is greater than about 4 and less than about 5.

Embodiment 289. The solution of any one of Embodiments 154 to 281, wherein the value of pH is greater than about 5 and less than about 7.

Embodiment 290. The solution of any one of Embodiments 154 to 281, wherein the value of pH is greater than about 7 and less than about 10.

Embodiment 291. The solution of any one of Embodiments 154 to 281, wherein the value of pH is greater than about 10 and less than about 13.

Embodiment 292. The solution of any one of Embodiments 154 to 291, wherein the value of oxidation reduction potential is greater than about 50 m V and less than about 150 m V.

Embodiment 293. The solution of any one of Embodiments 154 to 291, wherein the value of oxidation reduction potential is greater than about 150 m V and less than about 300 m V.

Embodiment 294. The solution of any one of Embodiments 154 to 291, wherein the value of oxidation reduction potential is greater than about 300 m V and less than about 500 m V.

Embodiment 295. The solution of any one of Embodiments 154 to 291, wherein the value of oxidation reduction potential is greater than about 500 m V and less than about 800 m V.

Embodiment 296. A process for generating the solution of any one of Embodiments 154 to 295, wherein said solution of produced by contacting an acidic solution with an ion exchange material.

Embodiment 297. The process of Embodiment 296, wherein the solution is produced by contacting an ion exchange material with a liquid resource and then contacting said ion exchange material with an acidic solution.

Embodiment 298. The process of Embodiment 297, wherein said liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

Embodiment 299. The process of Embodiments 296 or 298, wherein said acidic solution comprises hydrochloric acid, sulfuric acid, phosphoric acid, hydrobromic acid, chloric acid, perchloric acid, nitric acid, formic acid, citric acid, or acetic acid, or combinations thereof.

Embodiment 300. The process of Embodiment 299, wherein said acidic solution comprises acid at a concentration of from about 0.01 to about 0.1 mol per liter.

Embodiment 301. The process of Embodiment 299, wherein said acidic solution comprises acid at a concentration of from about 0.1 to about 0.25 mol per liter.

Embodiment 302. The process of Embodiment 299, wherein said acidic solution comprises acid at a concentration of from about 0.25 to about 0.5 mol per liter.

Embodiment 303. The solution of Embodiment 299, wherein said acidic solution comprises acid at a concentration of from about 0.4 to about 0.75 mol per liter.

Embodiment 304. The process of Embodiment 299, wherein said acidic solution comprises acid at a concentration of from about 0.7 to about 1.0 mol per liter.

Embodiment 305. The process of Embodiment 299, wherein said acidic solution comprises acid at a concentration of from about 0.9 to about 1.5 mol per liter.

Embodiment 306. The process of Embodiment 299, wherein said acidic solution comprises acid at a concentration of from about 1.5 to about 2.5 mol per liter.

Embodiment 307. The process of Embodiment 299, wherein said acidic solution comprises acid at a concentration of from about 2.0 to about 5.0 mol per liter.

Embodiment 308. The process of Embodiment 299, wherein said acidic solution comprises acid at a concentration of from about 5.0 to about 10.0 mol per liter.

Embodiment 309. The process of any one of Embodiments 154 to 308, wherein the acidic solution further comprising chloride, sulfate, phosphate, bromide, chlorate, perchlorate, nitrate, formate, citrate, acetate, or combinations thereof.

### EXAMPLES

### Example 1: Composition of a Synthetic Lithium Solution Produced from Lithium Extraction from a Geothermal Brine

Lithium is extracted from a liquid resource using a network of vessels containing ion-exchange beads. Each vessel comprises filter banks filled with ion exchange beads arranged along the length of the vessel, with parallel flow to and from each filter bank. The ion-exchange beads are loaded into each of the ion-exchange compartments (which form the filter banks once loaded with ion exchange beads) by mechanically separating each flow ion exchange reactor.

The porous ion exchange beads are comprised of ion exchange particles and a polymer matrix. The ion exchange particles are coated ion exchange particles comprised of a Li₂TiO₃ core with a TiO₂ coating. The particles are approximately spherical with a mean diameter of 10 microns, and the coating thickness is approximately 5 nm. The polymer matrix material is comprised of polyvinylidene difluoride. The porous ion exchange beads contain porous networks with a controlled distribution of pore sizes providing diffusion channels from the ion exchange bead surface into the ion exchange bead interior and to the ion exchange particles. The ion exchange beads have a 200 microns average diameter.

The brine from which lithium is extracted consists of a geothermal brine (e.g., liquid resource) containing approximately 250 mg/L Li, 50,000 mg/L Na, 40,000 mg/L Ca, and 200 mg/L Mg, 20,000 mg/L K, 500 mg/L B, 2,500 mg/L Sr, and other chemical species including chloride and sulfate. When the liquid resource flows into the ion exchange vessel, it contacts the ion exchange beads. Said ion exchange beads selectively absorb lithium and release protons, while rejecting other species.

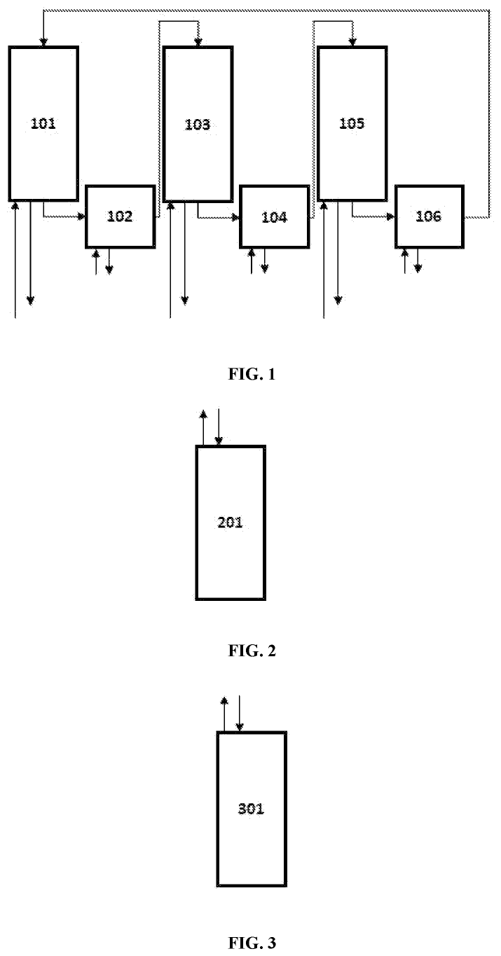

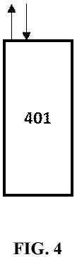

Three such vessels are connected to form a network. The vessels are connected via tanks where the pH of the brine is adjusted, as illustrated in FIG. 1. The network consists of ion exchange vessels (101, 103, 105) and mixing tanks for base and brine (102, 104, 106). For the mixing tanks in the brine circuit (102, 104, 106), an aqueous base solution of 5.0 M NaOH is added to increase the pH of the brine to 7.5. The pH of the brine is monitored before and after each mixing tank in the brine circuit, to control the rate of addition of aqueous base solution. For the purposes of this example, a flow configuration would be: a liquid resource flows into tank 102, then into vessel 103, into tank 104, into vessel 105, into tank 106 from which it leaves the system. Acidic eluent is concurrently flowed through vessel 101 to produce a synthetic concentrated lithium solution, or eluate (e.g., a lithium ion exchange eluate solution).

At any point during the operation of the network of three vessels, lithium is being extracted from brine with two vessels. Brine flows into a first mixing tank (e.g. 102) at pH of 6.5, and its pH is adjusted to a value of 7.5. This brine is fed to the first ion-exchange vessel (e.g. 102). The first vessel absorbs (e.g. 103) most of the lithium, releasing protons; this results in a drop in Li concentration from 250 to 50 mg/L and a drop in pH to a value of 3.0. In the subsequent mixing tank (e.g. 104), the pH of said brine is raised to about 7.5, and the brine is flowed into a second column (e.g. 105) which absorbs remaining lithium, and the Li concentration drops from 50 to 35 mg/L.

The third vessel (e.g. 101) is saturated with lithium from the previous ion-exchange cycle. The ion exchange beads in this vessel are first treated with an aqueous wash solution consisting of industrial water, to remove entrained brine. Subsequently, an acidic sulfate eluent consisting of 0.1 M sulfuric acid is contacted with the ion exchange beads in this vessel. This results in protons from the acid exchanging for lithium in the ion exchange beads. Lithium is thereby released from the ion exchange beads and enters the acidic eluent solution, while the ion exchange beads absorb protons. This yields a lithium sulfate synthetic lithium solution, or eluate (e.g., a lithium ion exchange eluate solution).

These system operations are repeated (e.g., multiple cycles are performed), loading lithium into each column until saturation, and redirecting flow to the next configuration of flows while the saturated column is treated with acidic eluent to release lithium.

The composition of the lithium sulfate eluate (e.g., lithium ion exchange eluate solution) produced is as follows: 700 mg/L lithium, 80 mg/L sodium, 30 mg/L magnesium, 100 mg/L calcium, 20 mg/L potassium, 1 mg/L boron, 25 mg/L strontium, 10 mg/L titanium, and other cationic impurities totaling around 70 mg/L. The pH of the eluate is 2, and its oxidation-reduction potential is measured at 225 mV.

### Example 2: Composition of a Synthetic Lithium Solution Produced from Lithium Extraction from a Natural Salt Flat Brine

Lithium is extracted from a liquid resource using a vessel containing ion-exchange beads. Each vessel comprises a compartment with a fixed bed of ion exchange beads.

The porous ion exchange beads are comprised of ion exchange particles. The ion exchange particles are coated ion exchange particles comprised of a Li₂Mn₂O₅ core with a SiO₂ coating. The particles are approximately spherical with a mean diameter of 3 to 5 microns, and the coating thickness is approximately 10 nm. The porous ion exchange beads contain porous networks with a controlled distribution of pore sizes providing diffusion channels from the ion exchange bead surface into the ion exchange bead interior and to the ion exchange particles. The ion exchange beads have a 150 microns average diameter.

The brine from which lithium is extracted consists of a natural aqueous chloride solution obtained from underground a salt flat (e.g., liquid resource). It contains approximately 700 mg/L Li, 80,000 mg/L Na, 700 mg/L Ca, and 2,000 mg/L Mg, 8,000 mg/L K, 400 mg/L B, 5 mg/L Sr, and other chemical species including chloride and sulfate. When the liquid resource flows into the ion exchange vessel, it contacts the ion exchange beads. Said ion exchange beads selectively absorb lithium and release protons, while rejecting other species.

During lithium extraction, the liquid resource is flowed through the ion exchange vessel 201, and the lithium concentration drops from 700 mg/L to 150 mg/L. Once the absorption of lithium ceases, the flow of liquid resource into the vessel ceases. The ion exchange beads in this vessel are then treated with an aqueous wash solution consisting of industrial water, to remove entrained brine.

Subsequently, an acidic chloride eluent consisting of 0.4 M hydrochloric acid (e.g., acidic solution), is pumped into vessel 201 to contact the ion exchange beads. This results in protons from the acid exchanging for lithium. Lithium is thereby released and enters the acidic eluent solution, while the ion exchange beads absorb protons. This yields a lithium chloride eluate (e.g., a lithium ion exchange eluate solution).

These system operations are repeated (e.g., multiple cycles are performed), loading lithium into the vessel through contact with a liquid resource, followed by washing of entrained brine, and elution of lithium using an acidic chloride solution to produce a synthetic concentrated lithium solution, or eluate (e.g., a lithium ion exchange eluate solution).

The composition of the lithium chloride synthetic lithium solution (e.g., lithium ion exchange eluate solution) is as follows: 2,000 mg/L lithium, 700 mg/L sodium, 40 mg/L magnesium, 200 mg/L calcium, 40 mg/L potassium, 5 mg/L of boron, 10 mg/L of strontium, and other cationic impurities totaling around 100 mg/L. The pH of the eluate is 3, and its oxidation-reduction potential is measured at 250 mV.

### Example 3: Composition of a Synthetic Lithium Solution Produced from Lithium Extraction From a Natural Salt Flat Brine Using an Agitated Vessel Containing Ion Exchange Beads

Lithium is extracted from a liquid resource using a vessel containing ion-exchange beads. The vessel comprises a stirred coned-bottom tank with a particle trap at the bottom.

The porous ion exchange beads are comprised of ion exchange particles. The ion exchange particles are comprised of Li₄Ti₅O₁₂. The particles are approximately spherical with a mean diameter of 3 to 5 microns. The porousion exchange beads contain porous networks with a controlled distribution of pore sizes providing diffusion channels from the ion exchange bead surface into the ion exchange bead interior and to the ion exchange particles.

The brine from which lithium is extracted consists of a natural aqueous chloride solution obtained from underground a salt flat (e.g., liquid resource). It contains approximately 150 mg/L Li, 40,000 mg/L Na, 500 mg/L Ca, and 300 mg/L Mg, 3,000 mg/L K, 40 mg/L B, 5 mg/L Sr, and other chemical species including chloride and sulfate. When the liquid resource flows into the ion exchange vessel, it contacts the ion exchange beads. Said ion exchange beads selectively absorb lithium and release protons, while rejecting other species.

During lithium extraction, the liquid resource is loaded into the ion exchange vessel 301. The pH of the brine is monitored, and an aqueous solution of 4.0 M NaOH is added to maintain the pH in the vessel at 7.5. The liquid resource is contacted with the ion exchange beads for 2 hours, and the lithium concentration drops from 150 mg/L to 25 mg/L. Once the absorption of lithium ceases, the liquid resource is drained from vessel 301. The ion exchange beads in this vessel are then treated with an aqueous wash solution consisting of industrial water, to remove entrained brine.

Subsequently, an acidic nitrate eluent consisting of 1.4 M nitric acid (e.g., acidic solution) is pumped into this vessel and agitated with the ion exchange beads for 10 minutes. This results in protons from the acid exchanging for lithium. Lithium is thereby released from the ion exchange beads and enters the acidic eluent solution to form a synthetic lithium solution, while the ion exchange beads absorb protons. This yields a lithium nitrate eluate (e.g., a lithium ion exchange eluate solution).

These system operations are repeated (e.g., multiple cycles are performed), loading lithium into the ion exchange beads until saturation, and eluting the absorbed lithium.

The composition of the lithium nitrate eluate (e.g., lithium ion exchange eluate solution) produced is as follows: 9,000 mg/L lithium, 1,000 mg/L sodium, 100 mg/L magnesium, 600 mg/L calcium, 75 mg/L potassium, 10 mg/L boron, 5 mg/L Sr, and other cationic impurities totaling around 200 mg/L. The pH of the eluate is 2.5, and its oxidation-reduction potential is measured at 300 m V.

### Example 4: Composition of a Synthetic Lithium Solution Produced from Lithium Extraction from a Geothermal Brine

Lithium is extracted from a liquid resource using a vessel containing ion-exchange beads. The vessel comprises a stirred coned-bottom tank with a particle trap at the bottom.

The porous ion exchange beads are comprised of ion exchange particles. The ion exchange particles are comprised of Li₄Mn₅O₁₂. The particles are approximately spherical with a mean diameter of 5 to 40 microns. The porous ion exchange beads contain porous networks with a controlled distribution of pore sizes providing diffusion channels from the ion exchange bead surface into the ion exchange bead interior and to the ion exchange particles.

The brine from which lithium is extracted consists of a natural aqueous chloride solution obtained from underground a salt flat (e.g., liquid resource). It contains approximately 400 mg/L Li, 50,000 mg/L Na, 40,000 mg/L Ca, and 1,000 mg/L Mg, 5,000 mg/L K, 200 mg/L B, 500 mg/L Sr, and other chemical species including chloride and sulfate. When the liquid resource flows into the ion exchange vessel, it contacts the ion exchange beads. Said ion exchange beads selectively absorb lithium and release protons, while rejecting other species.

During lithium extraction, the liquid resource is loaded into the ion exchange vessel 401. The pH of the brine is monitored, and an aqueous solution of 8.0 M NaOH is added to maintain the pH in the vessel at 7.5. The liquid resource is contacted with the ion exchange beads for 4 hours. Once the absorption of lithium ceases, the liquid resource is drained from vessel 401. The ion exchange beads in this vessel are then treated with an aqueous wash solution consisting of industrial water, to remove entrained brine.

Subsequently, an acidic chloride eluent consisting of 1.0 M hydrochloric acid (e.g., a acidic solution) is pumped into this vessel and agitated with the ion exchange beads for 10 minutes. This results in protons from the acid exchanging for lithium. Lithium is thereby released from the ion exchange beads and enters the acidic eluent solution to form a synthetic lithium solution, while the ion exchange beads absorb protons. This yields a lithium chloride eluate (e.g., a lithium ion exchange eluate solution).

These system operations are repeated (e.g., multiple cycles are performed), loading lithium into the ion exchange beads until saturation, and eluting the absorbed lithium.

The composition of the lithium chloride eluate (e.g., lithium ion exchange eluate solution) produced is as follows: 5,000 mg/L lithium, 250 mg/L sodium, 50 mg/L magnesium, 1,000 mg/L calcium, 50 mg/L potassium, 50 mg/L boron, 100 mg/L Sr, and other cationic impurities totaling around 200 mg/L. The pH of the eluate is 2.5, and its oxidation-reduction potential is measured at 300 m V.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents. It is intended that the following claims define the scope of some aspects of the disclosure and that methods and structures within the scope of these claims and their equivalents be covered thereby.

What is claimed is:

1. A lithium ion exchange eluate solution comprising:
a. water;
b. lithium, wherein the concentration of lithium is greater than about 100 milligrams per liter and less than about 25,000 milligrams per liter;
c. sodium, wherein the concentration of sodium is greater than about 10 milligrams per liter and less than about 25,000 milligrams per liter;
d. calcium, wherein the concentration of calcium is greater than about 1 milligram per liter and less than about 10,000 milligrams per liter;
e. magnesium, wherein the concentration of magnesium is greater than about 10 milligrams per liter and less than about 10,000 milligrams per liter; and
f. potassium, wherein the concentration of potassium is greater than about 10 milligrams per liter and less than about 10,000 milligrams per liter.

2. The solution of claim 1, wherein the molar ratio of lithium to the sum of all other cations dissolved in the solution is greater than 2:1.

3. The solution of claim 1, wherein the molar ratio of lithium to the sum of all other cations dissolved in the solution is greater than 10:1.

4. The solution of claim 1, wherein the molar ratio of lithium to the sum of all other cations dissolved in the solution is greater than 50:1.

5. The solution of any one of claims 1 to 4, wherein the concentration of lithium is greater than about 200 milligrams per liter and less than about 8000 milligrams per liter.

6. The solution of any one of claims 1 to 4, wherein the concentration of lithium is greater than about 200 milligrams per liter and less than about 4000 milligrams per liter.

7. The solution of any one of claims 1 to 4, wherein the concentration of lithium is greater than about 200 milligrams per liter and less than about 1000 milligrams per liter.

8. The solution of any one of claims 1 to 4, wherein the concentration of lithium is greater than about 1000 milligrams per liter and less than about 4000 milligrams per liter.

9. The solution of any one of claims 1 to 4, wherein the concentration of lithium is greater than about 6000 milligrams per liter and less than about 8000 milligrams per liter.

10. The solution of any one of claims 1 to 4, wherein the concentration of lithium is greater than about 15000 milligrams per liter and less than about 25000 milligrams per liter.

11. The solution of any one of claims 1 to 10, wherein the concentration of sodium is greater than about 10 milligrams per liter and less than about 5000 milligrams per liter.

12. The solution of any one of claims 1 to 10, wherein the concentration of sodium is greater than about 20 milligrams per liter and less than about 1000 milligrams per liter.

13. The solution of any one of claims 1 to 10, wherein the concentration of sodium is greater than about 1000 milligrams per liter and less than about 2000 milligrams per liter.

14. The solution of any one of claims 1 to 10, wherein the concentration of sodium is greater than about 10 milligrams per liter and less than about 500 milligrams per liter.

15. The solution of any one of claims 1 to 10, wherein the concentration of sodium is greater than about 500 milligrams per liter and less than about 1000 milligrams per liter.

16. The solution of any one of claims 1 to 10, wherein the concentration of sodium is greater than about 10 milligrams per liter and less than about 100 milligrams per liter.

17. The solution of any one of claims 1 to 10, wherein the concentration of sodium is greater than about 10000 milligrams per liter and less than about 25000 milligrams per liter.

18. The solution of any one of claims 1 to 17, wherein the concentration of calcium is greater than about 10 milligrams per liter and less than about 6000 milligrams per liter.

19. The solution of any one of claims 1 to 17, wherein the concentration of calcium is greater than about 10 milligrams per liter and less than about 500 milligrams per liter.

20. The solution of any one of claims 1 to 17, wherein the concentration of calcium is greater than about 500 milligrams per liter and less than about 1000 milligrams per liter.

21. The solution of any one of claims 1 to 17, wherein the concentration of calcium is greater than about 10 milligrams per liter and less than about 2,000 milligrams per liter.

22. The solution of any one of claims 1 to 17, wherein the concentration of calcium is greater than about 2,000 milligrams per liter and less than about 3,000 milligrams per liter.

23. The solution of any one of claims 1 to 17, wherein the concentration of calcium is greater than about 3,000 milligrams per liter and less than about 4,000 milligrams per liter.

24. The solution of any one of claims 1 to 17, wherein the concentration of calcium is greater than about 4,000 milligrams per liter and less than about 5,000 milligrams per liter.

25. The solution of any one of claims 1 to 17, wherein the concentration of calcium is greater than about 5,000 milligrams per liter and less than about 6,000 milligrams per liter.

26. The solution of any one of claims 1 to 25, wherein the concentration of magnesium is greater than about 1 milligram per liter and less than about 5000 milligrams per liter.

27. The solution of any one of claims 1 to 25, wherein the concentration of magnesium is greater than about 1 milligram per liter and less than about 500 milligrams per liter.

28. The solution of any one of claims 1 to 25, wherein the concentration of magnesium is greater than about 1 milligram per liter and less than about 200 milligrams per liter.

29. The solution of any one of claims 1 to 25, wherein the concentration of magnesium is greater than about 5 milligrams per liter and less than about 150 milligrams per liter.

30. The solution of any one of claims 1 to 29, wherein the concentration of potassium is greater than about 10 milligrams per liter and less than about 5000 milligrams per liter.

31. The solution of any one of claims 1 to 29, wherein the concentration of potassium is greater than about 10 milligrams per liter and less than about 500 milligrams per liter.

32. The solution of any one of claims 1 to 29, wherein the concentration of potassium is greater than about 10 milligrams per liter and less than about 200 milligrams per liter.

33. The solution of any one of claims 1 to 29, wherein the concentration of potassium is greater than about 10 milligrams per liter and less than about 100 milligrams per liter.

34. The solution of any one of claims 1 to 29, wherein the concentration of potassium is greater than about 20 milligrams per liter and less than about 80 milligrams per liter.

35. The solution of any one of claims 1 to 29, wherein the solution further comprises boron, wherein the concentration of boron is greater than about 0.01 milligrams per liter and less than about 10,000 milligrams per liter.

36. The solution of claim 35 wherein the concentration of boron is greater than about 0.01 milligrams per liter and less than about 1,000 milligrams per liter.

37. The solution of claim 35, wherein the concentration of boron is greater than about 0.1 milligrams per liter and less than about 750 milligrams per liter.

38. The solution of claim 35, wherein the concentration of boron is greater than about 1 milligrams per liter and less than about 50 milligrams per liter.

39. The solution of claim 35, wherein the concentration of boron is greater than about 50 milligrams per liter and less than about 100 milligrams per liter.

40. The solution of any one of claims 1 to 39, wherein the solution further comprises strontium, wherein the concentration of strontium is greater than about 1 milligrams per liter and less than about 10,000 milligrams per liter.

41. The solution of claim 40, wherein the concentration of strontium is greater than about 1 milligrams per liter and less than about 1000 milligrams per liter.

42. The solution of claim 40, wherein the concentration of strontium is greater than about 1 milligram per liter and less than about 50 milligrams per liter.

43. The solution of claim 40, wherein the concentration of strontium is greater than about 1 milligram per liter and less than about 30 milligrams per liter.

44. The solution of any one of claims 1 to 43 wherein the solution further comprises aluminum, wherein the concentration of aluminum is greater than about 0.01 milligrams per liter and less than about 1,000 milligrams per liter.

45. The solution of claim 44, wherein the concentration of aluminum is greater than about 0.1 milligrams per liter and less than about 750 milligrams per liter.

46. The solution of claim 44, wherein the concentration of aluminum is greater than about 1 milligrams per liter and less than about 50 milligrams per liter.

47. The solution of claim 44, wherein the concentration of aluminum is greater than about 50 milligrams per liter and less than about 100 milligrams per liter.

48. The solution of claim 44, wherein the concentration of aluminum is greater than about 100 milligrams per liter and less than about 200 milligrams per liter.

49. The solution of any one of claims 1 to 48, wherein the solution further comprises one or more transition metals, wherein the concentration of said one or more transition metals is greater than 0.01 milligrams per liter and less than about 1000 milligrams per liter.

50. The solution of claim 49, wherein the concentration of said one or more transition metals is greater than about 0.1 milligrams per liter and less than about 750 milligrams per liter.

51. The solution of claim 49, wherein the concentration of said one or more transition metals is greater than about 1 milligram per liter and less than about 50 milligrams per liter.

52. The solution of claim 49, wherein the concentration of said one or more transition metals is greater than about 1 milligram per liter and less than about 25 milligrams per liter.

53. The solution of claim 49, wherein the concentration of said one or more transition metals is greater than about 50 milligrams per liter and less than about 100 milligrams per liter.

54. The solution of claim 49, wherein the concentration of said one or more transition metals is greater than about 100 milligrams per liter and less than about 200 milligrams per liter.

55. The solution of any one of claims 49 to 54, wherein the one or more transition metals are selected from: zirconium, titanium, vanadium, iron, copper, manganese, molybdenum, aluminum, niobium, or combinations thereof.

56. A lithium ion exchange eluate solution comprising:
a. water;
b. lithium, wherein the concentration of lithium is greater than about 100 milligrams per liter and less than about 25,000 milligrams per liter;
c. sodium, wherein the concentration of sodium is greater than about 10 milligrams per liter and less than about 25,000 milligrams per liter;
d. one or more cationic metals, wherein the concentration of the one or more cationic metals is greater than about 1 milligram per liter and less than about 10,000 milligrams per liter.

57. The solution of claim 56, wherein the one or more cationic metals comprises:
a. calcium, wherein the concentration of calcium is greater than about 10 milligrams per liter and less than about 10,000 milligrams per liter; and
b. one or more transition metals, wherein the concentration of said one or more transition metals is greater than 0.01 milligrams per liter and less than about 1000 milligrams per liter.

58. The solution of claim 56, wherein the one or more cationic metals comprises:
a. magnesium, wherein the concentration of magnesium is greater than about 1 milligram per liter and less than about 10,000 milligrams per liter; and
b. one or more transition metals, wherein the concentration of said one or more transition metals is greater than 0.01 milligrams per liter and less than about 1000 milligrams per liter.

59. The solution of claim 56, wherein the one or more cationic metals comprises:
a. calcium, wherein the concentration of calcium is greater than about 10 milligrams per liter and less than about 10,000 milligrams per liter;
b. magnesium, wherein the concentration of magnesium is greater than about 10 milligrams per liter and less than about 10,000 milligrams per liter; and
c. potassium, wherein the concentration of potassium is greater than about 10 milligrams per liter and less than about 10,000 milligrams per liter.

60. The solution of any one of claims 56 to 59, wherein the molar ratio of lithium to the sum of all other cations dissolved in the solution is greater than 2:1.

61. The solution of any one of claims 56 to 59, wherein the molar ratio of lithium to the sum of all other cations dissolved in the solution is greater than 5:1.

62. The solution of any one of claims 56 to 59, wherein the molar ratio of lithium to the sum of all other cations dissolved in the solution is greater than 10:1.

63. The solution of any one of claims 56 to 59, wherein the molar ratio of lithium to the sum of all other cations dissolved in the solution is greater than 20:1.

64. The solution of any one of claims 56 to 59, wherein the molar ratio of lithium to the sum of all other cations dissolved in the solution is greater than 50:1.

65. The solution of any one of claims 56 to 64, wherein the concentration of lithium is greater than about 200 milligrams per liter and less than about 8000 milligrams per liter.

66. The solution of any one of claims 56 to 64, wherein the concentration of lithium is greater than about 200 milligrams per liter and less than about 4000 milligrams per liter.

67. The solution of any one of claims 56 to 64, wherein the concentration of lithium is greater than about 200 milligrams per liter and less than about 1000 milligrams per liter.

68. The solution of any one of claims 56 to 64, wherein the concentration of lithium is greater than about 1000 milligrams per liter and less than about 4000 milligrams per liter.

69. The solution of any one of claims 56 to 64, wherein the concentration of lithium is greater than about 6000 milligrams per liter and less than about 8000 milligrams per liter.

70. The solution of any one of claims 56 to 64, wherein the concentration of lithium is greater than about 15000 milligrams per liter and less than about 25000 milligrams per liter.

71. The solution of any one of claims 56 to 70, wherein the concentration of sodium is greater than about 10 milligrams per liter and less than about 5000 milligrams per liter.

72. The solution of any one of claims 56 to 70, wherein the concentration of sodium is greater than about 20 milligrams per liter and less than about 1000 milligrams per liter.

73. The solution of any one of claims 56 to 70, wherein the concentration of sodium is greater than about 1000 milligrams per liter and less than about 2000 milligrams per liter.

74. The solution of any one of claims 56 to 70, wherein the concentration of sodium is greater than about 10 milligrams per liter and less than about 500 milligrams per liter.

75. The solution of any one of claims 56 to 70, wherein the concentration of sodium is greater than about 500 milligrams per liter and less than about 1000 milligrams per liter.

76. The solution of any one of claims 56 to 70, wherein the concentration of sodium is greater than about 10 milligrams per liter and less than about 100 milligrams per liter.

77. The solution of any one of claims 56 to 70, wherein the concentration of sodium is greater than about 10000 milligrams per liter and less than about 25000 milligrams per liter.

78. The solution of any one of claims 56 to 77, wherein the one or more cationic metals comprises calcium, wherein the concentration of calcium is greater than about 10 milligrams per liter and less than about 5000 milligrams per liter.

79. The solution of any one of claims 56 to 77, wherein the one or more cationic metals comprises calcium, wherein the concentration of calcium is greater than about 10 milligrams per liter and less than about 500 milligrams per liter.

80. The solution of any one of claims 56 to 77, wherein the one or more cationic metals comprises calcium, wherein the concentration of calcium is greater than about 500 milligrams per liter and less than about 1000 milligrams per liter.

81. The solution of any one of claims 56 to 77, wherein the one or more cationic metals comprises calcium, wherein the concentration of calcium is greater than about 10 milligrams per liter and less than about 2,000 milligrams per liter.

82. The solution of any one of claims 56 to 77, wherein the concentration of calcium is greater than about 2,000 milligrams per liter and less than about 3,000 milligrams per liter.

83. The solution of any one of claims 56 to 77, wherein the concentration of calcium is greater than about 3,000 milligrams per liter and less than about 4,000 milligrams per liter.

84. The solution of any one of claims 56 to 77, wherein the concentration of calcium is greater than about 4,000 milligrams per liter and less than about 5,000 milligrams per liter.

85. The solution of any one of claims 56 to 77, wherein the concentration of calcium is greater than about 5,000 milligrams per liter and less than about 6,000 milligrams per liter

86. The solution of any one of claims 56 to 85, wherein the one or more cationic metals comprises magnesium, wherein the concentration of magnesium is greater than about 1 milligram per liter and less than about 5000 milligrams per liter.

87. The solution of any one of claims 56 to 85, wherein the one or more cationic metals comprises magnesium, wherein the concentration of magnesium is greater than about 1 milligram per liter and less than about 500 milligrams per liter.

88. The solution of any one of claims 56 to 85, wherein the one or more cationic metals comprises magnesium, wherein the concentration of magnesium is greater than about 1 milligram per liter and less than about 200 milligrams per liter.

89. The solution of any one of claims 56 to 85, wherein the one or more cationic metals comprises magnesium, wherein the concentration of magnesium is greater than about 5 milligrams per liter and less than about 150 milligrams per liter.

90. The solution of any one of claims 56 to 89, wherein the one or more cationic metals comprises potassium, wherein the concentration of potassium is greater than about 10 milligrams per liter and less than about 5000 milligrams per liter.

91. The solution of any one of claims 56 to 89, wherein the one or more cationic metals comprises potassium, wherein the concentration of potassium is greater than about 10 milligrams per liter and less than about 500 milligrams per liter.

92. The solution of any one of claims 56 to 89, wherein the one or more cationic metals comprises potassium, wherein the concentration of potassium is greater than about 10 milligrams per liter and less than about 200 milligrams per liter.

93. The solution of any one of claims 56 to 89, wherein the one or more cationic metals comprises potassium, wherein the concentration of potassium is greater than about 10 milligrams per liter and less than about 100 milligrams per liter.

94. The solution of any one of claims 56 to 89, wherein the one or more cationic metals comprises potassium, wherein the concentration of potassium is greater than about 20 milligrams per liter and less than about 80 milligrams per liter.

95. The solution of any one of claims 56 to 94, wherein the solution further comprises boron, wherein the concentration of boron is greater than about 0.01 milligrams per liter and less than about 10,000 milligrams per liter.

96. The solution of claim 95 wherein the concentration of boron is greater than about 0.01 milligrams per liter and less than about 1,000 milligrams per liter.

97. The solution of claim 95, wherein the concentration of boron is greater than about 0.1 milligrams per liter and less than about 750 milligrams per liter.

98. The solution of claim 95, wherein the concentration of boron is greater than about 1 milligrams per liter and less than about 50 milligrams per liter.

99. The solution of claim 95, wherein the concentration of boron is greater than about 50 milligrams per liter and less than about 100 milligrams per liter.

100. The solution of any one of claims 56 to 99, wherein the solution further comprises strontium, wherein the concentration of strontium is greater than about 1 milligrams per liter and less than about 10,000 milligrams per liter.

101. The solution of claim 100, wherein the concentration of strontium is greater than about 1 milligrams per liter and less than about 1000 milligrams per liter.

102. The solution of claim 100, wherein the concentration of strontium is greater than about 1 milligram per liter and less than about 50 milligrams per liter.

103. The solution of claim 100, wherein the concentration of strontium is greater than about 1 milligram per liter and less than about 30 milligrams per liter.

104. The solution of any one of claims 56 to 103 wherein the solution further comprises aluminum, wherein the concentration of aluminum is greater than about 0.01 milligrams per liter and less than about 1,000 milligrams per liter.

105. The solution of claim 104, wherein the concentration of aluminum is greater than about 0.1 milligrams per liter and less than about 750 milligrams per liter.

106. The solution of claim 104, wherein the concentration of aluminum is greater than about 1 milligrams per liter and less than about 50 milligrams per liter.

107. The solution of claim 104, wherein the concentration of aluminum is greater than about 50 milligrams per liter and less than about 100 milligrams per liter.

108. The solution of claim 104, wherein the concentration of aluminum is greater than about 100 milligrams per liter and less than about 200 milligrams per liter.

109. The solution of any one of claims 56 to 108, wherein the one or more cationic metals comprises one or more transition metals, wherein the concentration of said one or more transition metals is greater than 0.01 milligrams per liter and less than about 1000 milligrams per liter.

110. The solution of claim 109, wherein the concentration of said one or more transition metals is greater than about 0.1 milligrams per liter and less than about 750 milligrams per liter.

111. The solution of claim 109, wherein the concentration of said one or more transition metals is greater than about 1 milligram per liter and less than about 50 milligrams per liter.

112. The solution of claim 109, wherein the concentration of said one or more transition metals is greater than about 50 milligrams per liter and less than about 100 milligrams per liter.

113. The solution of claim 109, wherein the concentration of said one or more transition metals is greater than about 100 milligrams per liter and less than about 200 milligrams per liter.

114. The solution of any one of claims 56 to 113, wherein the one or more transition metals are selected from: zirconium, titanium, vanadium, iron, copper, manganese, molybdenum, aluminum, niobium, or combinations thereof.

115. The solution of any one of claims 1 to 114, wherein the pH of said solution is greater than about 0 and less than about 4.

116. The solution of any one of claims 1 to 115, wherein the oxidation-reduction potential of the solution versus standard hydrogen electrode is greater than about 50 m V and less than about 500 mV.

117. A process for generating the solution of any one of claims 1 to 116, the process comprising: contacting an acidic solution with an ion exchange material to provide the lithium ion exchange eluate solution.

118. The process of claim 117, wherein the process further comprises: contacting the ion exchange material with a liquid resource prior to contacting said ion exchange material with an acidic solution.

119. The process of claim 118, wherein said liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

120. The process of any one of claims 117 to 119, wherein said acidic solution comprises acid selected from: hydrochloric acid, sulfuric acid, phosphoric acid, hydrobromic acid, chloric acid, perchloric acid, nitric acid, formic acid, citric acid, or acetic acid, or combinations thereof.

121. The process of claim 120, wherein said acidic solution comprises acid at a concentration of from about 0.1 to about 5.0 mol per liter.

122. The process of any one of claims 117 to 121, wherein the acidic solution comprises chloride, sulfate, phosphate, bromide, chlorate, perchlorate, nitrate, formate, citrate, acetate, or combinations thereof.
